(19) United States
(12) Patent Application Publication
(10) Pub. No.: US 2025/0157289 A1
(43) Pub. Date: May 15, 2025

(54) PREDICTIVE GAMING INSIGHT PLATFORM

(71) Applicant: LNW Gaming, Inc., Las Vegas, NV (US)

(72) Inventors: Jon Christian WOLFE, Las Vegas, NV (US); Wesley NALL, Olive Branch, MS (US); Murali VENKATARAMAN, Cumming, GA (US); Jong-Wook SHIN, Winnetka, IL (US)

(21) Appl. No.: 18/907,925

(22) Filed: Oct. 7, 2024

Related U.S. Application Data
(63) Continuation-in-part of application No. 18/794,858, filed on Aug. 5, 2024.
(60) Provisional application No. 63/597,851, filed on Nov. 10, 2023.

(51) Int. Cl. G07F 17/32

(52) U.S. Cl. CPC G07F 17/3239

(57) ABSTRACT

A system and method(s) for aggregating gaming data generated by casino devices connected to a casino network. The system accesses a machine learning model trained through exploratory data analysis of the aggregated gaming data, mapping input features to model parameters used for predicting a target output value. The system further predicts, using the machine learning model, user-specific output value that identifies a player behavior by analyzing a portion of the aggregated gaming data associated with a specific user account logged into one of the casino devices. Based on the identified player behavior, the system automatically adjusts a configuration of the casino devices to optimize its operation for the specific user account.

### CROSS-REFERENCE TO RELATED APPLICATION

This patent application is a continuation-in-part of U.S. patent application Ser. No. 18/794,858 filed Aug. 5, 2024, which Ser. No. 18/794,858 Application claims the priority benefit of U.S. Provisional Patent Application No. 63/597,851 filed Nov. 10, 2023. The Ser. No. 18/794,858 Application and the 63/597,851 Application are each incorporated by reference herein in their respective entireties.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD

The present disclosure relates generally to system(s) and method(s) for generating and presenting gaming content, including use of artificial neural network model(s).

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines as well as those machines, or systems, that are easy to use.

Furthermore, there exist some challenges in developing games that present the most entertaining and exciting artwork, features, etc. For example, as games get more advanced, the designed gaming content increases in resolution and detail, thus also increasing in size and complexity. Therefore, animation of conventional gaming content can require improved or upgraded hardware (e.g., memory, graphics processing units, etc.) used to store, process, present, etc. the large and complex gaming content.

Therefore, there is a continuing need for wagering game machine manufacturers to continuously develop gaming features (e.g., innovative and/or interesting gaming content) that will improve the gaming experience for players. Furthermore, it would be beneficial to have a system that overcomes the conventional technical challenges and complexities associated with developing and animating ever more sophisticated gaming content.

### SUMMARY

According to an embodiment of the present disclosure, a system and/or method(s) to aggregate gaming data generated by casino devices communicatively coupled to a casino network. The system and/or method(s) can further access a machine learning model trained, via exploratory data analysis of the aggregated gaming data, to map input features of the aggregated gaming data to model parameters used to predict a target output value. The system and/or method(s) can further predict, using the machine learning model to analyze at least some portion of the aggregated gaming data associated with a specific user account logged onto one of the casino devices, a user-specific output value that identifies a player behavior. The system and/or method(s) can further automatically modify, based on the identified player behavior, a configuration associated with the one of the casino devices to optimize, for the specific user account, an operation associated with the one of the casino devices.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of an example network according to one or more embodiments of the present disclosure.

FIG. 2 is a schematic view of a gaming system according to one or more embodiments of the present disclosure.

FIG. 3 is a diagram of a computer system according to one or more embodiments of the present disclosure.

FIG. 4 illustrates an example method flow of dynamically generating models for user-related insights according to one or more embodiments of the present disclosure.

FIG. 5 illustrates an example architecture according to one or more embodiments of the present disclosure.

FIG. 6 illustrates an example method flow of dynamically applying portable models for user-related insights using an integration framework according to one or more embodiments of the present disclosure.

FIG. 7 illustrates an example method flow of dynamically managing predictions using an integration framework according to one or more embodiments of the present disclosure.

FIGS. 8, 9, and 10 illustrate a user interface animated via an integration framework according to one or more embodiments of the present disclosure.

FIG. 11 illustrates an example architecture according to one or more embodiments of the present disclosure.

FIG. 12 illustrates an example method flow according to one or more embodiments of the present disclosure.

FIG. 13 illustrates an example method flow according to one or more embodiments of the present disclosure.

FIG. 14 illustrates an example method flow according to one or more embodiments of the present disclosure.

FIG. 15A illustrates an example of a continuous training process according to one or more embodiments of the present disclosure.

In FIG. 15B illustrates a continuous deployment process according to one or more embodiments of the present disclosure.

FIG. 16 through FIG. 27 illustrate an example of an AI tool according to one or more embodiments of the present disclosure.

FIG. 28, FIG. 29 and FIG. 30A-30C illustrate an example AI tool. according to one or more embodiments of the present disclosure.

FIG. 31A, FIG. 31B, and FIG. 31C illustrate an example AI tool according to one or more embodiments of the present disclosure.

FIG. 32 through FIG. 42 illustrate an example AI tool according to one or more embodiments of the present disclosure.

FIG. 43 through FIG. 45 illustrate an example AI tool according to one or more embodiments of the present disclosure.

FIG. 46 illustrates an example method flow according to one or more embodiments of the present disclosure.

FIG. 47 through FIG. 52 illustrate an example AI tool according to one or more embodiments of the present disclosure.

FIG. 53 illustrates an example architecture according to one or more embodiments of the present disclosure.

FIG. 54 illustrates an example method flow according to some embodiments of the present disclosure.

FIG. 55 illustrates an architecture according to one or more embodiments of the present disclosure.

FIG. 56 illustrates an example AI tool according to one or more embodiments of the present disclosure.

FIG. 57 illustrates an example method flow according to one or more embodiments of the present disclosure.

FIG. 58 through FIG. 60 illustrates an example AI tool according to one or more embodiments of the present disclosure.

FIG. 61, FIG. 62, and FIG. 63 illustrate an example AI tool according to one or more embodiments of the present disclosure.

FIG. 64 illustrates an example method flow according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings, and will herein be described in detail, at least some embodiments with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

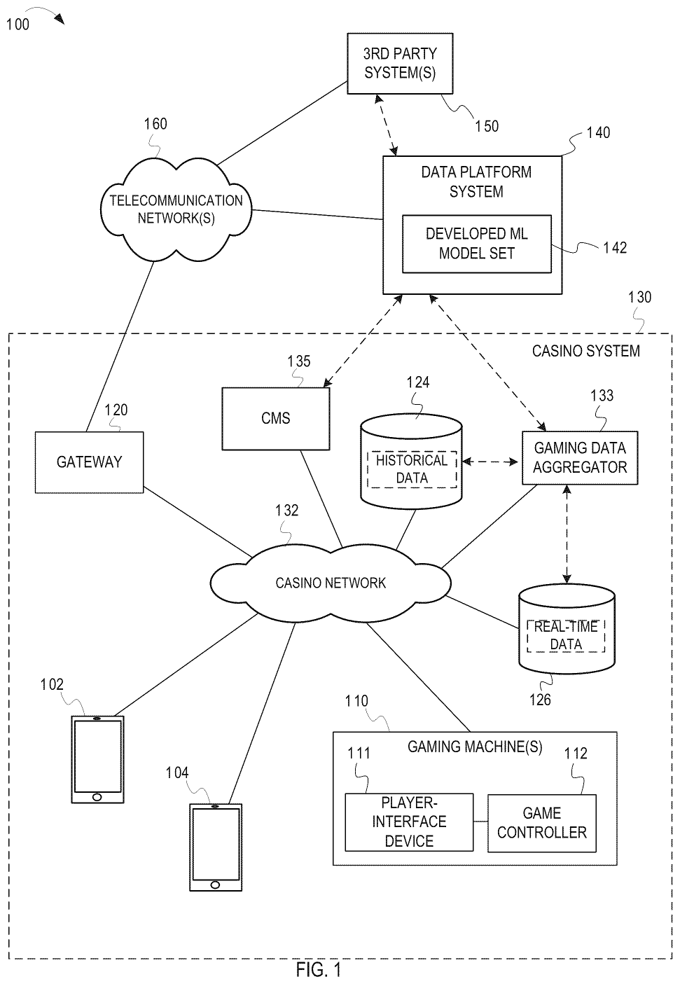

FIG. 1 is a diagram of an example network (“network 100”) according to one or more embodiments of the present disclosure. The network 100 includes a data platform system 140 communicatively coupled (e.g., connected within the network 100) to additional systems and/or devices via one or more telecommunication networks (i.e., “telecommunication network(s) 160”) and via a local casino network 132. In some embodiments, the telecommunication network(s) 160 include, but are not limited to, the Internet, a computer network, a cell phone communication network, etc. A data platform is an integrated set of technologies that enables acquisition, storage, preparation, delivery, and governance of data, as well as a security layer for users and applications. Examples of the data platform system 140 includes the Amazon Web Services (AWS) cloud computing service by Amazon.com, Inc., the Google Cloud Platform (GCP) cloud computing service by Google LLC, the Azure Machine Learning (Azure ML) cloud computing service by Microsoft Corporation, and so forth.

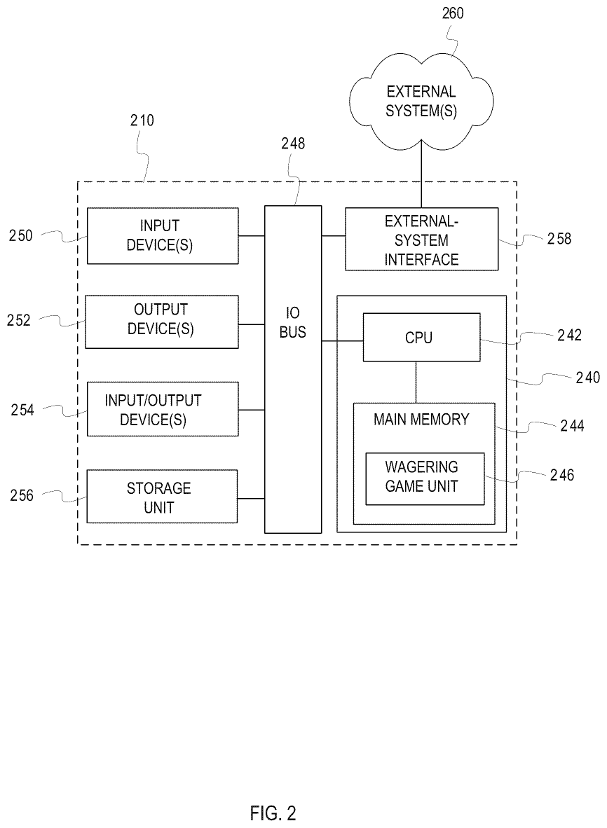

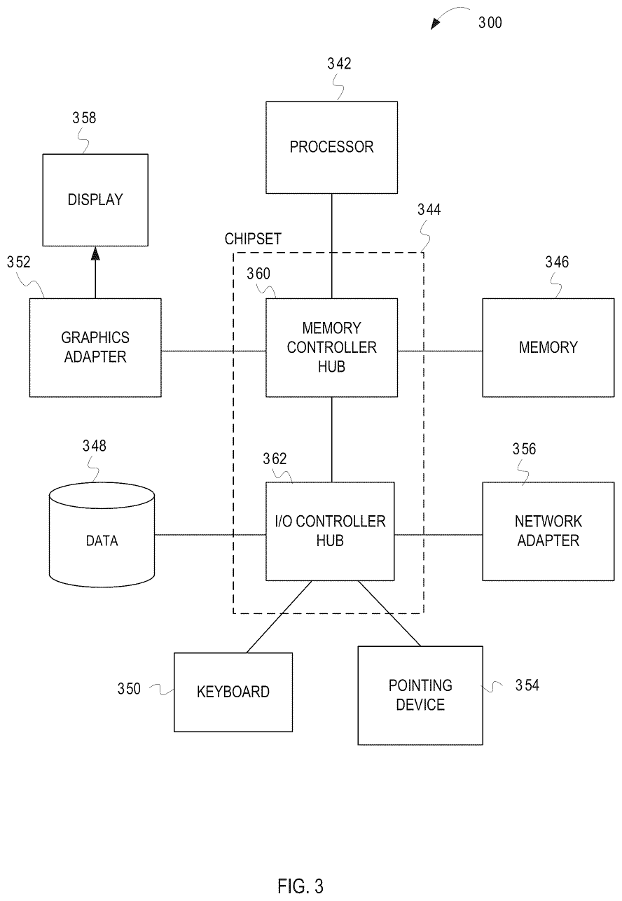

In one embodiment, one of the additional systems or devices communicatively coupled to the data platform system 140 includes a casino system 130, which includes a gateway 120 (e.g., a demilitarized zone (DMZ) Server) gateway communicatively coupled via a gaming network, (e.g., via casino network 132)) to casino management system (“CMS”) 135, which is communicatively coupled to a gaming machine 110. The gateway 120 may be a server, a desktop computer, a laptop, a smartphone, a gaming machine, or other form of electronic device having one or more processors, a computer memory, an electronic communications system (e.g., a bus, a network interface device, a wireless communications device, etc.), etc. For instance, gateway 120 may be computer system 300 described in FIG. 3. The gaming machine 110 includes player interface device 111 and game controller 112. One example of a gaming machine is gaming machine 210 described in FIG. 2. In one example, player interface device 111 may connect to, or be associated with, input/output device(s) 254 and/or external-system interface 258. Game controller 112 may be incorporated with game-logic circuitry 240. Presentation device(s) 114 may be connected to, or associated with, output device(s) 252 and/or input/output devices 254 (e.g., for touch-screen devices). One example of the player interface device 111 includes an iView® player interface device manufactured by Light & Wonder, Inc. The player interface device 111 may be communicatively connected to the gaming machine 110 (e.g., connected via Universal Serial Bus (USB) connection). An example description of the iView® player interface device can be found in United States (U.S.) U.S. Pat. No. 8,241,123 to Kelly et al., the entirety of which is hereby incorporated by reference.

CMS 135 is authorized to perform transactions with, and/or to securely communicate with, player interface device 111. In some embodiments, some combination of one or more of player interface device 111, CMS 135, gateway 120, and/or one or more data storage devices (e.g., database 124, database 126, etc.) may be collectively referred to as a “player tracking system,” a “patron management system,” etc., or more generally as, or part of, the casino system 130. CMS 135 provides (via player interface device 111) “system-based content” and/or “system-based services.” System-based content and/or system-based services may include, but are not necessarily limited to, content related to player benefits, casino services, marketing bonuses, promotions, advertisements, beverage or dining services, or any other information that is relevant to the player's gaming experience other than the wagering game itself. Content for a wagering game may be referred to as game content. Game content, for instance, includes game assets of the wagering game, content related to a bet placed on the game (e.g., bet meters, pay tables, payout/collection, credit meters, number of lines selected for betting, an amount bet per line, a maximum bet, etc.), game play elements of the game (e.g., reels, indicia, game symbols,), game instructions, etc. The term “gaming content,” as used herein, comprises both system-based content and game content. Examples of the CMS 135 include, but are not limited to, one or more of the ACSC Casino Management System® product, the SDS® slot-management product, the CMP® player-tracking product, the Elite Bonusing Suite® product, or the Bally Unified Wallet® product, all available from Light & Wonder, Inc.

In addition, casino system 130 includes a gaming data aggregator 133 configured to aggregate data from various sources and/or to organize data obtained from the sources. In one embodiment, the gaming data aggregator 133 obtains gaming data from database 124, which stores historical data related to players (e.g., stored in SQL or other relational type database) or database 126 which stores real-time data related to players. In one embodiment, the gaming data aggregator 133 (also referred to as “aggregator 133”) aggregates the historical data (e.g., from database 124) and/or the real-time data (e.g., database 126) prior to injecting into an ML model. In one embodiment, the gaming data aggregator 133 is a slot event aggregator or simulator configured to detect regulated gaming activity (e.g., gaming machine events, slot account system (SAS) events, player interface device events, etc.), store the events, classify the events, and prepare the stored event data into an ingestible form as input variables for machine-learning (ML) model analysis (e.g., for feature engineering/extraction analysis). Other sources of data in addition to player data may include game data, accounting data, hotel data, offer data, iGaming data, dining data, retail data, sports betting data, e-commerce data, etc. In one embodiment, the aggregator 133 aggregates a combination of real-time data (e.g., SAS data) combined with historical (e.g., stateful) data. For example, ingested real-time data (e.g., real-time performance of a player or patron) may be distinguished (e.g., separately classified) and evaluated in combination with ingested historical data (e.g., past performance of player/patron) into a single ingestion event prior to being provided to an ML model(s) (e.g., prior to being provided to an ML model from the developed ML model set 142). The two types of data may be used as a comparison with each other and/or to distinguish between past gaming data (e.g., from which one or more past play patterns may be detected by the ML model) and current gaming activity (e.g., current session data) to predict a deviation from past activities.

In one embodiment, the sources that store and/or provide data for aggregation may be the same or similar sources, however the gaming data aggregator 133 categorizes the aggregated data based on timing of the data records (e.g., historical data may include data that occurs within the casino system 130 a certain time period in the past (e.g., events that occurred in the past before a current date, events that occurred beyond a specific time period, events that occurred for past trips before a current trip, etc.), whereas real-time data may include data that occurs most recently (e.g., today, for a current trip, etc.)). Historical data may be referred to herein as static or stateful data. The aggregated data (by gaming data aggregator 133) may be associated with any information obtained via any casino device or related system, such as the CMS 135 (e.g., which stores historical data about one or more users in user accounts, profiles, etc.), the game controller 112 (e.g., which generates SAS events), the player interface device 111 (e.g., which generates system-based data), etc. In one embodiment, the gaming data aggregator 133 uses a message broker that supports multiple messaging protocols and streaming, such as the RabbitMQ™ open-source message broker product by VMWare, Inc. The message broker supports continuous and/or immediate transmission (e.g., broadcasting) of real-time data (e.g., to the data platform system 140).

The network 100 also includes one or more user computing devices associated with the casino system 130, such as mobile devices 102 and 104, used respectively by a player and a casino employee (e.g., mobile device 102 may be referred to herein as a player mobile device, mobile device 104 may be referred to herein as a casino employee mobile device).

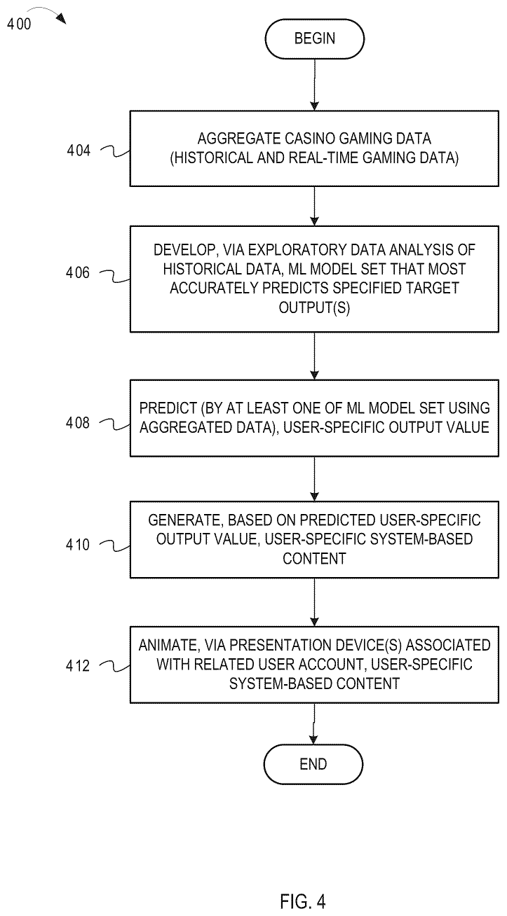

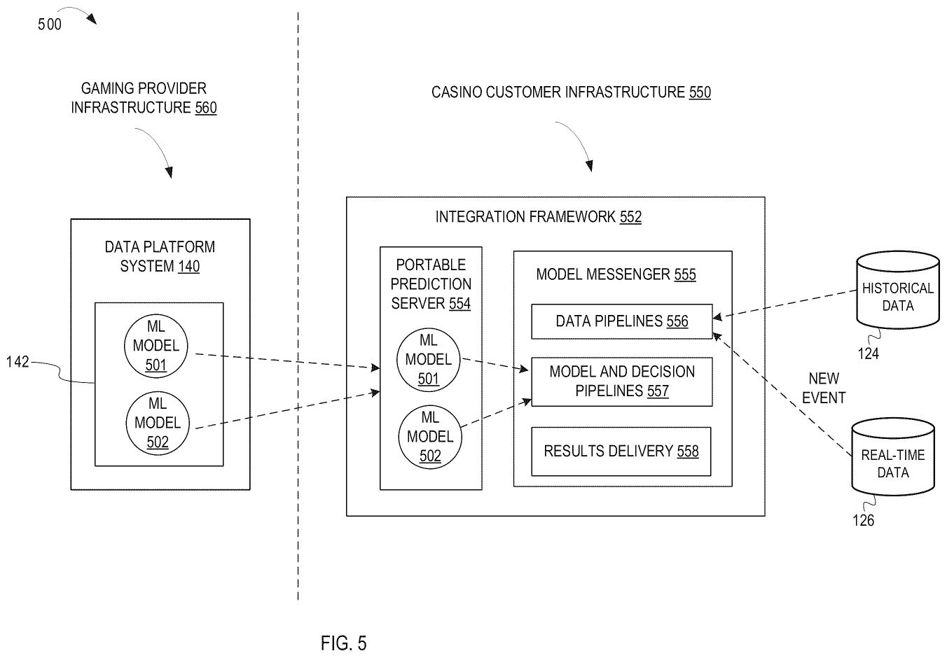

The network 100 aggregates (e.g., via gaming data aggregator 133) casino data (e.g., see 404 of FIG. 4) including historical casino data (also referred to as static or stateful data), and, based on the aggregated data, the network 100 develops (e.g. see 406 of FIG. 4), via data platform system 140, an optimal ML model set (e.g., developed ML model set 142) for the casino associated with casino system 130. The data platform system 140 (and/or the portable predictions server 554 shown in FIG. 5) predicts (e.g., see 408) via one of the developed ML models using the aggregated data (e.g., aggregated real-time data and/or aggregated historical data), a user-specific output value (i.e., a predicted output value of the ML model) such as a predicted user behavior or pattern, a predicted user value or ranking, a predicted user state, etc. The network 100 (e.g., via data platform system 140) further generates user-specific system-based content (e.g., see 410), such as a customized promotional offer related to the predicted, user-specific output value. The data platform system 400 further delivers the user-specific system-based content via a delivery mechanism associated with a location of the user (e.g., by a delivery mechanism that will most likely reach the attention of the user). For example, if the customized promotional offer is directed to a player (e.g., to a player associated with a player account) the network 100 provides (e.g., animates a customized promotional offer) via a presentation device most closely associated with the player (e.g., see 412 of FIG. 4), such as via a presentation device of player mobile device 102. If the user-specific system-based content is related to a casino employee the user-specific system-based content can be sent to a presentation device at a casino employee station or to presentation device of casino employee mobile device 104 (e.g., a message to personally deliver a promotional offer to the player).

The network 100 further includes third-party systems 150 (e.g., social network systems, financial systems, hospitality partner systems, regulator systems, marketing systems, other casino systems, etc.).

FIG. 2 is schematic view of a gaming system according to at least some aspects of the disclosed concepts. Referring to FIG. 2, a gaming machine 210 includes game-logic circuitry 240 (e.g., securely housed within a locked box inside a gaming cabinet). The game-logic circuitry 240 includes a central processing unit (CPU) 242 connected to a main memory 244 that comprises one or more memory devices. The CPU 242 includes any suitable processor(s), such as those made by Intel Corporation and Advanced Micro Devices, Inc. By way of example, the CPU 242 includes a plurality of microprocessors including a primary (e.g., master) processor, a secondary (e.g., worker, helper, etc.) processor, a parallel processor, etc. Game-logic circuitry 240, as used herein, comprises any combination of hardware, software, or firmware disposed in or outside of the gaming machine 210 that is configured to communicate with or control the transfer of data between the gaming machine 210 and a bus, another computer, processor, device, service, or network. The game-logic circuitry 240, and more specifically the CPU 242, comprises one or more controllers or processors and such one or more controllers or processors need not be disposed proximal to one another and may be located in different devices or in different locations. The game-logic circuitry 240, and more specifically main memory 244, comprises one or more memory devices which need not be disposed proximal to one another and may be located in different devices or in different locations. The game-logic circuitry 240 is operable to execute all of the various gaming methods and other processes disclosed herein. The main memory 244 includes a wagering-game unit 246. In one embodiment, the wagering-game unit 246 causes wagering games to be presented, such as video poker, video blackjack, video slots, video lottery, etc., in whole or part.

The game-logic circuitry 240 is also connected to an input/output (I/O) bus 248, which can include any suitable bus technologies, such as an AGTL+frontside bus and a PCI backside bus. The I/O bus 248 is connected to various input devices 250, output devices 252, and input/output devices 254.

By way of example, the output devices 252 may include a primary presentation device, (e.g., primary display), a secondary presentation device, (e.g., a secondary display), and one or more audio speakers. The primary presentation device or the secondary presentation device may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices, the audio speakers, lighting assemblies, and/or other devices associated with presentation are collectively referred to as a “presentation assembly” of the gaming machine 210. The presentation assembly may include one presentation device (e.g., the primary presentation device), some of the presentation devices of the gaming machine 210, or all of the presentation devices of the gaming machine 210. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device and/or the secondary presentation device, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 210. The gaming machine 210 may include a touch screen(s) mounted over the primary or secondary presentation devices, buttons on a button panel, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The input/output devices 254 include one or more value input/payment devices and value output/payout devices. In order to deposit cash or credits onto the gaming machine 210, the value input devices are configured to detect a physical item associated with a monetary value that establishes a credit balance on a credit meter. The physical item may, for example, be currency bills, coins, tickets, vouchers, coupons, cards, and/or computer-readable storage mediums. The deposited cash or credits are used to fund wagers placed on the wagering game played via the gaming machine 210. Examples of value input devices include, but are not limited to, a coin acceptor, a bill/ticket acceptor (e.g., a bill validator), a card reader/writer, a wireless communication interface for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 210. The credits may be exchanged for cash at, for example, a cashier or redemption station. Examples of value output devices include, but are not limited to, a coin hopper for dispensing coins or physical gaming tokens (e.g., chips), a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The I/O bus 248 is also connected to a storage unit 256 and an external-system interface 258, which is connected to external system(s) 260 (e.g., wagering-game networks, communications networks, etc.).

The external system(s) 260 includes, in various aspects, a gaming network, other gaming machines or terminals, a gaming server, a remote controller, communications hardware, or a variety of other interfaced systems or components, in any combination. In yet other aspects, the external system(s) 260 comprises a player's portable electronic device (e.g., cellular phone, electronic wallet, etc.) and the external-system interface 258 is configured to facilitate wireless communication and data transfer between the portable electronic device and the gaming machine 210, such as by a near-field communication path operating via magnetic-field induction or a frequency-hopping spread spectrum RF signals (e.g., Bluetooth, etc.).

The gaming machine 210 optionally communicates with the external system(s) 260 such that the gaming machine 210 operates as a thin, thick, or intermediate client. The game-logic circuitry 240—whether located within (“thick client”), external to (“thin client”), or distributed both within and external to (“intermediate client”) the gaming machine 210—is utilized to provide a wagering game on the gaming machine 210. In general, the main memory 244 stores programming for a random number generator (RNG) and game-outcome logic. Furthermore, in some embodiments, the main memory stores at least some game content (e.g., art, sound, etc.) and/or dynamically generates game content that is approved or authorized for presentation (e.g., the game content has either (1) received regulatory approval from a gaming control board or commission and is verified by a trusted authentication program in the main memory 244 prior to game execution or (2) is dynamically generated via an artificial intelligence model, such as a machine learning model that is trained to generate content that is compliant with regulatory, or other, requirements). In one example, an authentication program generates a live authentication code (e.g., digital signature or hash) from the memory contents and compares it to a trusted code stored in the main memory 244. If the codes match, authentication is deemed a success, and the game is permitted to execute. If, however, the codes do not match, authentication is deemed a failure that must be corrected prior to game execution. Without this predictable and repeatable authentication, the gaming machine 210, external system(s) 260, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 242 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 242 when executing the game-outcome logic to determine a resultant outcome for that instance of the wagering game. The resultant outcome is then presented to a player of the gaming machine 210 by accessing associated game assets, required for the resultant outcome, from the main memory 244. The CPU 242 causes the game assets to be presented to the player as outputs from the gaming machine 210 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 210 may be used to play centrally determined games. Centrally determined games are a type of game whose outcomes are determined by a central server and delivered to player terminals (e.g., to be displayed in an entertaining fashion). It includes, but is not limited to, Class 2 games, electronic pull-tab games, electronic scratch ticket games, historical horse racing, bingo games, etc. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 210 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

FIG. 3 is a block diagram of a computer system 300 according to one or more embodiments. The computer system 300 includes at least one processor 342 coupled to a chipset 344, as indicated in dashed lines. Also coupled to the chipset 344 are memory 346, a storage device 348, a keyboard 350, a graphics adapter 352, a pointing device 354, and a network adapter 356. A display 358 is coupled to the graphics adapter 352. In one embodiment, the functionality of the chipset 344 is provided by a memory controller hub 360 and an I/O controller hub 362. In another embodiment, memory 346 is coupled directly to the processor 342 instead of to the chipset 344.

The storage device 348 is any non-transitory computer-readable storage medium, such as a hard drive, a compact disc read-only memory (CD-ROM), a DVD, or a solid-state memory device (e.g., a flash drive). Memory 346 holds instructions and data used by processor 342. The pointing device 354 may be a mouse, a track pad, a track ball, or another type of pointing device, and it is used in combination with the keyboard 350 to input data into the computer system 300. The graphics adapter 352 displays images and other information on the display 358. The network adapter 356 couples the computer system 300 to a local or wide area network.

As is known in the art, the computer system 300 can have different and/or other components than those shown in FIG. 3. In addition, the computer system 300 can lack certain illustrated components. In one embodiment, the computer system 300 acting as the gateway 120 (FIG. 1) may lack the keyboard 350, pointing device 354, graphics adapter 352, and/or display 358. Moreover, the storage device 348 can be local and/or remote from the computer system 300 (such as embodied within a storage area network (SAN)). Moreover, other input devices, such as, for example, touch screens may be included.

The network adapter 356 (may also be referred to herein as a communication device) may include one or more devices for communicating using one or more of the communication media and protocols discussed above with respect to FIG. 1, or FIG. 2.

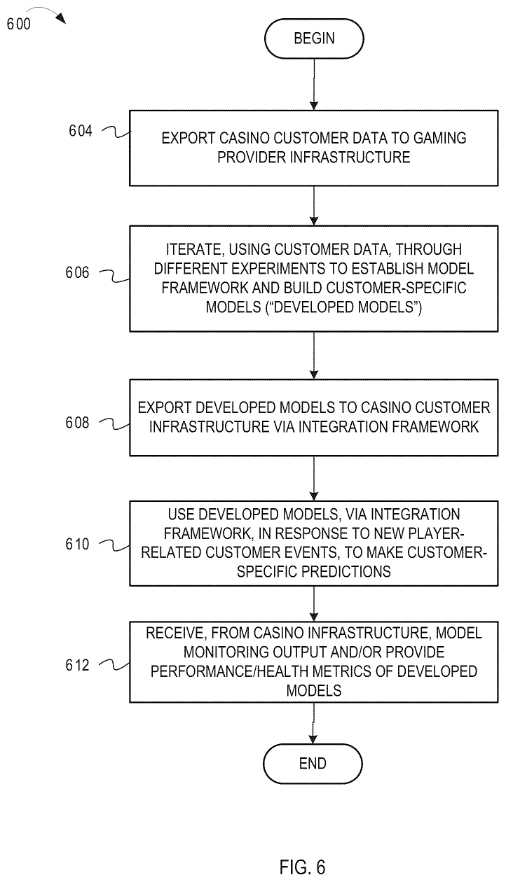

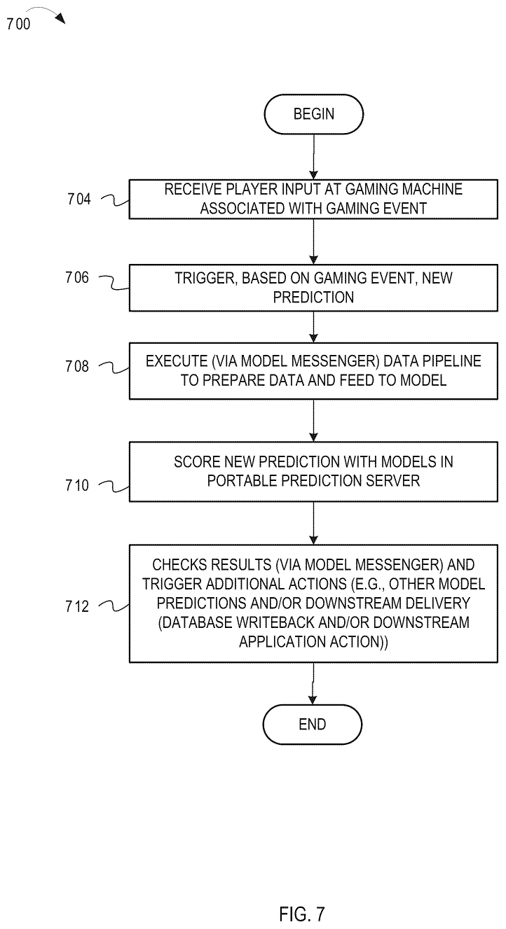

In addition, some or all of the components of this general computer system 300 of FIG. 3 may be used as part of the processor and memory discussed above with respect to the systems or devices described in FIG. 1, FIG. 2, FIG. 4, FIG. 5, FIG. 6, or FIG. 7.

In some embodiments, a gaming system may comprise several such computer systems 300. The gaming system may include load balancers, firewalls, and various other components for assisting the gaming system to provide services to a variety of user devices.

The computer system 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on storage device 348, loaded into memory 346, and executed by processor 342.

FIG. 4 illustrates an example of a method flow (“flow 400”) of dynamically generating models for user-related insights according to one or more embodiments of the present disclosure. The description of FIG. 4 refers to a “processor” that performs operations associated with the flow 400. It should be noted that the reference to the processor may refer to the same physical processor or it may be one of a set of a plurality of processors. The set of processors may operate in conjunction with each other and may be distributed across various networked devices (e.g., across the network 100). The types of processors may include a central processing unit, a graphics processing unit, any combination of processors, etc. In one embodiment, the processor may be included in, or refer to, one or more devices of the network 100, such as any one of the devices connected via the casino network 132 (e.g., gateway 120, CMS 135, gaming machine 110, player interface device 111, etc.) or any device connected via the telecommunications network 160 (e.g., the data platform system 140, third-party system(s) 150, etc.). In one embodiment, the processor may be the central processing unit (CPU) 242 (see FIG. 2) or a processor in another device mentioned herein, such as the processor 342 associated with the computer 300, a table controller, a card-handling device, a camera controller, a game controller (e.g., game controller 112), a gaming server, etc.

Occasionally, the flow 400 will refer to FIG. 1, FIG. 2, FIG. 3, FIG. 5, FIG. 6, or FIG. 7 to describe various embodiments.

Referring to FIG. 4, the flow 400 begins at processing block 404, where a processor aggregates gaming data from a casino system (i.e., casino gaming data). In one embodiment, the processor aggregates casino gaming data associated with a plurality of user inputs received from a plurality of casino devices authorized for secure electronic communications via a gaming network.

In one example, the processor can aggregate, as the casino gaming data, casino-related data (e.g., stored in database 126), such as casino event data, security data, tournament data, hospitality data, loyalty program data, accounting data (e.g., data from a Slot Accounting System (SAS) protocol), patron traffic data, offers, advertising, etc.), gaming machine data, configuration data, game administration data, fault/error correction data, log data, event-history data, etc. Other examples of aggregating casino gaming data may include detecting environmental data, such as data collected about a gaming environment (e.g., around a gaming machine, within a section of a casino, at a specific geographic location, etc.). Environmental data can be obtained via environmental sensors, via security sensors, via patron tracking location/motion detection devices, etc. Yet other examples of aggregating casino gaming data includes detecting calendar or time related events, such as seasonal events, holidays, special casino events, tournament start/end events, travel schedule, etc.

In one embodiment aggregating casino gaming data includes detecting gaming session data. Gaming session data comprises events that occur during a gaming session, such as funding events (e.g., Ticket-In, Ticket-Out (TITO) events, electronic funds transfer, etc.), slot accounting events (e.g., wagering events, win events, loss events, bonus events, payout events), jackpot events (e.g., progressive jackpot events, etc.), or any other event that occurs during regulated gaming activity at a gaming machine, gaming table, etc. The session data further includes user input data by a user seated at the gaming device during a gaming session. The session data can be detected by a processor (e.g., during operation of game activity), via a sensor of the gaming machine or a sensor of an associated player interface device, via a sensor of an environmental display or other device (e.g., data sensed by an environmental motion session, data captured by image sensors at a gaming machine or table, data captured by pressure sensors in a seat, data captured by card entry via a card sensor, etc.). In one embodiment, casino gaming data is detected via a Slot Event Aggregator (SEA) Server to gather data directly from gaming machines on a casino floor.

In some embodiments, aggregating the casino gaming data includes identifying business problems and expected values, collecting data (e.g., combining all relevant data from multiple sources into a single file and ensure all data is collected at the same unit of analysis), and labeling data (e.g., to perform supervised machine learning). For instance, in one embodiment, while aggregating the casino gaming data, the processor configures the aggregated casino gaming data to prepare the stored data in an ingestible form as input variables for machine-learning (ML) model analysis (e.g., for feature engineering/extraction analysis by an exploratory data analyzer). The input variables represent input features (independent variables) to any one of a plurality of machine-learning models associated with a plurality of different types of artificial neural networks. In one example, the gaming data aggregator 133 can extract gaming data (e.g., historical data) from SQL databases using queries and can save the data in a spreadsheet format of delineated data (e.g., a Comma Separated Value (CSV) data format) which delineates input values associated with a particular input variable name.

In some embodiments, aggregating casino gaming data includes organizing and/or annotating the data according to a type, a timing, etc. For example, the gaming data aggregator 133 can organize the data into different categories such as static data (e.g., historical data), real-time data, visit data, player rating data, player identifier, player statistics, count/average of player events/actions that occurred within a certain period of time, etc. Visit data may include, for example visited property name, count/average of visits made in certain number of months, number of trips made on average for different time periods, etc. The data can be organized as a first type (e.g., static/historical data), to train one or more machine-learning models versus a second type (e.g., real-time data), which is used to predict an output for a particular user using the trained machine-learning model(s). The first type (static data) relates to actions or events associated with a plurality of users (or with a specific user) that occurred over a first period of time (e.g., a sufficiently long enough period of time to detect patterns that emerge from analysis of the data); thus the training of the machine-learning models logically deduces user patterns and their anticipated outcomes. The second type of data (real-time data) refers to the most current actions or events associated with a specific user (which can be collected and aggregated as a whole in real time), which current actions or events occur over a second period of time (e.g., a sufficiently short enough period of time to be considered relevant to a current action (e.g., actions that occur during a current visit to a gaming operator, actions that occur during a current gaming session, etc.)).

Referring again to FIG. 4, the flow 400 continues at processing block 406, where a processor develops, via exploratory data analysis of historical data, a machine-learning (ML) model set (“developed ML model set”) that most accurately predicts specified target variable output(s). Exploratory data analysis includes feature engineering, data pre-processing, predictive model experimentation, feature selection, etc.

In one embodiment, the processor trains, via analysis of the aggregated casino gaming data (e.g., via exploratory data analysis of the historical aggregated data) using the aggregated data as informative features (e.g., labeled input variables) for each of a library of machine-learning models. The library can include repositories of source code for a plurality of machine-learning models. The exploratory data analysis identifies at least a portion of (e.g., a subset) of the library of machine-learning models that map the gaming-related data inputs to model parameters that identify or influence a specified target variable output value (e.g., to predict/deduce, via supervised/annotated learning, a player-related behavioral pattern or a player-related rating/score obtained from analysis of the data). In one embodiment, the processor ingests, into each of the machine learning models in the library, the aggregated gaming data (e.g., uses the spreadsheet of aggregated data with identified variables). The processor then trains multiple models with various feature engineering/feature extraction while performing hyperparameter tuning. In one embodiment, an exploratory data analyzer inputs the aggregated historical data as input features for each ML model in a library of available ML models (or for a select subset of relevant ones of the ML models in the library based on types or classifications of input data, target variable output, etc.). The exploratory data analyzer explores (e.g., using an optimization algorithm associated with the model to independently change weights and/or biases, clustering, etc. and/or otherwise optimize hyperparameters values) to learn, for each machine-learning model, the relevant model parameters (e.g., parameters most predictive of the specified target variable output), which map to the most relevant (e.g., most informative) input features. In one embodiment, at least a portion of the exploratory data analysis can be performed by an AI automation tool, such as the DataRobot™ automated machine learning platform available from DataRobot, Inc.

In response to the training, the processor selects (from the library of models) an optimal ML model set (e.g., the subset of models from the library that produces the most accurate prediction(s) for a target function specified by target variable output(s)). The subset of optimal ML models may be referred to herein as the “developed ML model set” (e.g., developed ML model set 142). In some embodiments, the data platform system 140 can be made available (e.g., via subscription) to a plurality of different casino customers (e.g., each casino has a uniquely configured casino system 130 and/or unique business needs). The data platform system 140 can generate a different developed ML model set 142 for each casino customer. Thus, each different developed ML model set 142 can be uniquely tailored to the needs or requirements of each casino. For instance, each developed ML model set 142 can include the subset of ML models that best fit the casino-specific gaming data and/or the specified target variable outputs. Thus, the developed ML model set 142 can be unique to any given casino given the unique needs, requirements, characteristics, etc. of each different casino customer. In one embodiment, the data platform system 140 provides a subscription service to which different casino entities can subscribe (e.g., at different subscription levels), and can use the service to upload data and specify output requirements for automated ML analysis based on their unique needs, requirements, characteristics, etc. In one embodiment, the subscription service can be available via an integration framework (e.g., integration framework 552 described in association with FIG. 5). For example, as shown in FIG. 5, a gaming provider (e.g., Light & Wonder, Inc.) controls the data platform system 140 via a gaming provider infrastructure 560 (which includes the data platform system 140). The data platform system 140 offers a subscription service to a plurality of casino operators, each with their own casino customer infrastructure 550. The integration framework 552 is installed within the casino customer infrastructure (e.g., within in the casino system 130 described in FIG. 1). The integration framework 552 includes a portable prediction server 554 that copies, from the data platform system 140, the developed ML model set 142 (which includes, for instance, ML model 501 and ML model 502). The integration framework also includes a model messenger 555 that incorporates data pipelines 556 (e.g., from sources such as databases, files, etc. that store gaming data and/or via a messaging service that notifies real-time events). The model messenger 555 further includes model and decision pipelines 557 configured to make decisions related to use of the ML models available from the portable prediction server 554. The model messenger 555 may further include a results delivery component 558 to specify information related to use of a particular ML model, predicted outputs of an ML model, explainability and/or evaluation tools, etc.

Referring again to processing block 406 in FIG. 4, as described, the developed ML model set 142 (e.g., the ML model 501 and ML model 502 shown in FIG. 5) includes the subset of ML models from the library that produce the most accurate prediction(s) for the specified target variable output(s). In some examples described herein, the specified target variable outputs may be referred to as “player-insights”, or in other words an ML model output value predictive of a player-related behavior (e.g., a specific action, a specific pattern of activity, a specific pattern of inactivity, a specific inaction, etc.). Examples of predicted gaming-related insights include player behaviors related to a break point (also referred to as a “breakpoint”) or churn point (also referred to as a churn rate or simply as churn). A player churn point is related to whether a player will stop playing a wagering game within a given period (e.g., after one gaming session). A player breakpoint is related to a point in time that a player breaks from a given pattern of play (e.g., a point at which a player begins betting at a different rate than average, a point at which a player slows down play, etc.). For example, in one embodiment, the integration framework 552 described in FIG. 5 includes one or more configuration tools to request or suggest aggregation and ingestion of certain data types or certain input variables in order to develop specific ML model sets that generate an accurate prediction of the player-related behavior (e.g., the break point or churn point). In one embodiment, the integration framework 552 includes an automated data ingestion tool configured, according to some embodiments, to extract and aggregate data from various casino data sources, migrate the data to the data platform system 140, transform the data (e.g., clean the data, enrich the data, reformat the data, etc.), require or recommend specific input variables, etc.

In one embodiment, the integration framework 552 includes one or more configuration tools to combine certain classifications of data sets during training/exploratory analysis for a specified target variable output(s) (e.g., for a break point analysis). For example, in one embodiment, the configuration tool evaluates data from both a first source (e.g., first spreadsheet) containing historical “trip data” and a second source (e.g., a second spreadsheet) containing historical session data during training/exploratory analysis to predict an initial player break point. The trip data is related to a player trip or visit to a casino property, such as a trip number, a casino property name, a number of days played, a time played, a number of days since a previous event by a player account/profile identifier (e.g., UniversalPlayerID), comps redeemed, and so forth. The session data includes information about a time of day of the session, an amount of time played during the session, an amount won during the session, a player rating for the player that plays during the session, the player account/profile identifier (e.g., UniversalPlayerID), etc. In another example, the configuration tool can further evaluate offer redemption data from a third source (e.g., a third spreadsheet) which specifies offers extended to, and/or redeemed by players. The offer redemption data includes, but is not limited to, an offer name, an offer type, an offer date, a redemption date, a player account/profile identifier (e.g., UniversalPlayerID), etc. The trip data, session-level data are combined onto the offer redemption data to identify what predicts offer propensity (e.g., to identify what predicts a likelihood or degree of influence that the player will redeem an offer, such as to delay or prevent a predicted breakpoint, to identify or predict a category of offer to send to a player after visiting the casino, etc.).

The integration framework 552 includes one or more configuration tools or settings that can suggest how to predict other gaming-related outputs for various use cases. As described, one use case includes player breakpoint or churn analysis. Another use case includes detecting/predicting a responsible gaming play pattern. For example, the integration framework 552 can be used to detect a deviation in normal player behavior play that indicates bad decision making. For instance, the integration framework 552 can predict a level of erraticness to a player's behavioral pattern, which indicates a signal of irresponsible gaming (e.g., player begins to bet at a faster pace, player begins to deviate from optimal play, player begins to deviate from a detected strategy skill/capability of the player, etc.).

Another use case includes detecting/predicting a bad action (e.g., money laundering event, suspicious activity, card-counting pattern, etc.)).

Another use case includes detecting/predicting a player-related rating, (e.g., a predicted player lifetime value, a predicted anonymous player rating value). Determination of a player lifetime value, for instance, includes evaluation of all data associated with a player including data obtained about the player on the gaming floor (e.g., gaming session data) as well as data about the player regarding actions or events that occur across all facets of a casino property (e.g., across all areas of a resort, including retail, restaurants, hotel, etc.). The player lifetime value can be related to a prediction in time or sequence, such as first predicting the player value “on the gaming floor” (e.g., a player value related to playing wagering games), then second predicting the player value “off the casino floor” (e.g., a player value to a restaurant). Determination of an anonymous player rating can include threading TITO tickets with unique serial numbers (e.g., threads together the TITO serial number from a first gaming machine to a TITO ticket serial number at a second gaming machine, and so forth,) indicating a chain of activity, hence a degree of user activity. For instance, the data platform system 140 aggregates and organizes the disparate TITO ticket serial numbers according to a timeline by a particular user (e.g., Ticket in serial number 1 is tracked, then when inserted into second machine, second serial number is tracked, and then correlates the data to a single user). Based on the correlation, the data platform system 140 determines a pattern of play, amounts of credits input, credits output, etc. as related to an unrated player. Based on the determined patterns, credits spent, etc., the data platform system 140 can identify, when to start developing the unrated player for a player rating (associated with a patron loyalty account) and/or promotional offers to offer to the player (e.g., via a patron loyalty account).

Another use case includes detecting/predicting a player-related sentiment or state (e.g., a likely player emotional state, a predicted group/tribal gaming sentiment or action, a predicted forecast of a number of players/guests, etc.). For example, the data platform system 140 can identify tribal gaming groups, or in other words, can identify which individuals within a casino are associated with the same group, what their individual player ratings are, how they are associated with each other, etc. For instance, the data platform system 140 can identify the groups based on the data from various locations or sources (e.g., based on casino camera footage across the casino property, based on gaming session data showing proximity to each other at gaming machine banks or gaming tables, based on trip data indicating related or associated individuals in a party, based patron records having similar last names, etc.). Based on the predicted relationships of players within a group, the data platform system 140 can provide offers to the group as a whole. For instance, the data platform system 140 can identify high activity players versus less active players. However, if the data platform system 140 detects a relationship between a high activity player and a less activity player, the data platform system 140 can provide similar offers of hospitality, comps, etc. to the player with less activity as they would to the high activity player simply because the player with less activity is determined to be within the entourage of the group as a whole, and the offer provided to the player with less activity can affect (e.g., induce) an increase of play of the group as whole.

Another use case includes detecting/predicting a player classification (e.g., player segmentation via clustering). For example, the data platform system 140 can experiment with player segmentation through clustering modeling and/or can analyze player segments by visit behavior. The segmentation involves classifying similar customers into a same segment to better understand player demographics, behaviors, etc.

In some embodiments, the data platform system 140 can automatically build/develop models for various use cases using various types or classifications of models. For example, breakpoint analysis involves a binary classification model, an offer propensity analysis involves a multi-class/multi-label model, a player segmentation analysis involves a clustering model, and so forth.

In addition to building a developed ML model set, the data platform system 140 can deploy (e.g., via the integration framework 552), the developed ML model set 142 along with evaluation tools to describe the analysis results and/or to explain or specify the informative features. For example, the data platform system 140 can present the developed ML model set via a leaderboard which organizes a ranking of ML models (from the developed ML model set) based on how accurate they were determined to be via the exploratory analysis. For example, the leaderboard can present a ranked list showing the ML models that rank best based on certain accuracy criteria (e.g., the highest feature impact, the highest predictive output for a target variable, the greatest number of information features mapped to model parameters, the highest cross validation, etc.). The evaluation tools assess where a model is accurate and where it is not accurate. Furthermore, the evaluation tools include explainability tools that identify and communicate what is driving a model behavior. For example, for a breakpoint analysis for an individual player at the session level, the explainability tools identify a prediction value along with explanations for the predicted value (e.g., the explainability tool specifies that “this particular player-session has 97% likelihood to be breakpoint session. Primary explanations include: the time of the session is 5 AM; the player played 39 minutes this session; the player won 79590 credits.”).

In one embodiment, the evaluation tools can specify a type of classifier for an ML model. For instance, the evaluation tools can specify a type of classifier (from the developed ML model set 142) that uses the most number of informative features indicated by the aggregated data than any other type of classifier in the set. The evaluation tools can further automatically present documentation for a classifier, which includes data about all hyperparameters (tunable parameters) used. The evaluation tools can further generate a visual representation (e.g., a graph) that specifies how each of the informative features impacted the output;

Referring again to FIG. 4, the flow 400 continues at processing block 408 where the processor predicts (using real-time data, historical data, some combination, etc. with optimal ML model set) user-specific output value(s). For example, the data platform system 140 (and by extension the integration framework 552 which accesses the developed ML model set 142 via the portable prediction server 554) predicts, using a deployed one ML model (e.g. the highest scored/ranked ML model in the developed ML model set 142) to analyze aggregated data associated with one or more specific users (e.g., to analyze historical data of the user to determine a particular playing pattern of the player over time, to analyze individual real-time user data used for real time testing/performance (not for training), etc.) to predict one or more specific player insights (e.g., to predict user-specific output value(s) related to the player insight). The aggregated data includes specific data records data linked to a specific user (e.g., either via a direct identifier, such as a user-account identifier, or via a plurality of connective data links (e.g., slot account record identifiers, group identifiers/markers, etc.) that relate the record of data to the specific user)). The user-specific output value indicates a probability value that the specific user is engaged, in real-time, in a user-specific pattern associated with a predicted output value.

Referring again to FIG. 4, the flow 400 continues at processing block 410 where the processor generates, based on the user-specific output value(s), user-specific system-based content to present. The system-based content generated may also be referred to herein as casino content. For example, the data platform system 140 and/or integration framework 552 determines, based on the predicted player, an optimal gaming promotion to present to a player (during real-time or thereafter) via a presentation device associated with the player (e.g., via player interface device 111 at gaming machine 110 at which the player is carded, via player mobile device 102, via a user interface or display signage at a gaming table at which the player is seated, etc.).

In one embodiment, the gaming promotion/offer may be an ML model output value determined from an offer propensity model that has various categories (e.g., seven different categories of offers), which are intended to be sent to a player (e.g., at some point after the player performs a first gaming activity at a casino). The gaming offer is selected to induce an action of the user related to gaming or to be performed in the gaming environment, such as an inducement to facilitate or expedite an occurrence of a behavior for the predicted user-specific output value or, conversely, an inducement to prevents an action associated with the user-specific output value. The processor can further specify an insight and/or actionability related to the promotion, such as an expected increase or decrease in percentage of a specific activity intended to occur based on offering the promotion to the player. The data platform system 140 and/or integration framework 552 can further customize the offer to a particular player or a party associated with the player (customized to the player or to the group associated with the predicted user-specific output value). In some embodiments, the gaming promotion/offer may be a custom play enhancement object that indicates a play enhancement operation, of the wagering game, customized to the detected play pattern. For instance, the play enhancement object includes an offer to extend play or increase a velocity of play (e.g., “in the next 10 minutes gets 8X points on play”).

Because the data platform system 140 and/or integration framework 552 can provide, in real-time, an inducement to prevent the predicted user pattern, the data platform system 140 and/or integration framework 552 can prevent an undesired behavior more quickly than possible (i.e., due to real-time detection of deviations in patterns specific to the user and real-time inducement of continuous engagement). Thus, rather than waiting a typical marketing cycle (e.g. 6 months) to determine whether the player is inactive then contacting the user with an offer of inducement (as is typically done for marketing), the data platform system 140 and/or integration framework 552 can instead detect, in real-time, a real-time reduction is engagement (reduction in play, slight deviations from normal patterns as they occur) to offer incentives in real-time that keep up a level play based on the slight deviations (e.g., easier to keep the casino patron engaged with inducement activities based on the real-time reduction in play as opposed to trying to win back the patron after being inactive for 6 months).

Referring again to FIG. 4, flow 400 continues at processing block 412 where the processor animates, via a presentation device associated with the gaming machine, the user-specific system-based content. As mentioned, the data platform system 140 and/or integration framework 552 can provide system-based content (e.g., an offer) via various delivery mechanisms (e.g., audio and/or visual presentation devices, electronic messaging devices, speakers, signage, displays, mobile devices, etc.). The data platform system 140 and/or integration framework 552 customizes the offer based on the delivery mechanism. For example, the integration framework 552 can animate (e.g., via the player interface device 111) a custom play enhancement object that a user can select (e.g., touch via touch screen, accept via button press, via drag-and-drop, etc.). In some embodiments, the integration framework 552 includes delivery mechanisms to provide the offer via various apps, devices, locations (e.g., based on user location). The integration framework 552 can make determinations regarding which type of delivery mechanism to use (e.g., mobile device delivery versus in-casino device delivery), how the delivery appears in an application, how the offer/promotion data is customized to a player, etc.

Referring again to FIG. 5, an example is shown of a two-server system involving a first server (e.g., a centralized server communicatively coupled to the data platform system 140) which builds and deploys the models and exports the deployed model to a second server (e.g., such as a server of a casino operator communicatively coupled to the integration framework 552). The second server (e.g., portable prediction server 554) is associated with a customer account (e.g., the gaming provider infrastructure 560 provides a service to customers who can subscribe to use of the integration framework 552). In some embodiments, the first server builds and deploys the model based on aggregated data from a variety of third-party entity accounts (e.g., from a plurality of different casino operators). In one embodiment, the second server can run a deployed model to aggregate gaming-related data associated with a plurality of users of the third-party entity (e.g., of users from the casino operator). The model (running on the second server) communicates with (sends model monitoring output to) the first server, which first server provides performance metrics of the model. The first server (e.g., data platform system 140) includes production-grade API endpoints that allow the developed ML models to be reliably integrated into the integration framework 552.

The integration framework 552 is customizable to each casino customer that subscribes to the service provided by the data platform system 140. The data platform system 140 and/or integration framework 552 thus provide tools that permit different customers to meet different needs or requirements (e.g., to have varying levels of data for exploratory analysis/training, to develop different ML model sets, to predict different target outputs, and so forth). The system can determine, based on the amount or nature of the data from a customer how to customize a model. Further, based on subscription levels, the tool can provide different levels of models, analysis, response, etc. In some embodiments, a degree or quality of service provided by the data platform system 140 is based on a degree or level of service subscription of the third-party entity (e.g., the casino customer) associated with the casino customer infrastructure 550, including (1) different levels or degrees of data aggregation for each customer, (2) different levels of access to given models, (3) different customized models specific to a given customer, etc.

FIG. 6 and FIG. 7 illustrate data flows for methods examples associated with the architecture illustrated in FIG. 5.

The description of flow 600 will refer to FIG. 5 and FIG. 7 for further details. Referring to FIG. 6, flow 600 begins at processing block 604, where a processor exports customer specific data to a gaming provider infrastructure. For example, the data platform system 140 aggregates data from the casino customer infrastructure 550 (e.g., from database(s) 124 and/or 126). The customer data is exported from the casino customer infrastructure 550 to the data platform system 140 to generate the developed ML model set 142. In one example, a casino customer may require more features from the subscription service than other customers. For example, one casino customer has more complexity to their data than another casino customer, thus the deployed ML model set built for a first casino customer may generate ML models that are more detailed or specific to the aggregated data (e.g., degree of data, level of data organization, amount, etc.) than for a second casino customer with lesser detailed data. Thus, the deployed ML model(s) are customized to the data and/or needs of the casino.

Referring again to FIG. 6, flow 600 continues at processing block 606, where a processor iterates, using customer data, through different experiments to establish model framework and build customer-specific models (“developed models”). For example, the data platform system 140 iterates through different experiments (e.g., via the exploratory data analysis described at processing block 406) to obtain the developed ML model set 142.

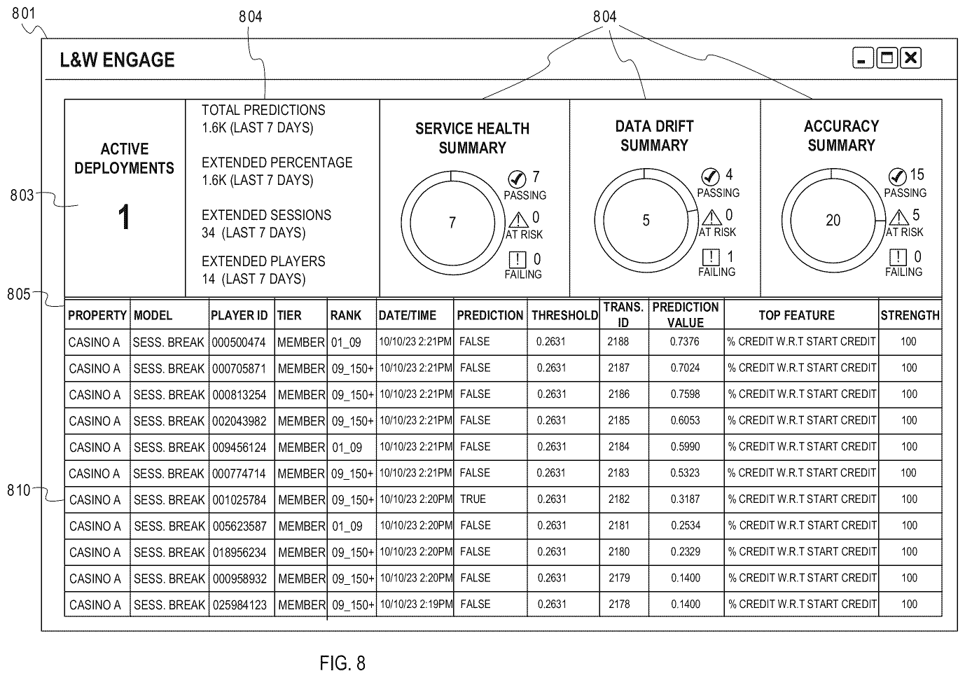

Referring again to FIG. 6, the flow 600 continues at processing block 608, where a processor exports the developed models to a casino customer infrastructure via the integration framework. For example, as shown in FIG. 5, the data platform system 140 exports the developed ML model set 142 to the portable prediction server 554 of the integration framework 552. In one example, the processor further presents, as shown in FIGS. 8, 9, and 10, a user interface 810 which the integration framework can animate and present to a casino customer regarding the exported (e.g., deployed) ML model and predictions made by the portable prediction server 554. Section 803 illustrates a number of deployed ML models (e.g., a session breakpoint model) used to generate predictions on aggregated data, including for real-time play.

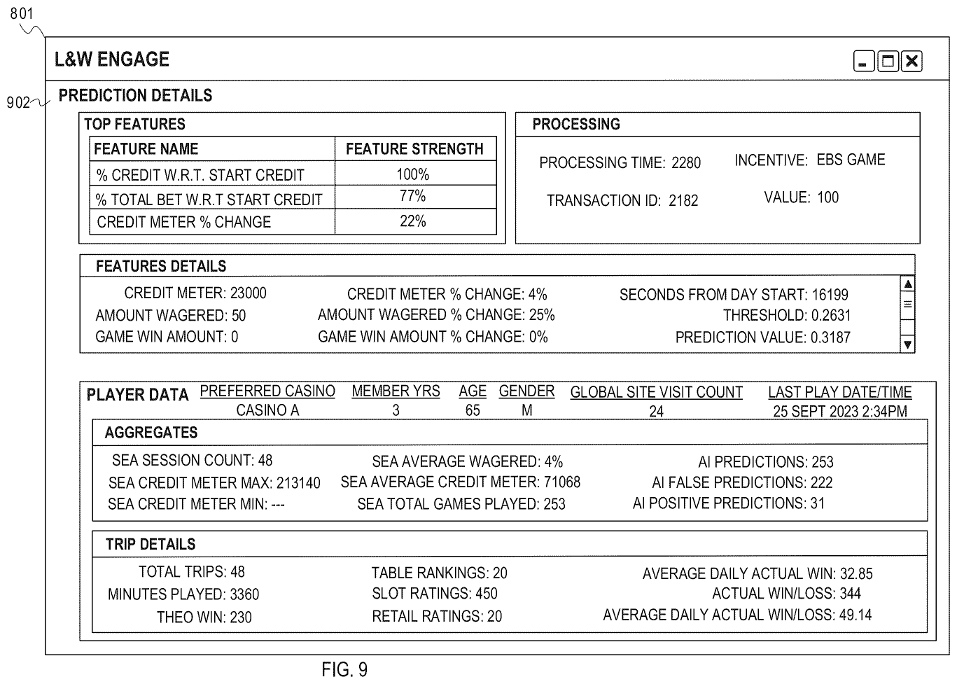

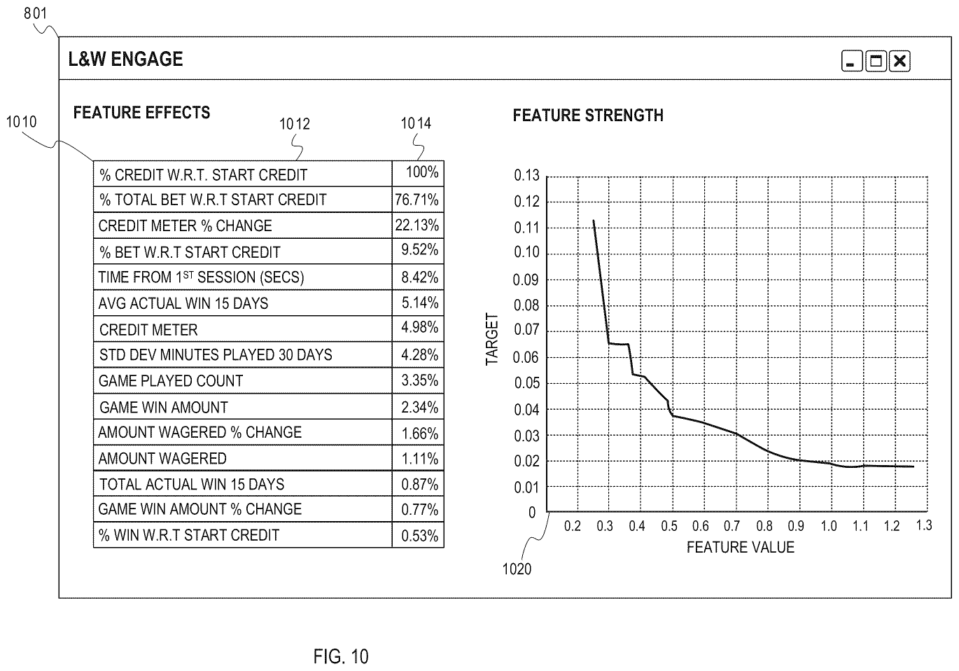

Referring again to FIG. 6, flow 600 continues at processing block 610, where a processor uses the developed models, via the integration framework, in response to new player-related customer events, to make customer-specific predictions. For example, as shown in FIG. 5, a new event occurs via aggregation of real-time and/or historical data. FIG. 7 illustrates a data flow 700 that makes customer-specific predictions based on a new event according to one embodiment. For instance, referring to FIG. 7, at processing block 704 of flow 700, a gaming machine (e.g., within the casino customer infrastructure 550) receives player input (e.g., wagering inputs) associated with a gaming event (e.g., a real-time game event that occurs during a gaming session). At processing block 704 of flow 700, the portable prediction server 554 triggers, based on the real-time gaming event, a new prediction event (e.g., a prediction event is a real-time request to generate a customer-specific prediction, as described in more detail at processing block 408). In one embodiment, the real-time gaming event(s) is/are evaluated against (e.g., compared to, contrasted with, etc.) historical gaming events of the same player, thus producing a more accurate and robust customer-specific (e.g., patron-specific) prediction. At processing block 708 of flow 700, in response to triggering a new prediction event, the model messenger 555 executes a data pipeline (e.g., from data pipelines 556) to prepare the data and to feed (e.g., via the model and decision pipelines 557) the prepared data to one or more of the ML models residing within the portable prediction server 554. At processing block 710 of flow 700, the portable prediction server 554 scores a new prediction using at least one model (e.g., the highest ranked ML model on a leaderboard presented by the evaluation tools of the integration framework 552). The ML model returns a prediction score (e.g., a predicted output value). At processing block 712 of flow 700, the model messenger 555 checks the results of the prediction for accuracy and/or validation. Further, the model messenger 555 triggers additional actions based on the results of the prediction. For instance, the model messenger 555 can trigger other model predictions, provide a downstream delivery (e.g., a database writeback, a downstream application action, etc.), and so forth. Referring momentarily to FIG. 8, section 804 illustrates summary information about a number of predictions made as well as any information about results of the predictions and presentation of incentives that extended a session beyond a breakpoint. FIG. 8 also illustrates a section 805 with an animated listing (which updates concurrently with the generation of a new prediction for each new real-time game play performed by a casino patron (of fictitious casino named “Casino A”). The listing in section 802 shows details about each prediction in each row, including, but not limited to: the casino customer name, the ML model name used to make the prediction, a player identifier that performed the real-time play event, player information such as player member status or rank, a date/time of the prediction, prediction information such as whether the prediction was true or false (e.g., did the prediction accurately predict the breakpoint event) a threshold value for a numerical prediction output, an actual numerical prediction value output of the ML model, a transaction identifier, a top feature used to inform the prediction, a prediction strength of that top feature, etc. The listing can be sorted, such as by the ML model that made the prediction. The listing can also be filtered by top feature, by prediction, etc. FIG. 9 illustrates, via the user interface 801 prediction details 902 about one of the particular predictions listed in the section 805, such as the details for the prediction of row 810. As shown in FIG. 9, the prediction details 902 includes, but is not limited to, information about top features that were used for the ML model prediction, processing information, features details, and player related data (e.g. player account information, player statistics, player profile data, summary aggregated data for the player, trip details for the player, etc.), and so forth. FIG. 10 illustrates additional information related to the prediction, including an animated feature impact chart 1010 with a column 1012 that names the feature (e.g., variable name) used for the prediction as well a corresponding column 1014 that indicates a feature impact score (e.g., a percentage of impact or effect that the particular feature had in predicting the ML model output relative to other features). A chart 1020 specifies a feature strength (for any given feature selected from the chart 1010) charted according to a value range for a target variable (e.g., on the Y-axis) and the values found for the feature.

Referring again to FIG. 6, flow 600 continues at processing block 612, where a processor receives, from casino infrastructure, model monitoring output and/or provides performance/health metrics of developed models. For example, end users of a casino operator can log in to the tool provided by the integration framework 552 to see the performance and health of their customer-specific deployed ML models. Examples of performance/health metrics include metrics associated with data drift, accuracy of the model predictions, a service health, bias and fairness, customer-defined key performance indicators (KPI's), etc. The integration framework 552 automatically notifies the data platform system 140 of the performance/health metric changes in real-time. The data platform system 14 can automatically adapt any of the developed ML model set 142 to any changes in the performance/health metrics (e.g., adapts models to new data when performance begins to decay). By monitoring every model, the data platform system 140 can quickly adapt to new data and player behavior when model performance is beginning to decay. FIG. 8 illustrates an example of animated, automatic notifications via sections 804 of model performance and/or health metrics. The animated notifications can include graphs with indicators (e.g. color-coded indicators, graphs, etc.) showing a number of performance and/or health related metrics.

Examples of additional embodiments associated with the architecture descried in FIG. 5 includes providing external data pipelining (e.g., caching stateful/static data) for low-latency scoring, enabling multi-model pipelining (e.g., chaining models together with business/decision logic), and last-mile delivery of prediction results (e.g., via database write out and/or delivery to downstream applications).

Certain challenges exist for gaming operators (e.g., casinos) and patrons. One challenge is an inability to quickly and accurately locate and provide game information. With so many games available on a casino floor, it can be overwhelming for both employees and patrons to identify top performing games, trending games, favorite games, or relevant details of a game, resulting in user confusion or uncertainty. Another challenge is struggling with inefficient machine maintenance in the casino. Yet another challenging aspect in the casino industry involves operating thousands of slot machines full-time, resulting in massive generation of data and frequent breakdowns. Identifying the root cause of these issues and resolving them swiftly becomes a challenging task for a technician. Another challenge is a lack of efficiency in staffing scheduling within casino operations. Effective scheduling and staffing are crucial for smooth operations of a casino. Using manual methods often leads to poor staffing and resource allocation impacting customer experiences negatively. Another challenge involves accurately and consistently targeting player engagement and retention. Casinos often struggle to reach the right player at the right moments. This ultimately results in missed opportunities for player retention and engagement, hence failing to create effective offers and promotions for a player.

Some embodiments involve analyzing various types of data (e.g., machine, operator/operational, player, employee, etc.) to solve challenging technical problems of the gaming systems industry. One embodiment involves a gaming-provider (e.g., Light & Wonder, Inc referred to herein as “LNW” or “L&W”)) artificial intelligence (AI) application tool (referred to herein as the “AI tool,” an “AI ecosystem” or an “AI system”). The AI tool provides a cost-effective solution to manage employees, help hosts identify potential players, obtain a list of top games for players, automate maintenance of slot machines, and so forth. The AI tool further allows customers to build custom models. In some embodiments, the custom models generated via the AI tool are accessible via an application store (referred herein as an “app store”) with a model-as-a-service (MaaS) structure.

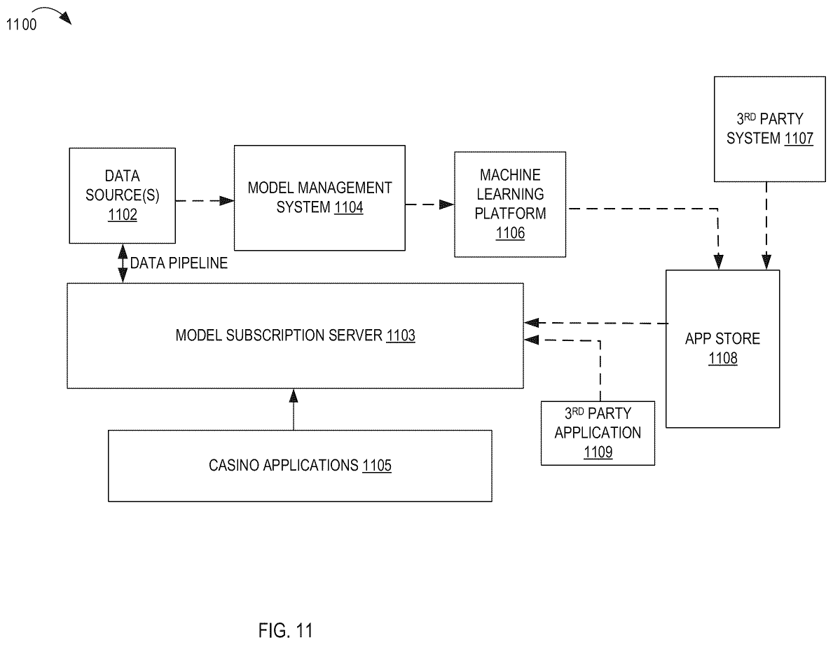

FIG. 11 illustrates an example architecture 1100 and associated flow elements according to some embodiments of the present disclosure. The example architecture 1100 is for an AI tool (e.g., a model ecosystem) that creates models and deploys them in a cloud space as a model-as-a-service. The architecture 1100 includes one or more data sources 1102 (e.g., database(s), casino management program(s), slot data system(s), third-party data source(s), etc.), a model management system 1104 (e.g., running a model management application), a machine learning platform 1106 (e.g., an autoML system, a composable ML system, etc.), an app store 1108 (e.g., an online application store), and a model subscription server 1108. In some embodiments, the machine learning platform 1106 (or any machine learning platform described herein) may be incorporated into, or be available via, a data platform system (e.g., via data platform system 140).

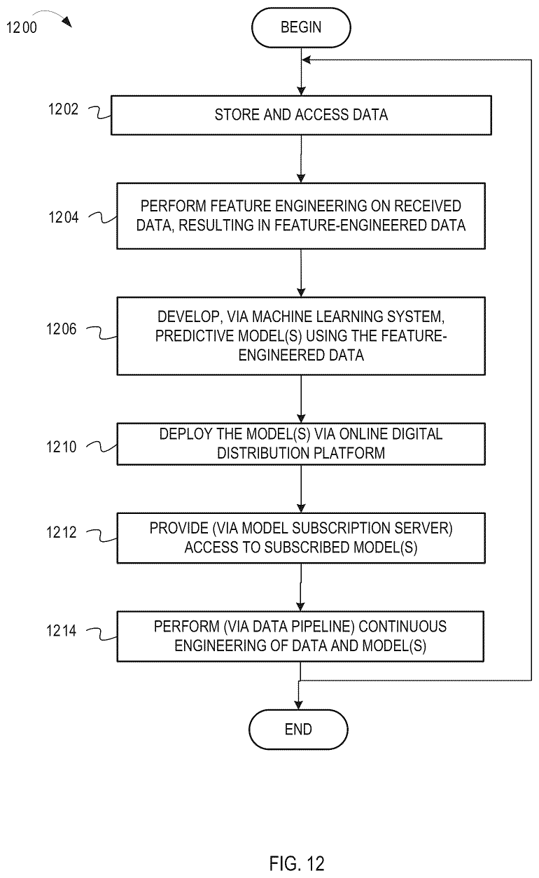

FIG. 12 illustrates a flow 1200 associated with an example use of the architecture 1100 according to some embodiments of the present disclosure. The flow 1200 is described in association with FIG. 11 and will refer to elements of FIG. 11. The description of the flow 1200 refers to a “processor” that performs operations associated with the flow 1200. It should be noted that the reference to the processor may refer to the same physical processor or it may be one of a set of a plurality of processors. The set of processors may operate in conjunction with each other and may be distributed across various networked devices (e.g., across the network 100, via the components of the architecture 1100, etc.). The types of processors may include a central processing unit, a graphics processing unit, any combination of processors, etc. In one embodiment, the processor may be included in, or refer to, one or more devices of the network 100, such as any one of the devices connected via the casino network 132 (e.g., gateway 120, CMS 135, gaming machine 110, player interface device 111, etc.) or any device connected via the telecommunications network 160 (e.g., the data platform system 140, third-party system(s) 150, etc.). In one embodiment, the processor may be the central processing unit (CPU) 242 (see FIG. 2) or a processor in another device mentioned herein, such as the processor 342 associated with the computer 300, a table controller, a card-handling device, a camera controller, a game controller (e.g., game controller 112), a gaming server, etc.

Referring to FIG. 12, the flow 1200 begins at processing block 1202, where a processor stores and accesses data. For example, the processor can store (e.g., aggregate) data via data source(s) 1102. The data includes, but is not limited to gaming data, casino operator data, historical gaming data, real-time gaming data, gaming environment data, gaming patron data, casino operator data, casino employee data, hospitality data, promotions data, services data, machine maintenance data, game data, game play data, location data, scheduling or calendaring data, travel/visit data, etc. In some embodiments, the processor obtains data from database(s), casino management program(s), slot data system(s), third-party data source(s) (e.g., a market research provider, social networks, etc.), and so forth.

Flow 1200 continues at processing block 1204, wherein a processor performs feature engineering on received data, resulting in feature-engineered data. For example, in FIG. 11, the data sources provide, to the model management system 1104, data from the data sources, which, in response to user input via a model management application, selects, manipulates, and transforms measurable input from the data sources into features (e.g., data columns in a spreadsheet), which spreadsheet can be used in supervised learning. The model management application (running on the model management system 1204) performs, and/or provides options for performing, feature engineering on the data. In one embodiment, the model management application uses a Python Pandas library to prepare the data set.

Flow 1200 continues at processing block 1206, where a processor develops, via a machine learning platform, predictive model(s) using the feature-engineered data. For example, in FIG. 11, the model management system 1104 uploads feature-engineered data to the machine learning platform 1106 to select and analyze (e.g., via exploratory data analysis) a set of predictive models (a machine-learning (ML) model set) which score highest in various output accuracy, or other, metrics. The set of predictive models are further analyzed (e.g., via model engineering) to develop the set of predictive model(s) into a more developed set (e.g., “developed ML model set”) which most accurately predict(s) specified target variable output(s). Various technical techniques are applied during development and include, but are not limited to, exploratory data analysis, feature engineering, data pre-processing, predictive model experimentation, feature selection, etc.

Flow 1200 continues at processing block 1210, wherein a processor deploys the model(s) to an online digital distribution platform configured to provide access and/or use of machine learning model(s) (e.g., via the MaaS structure). For example, in FIG. 11 the developed ML model set is deployed to app store 1108. Users can access and subscribe to applications that use the deployed machine learning model(s). The applications integrate with the deployed models (e.g., via the app store 1108, via data platform system 140, via an application programming interface (API), via the Internet, via a telecommunication network, via a data pull or push protocol, etc.).

Flow 1200 continues at processing block 1212, wherein a processor provides access to the subscribed model(s). For example, in FIG. 11, model subscription server 1103 serves the models, which casino applications 1105 use and/or access. Some example models may include a staffing model, a host model, a top games model, and a machine maintenance model. A service tracking manager (STM) task dispatching product can use the staffing model to optimize employee allocation based on real time and historical demand. A casino host can use the host model to identify a player that should be contacted within a set amount of time (e.g., to provide a promotion within a given number of days). A game finder app can use the top games model to assist a user (e.g., an employee and/or patron) to view a list of the top trending games in the casino. A machine entry authorization log (MEAL) and STM app can use a staffing model to provide a user (e.g., an employee) with the technical knowledge needed to resolve issues with a slot machine and/or to identify parts requiring attention.

Flow 1200 continues at processing block 1214, wherein a processor performs continuous engineering of the data and model(s). For example, in FIG. 11, the model subscription server 1103 uses the models to access (e.g., via an established data pipeline) live data and/or real-time data from the data source(s) 1102 and the model management system 1104 and machine learning platform 1106 updates the data and/or the predictive models in a continuously improved manner (e.g., continuously re-trains the model to address data drift), to regenerate and re-deploy the updated model set. Furthermore, a processor can deploy third-party models (e.g., from third party system 1107) to the online digital distribution platform (e.g., to the app store 1108). Furthermore, the model subscription server 1103 permits access and/or use (e.g., subscriptions) to the models via third party application(s) 1109. In one embodiment, the AI tool can be integrated as an add-in, a module, etc. to applications (whether gaming or non-gaming applications, such as calendaring applications, word processing applications, social communication applications, social-networking applications, virtual reality applications, augmented reality applications, etc.).

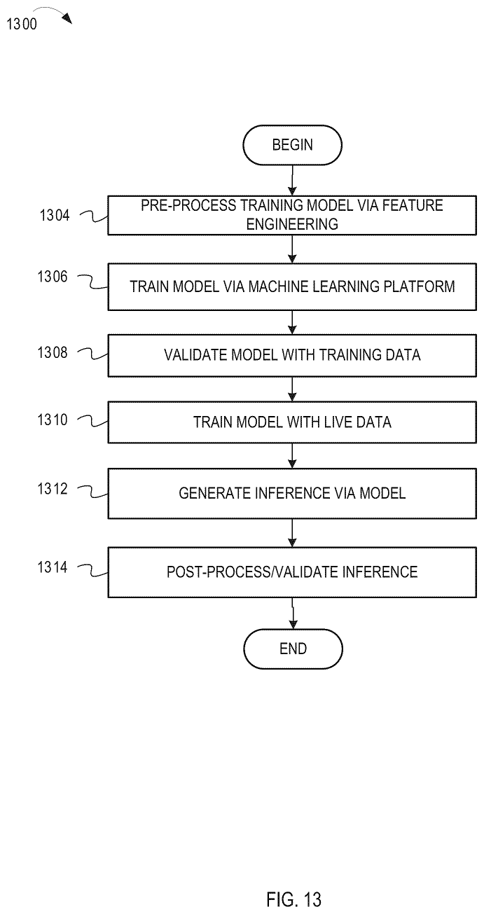

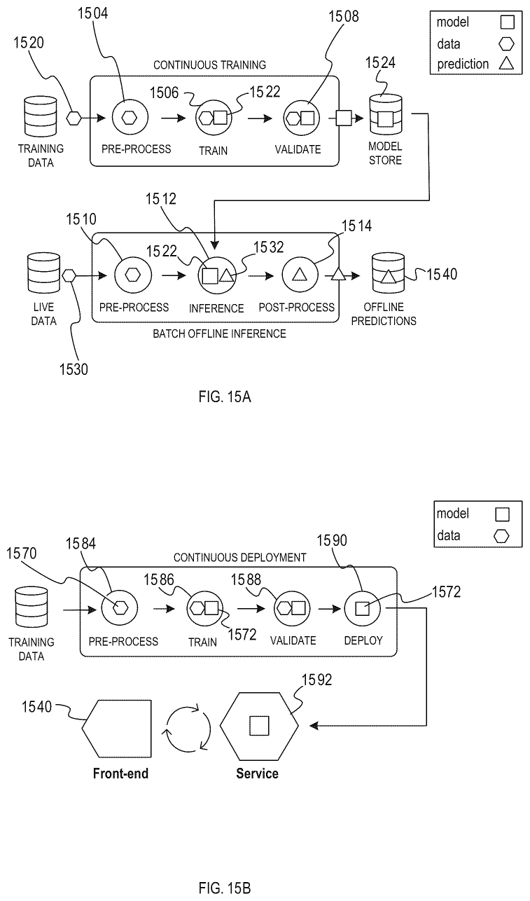

FIG. 13 illustrates a flow diagram of an example flow 1300 for continuous training and batch offline inference via the AI tool according to some embodiments. The description of flow 1300 will refer to FIG. 15A. The flow 1300 begins at processing block 1304, where a processor pre-processes a training model via feature engineering. In FIG. 15A, an example is illustrated at stage 1504 of a continuous training process according to some embodiments, where training data 1520 is preprocessed to prepare it for model selection and training. Referring back to FIG. 13, at processing block 1306, a processor trains the model via a machine learning platform. For example, in FIG. 15A, an example is illustrated at stage 1506 of the continuous training process, where a model 1522 is selected (e.g., via a machine learning platform) based on feature engineering in association with training data 1520. Referring back to FIG. 13, at processing block 1308, a processor validates the model with training data. In FIG. 15A, an example is illustrated at stage 1508 of the continuous training process, where a portion of the training data (that was not used during training) is used to validate the model 1522. The validated model is then stored in a model store 1524. Referring back to FIG. 13, at processing block 1310, a processor trains the model with live data. Referring to FIG. 15A, an example is illustrated at stage 1510 of a batch offline inference process according to some embodiments, where live data 1530 is preprocessed to prepare it for model inference. Referring back to FIG. 13, at processing block 1312, a processor generates an inference (e.g., a prediction) using the trained model. In FIG. 15A, an example is illustrated at stage 1512 of the batch offline inference, where the model 1522 (selected form the model store 1524) is used to make an inference (e.g., a prediction 1532). Referring back to FIG. 13, at processing block 1314, a processor post-processes (e.g., validates) the inference. In FIG. 15A, an example is illustrated at stage 1514 of the batch offline inference, where the prediction 1532 is post-processed (e.g., validated to ensure that the model 1522 is good to use), and is stored in an offline predictions store 1540.

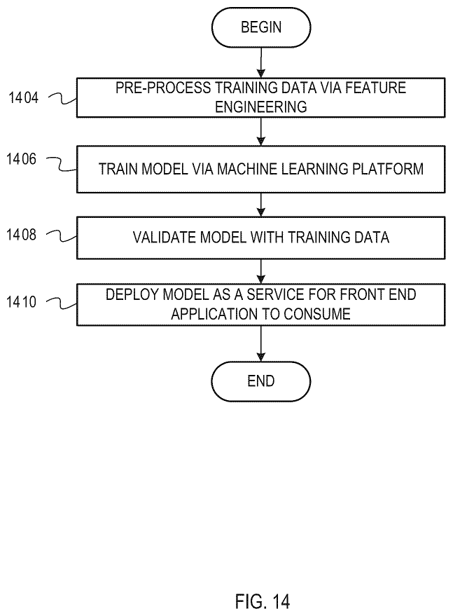

FIG. 14 flow diagram illustrates an example flow 1400 for continuous deployment (e.g., streaming) of a model according to some embodiments. The description of flow 1400 will refer to FIG. 15B. Referring to FIG. 14, at processing block 1404, a processor pre-processes training data (e.g., via feature engineering). In FIG. 15B, an example is illustrated at stage 1584 of a continuous deployment process according to some embodiments, where training data 1570 (e.g., similar to training data 1520) is preprocessed to prepare it for model selection and training. Referring momentarily back to FIG. 14, at processing block 1406, a processor selects and trains the model via a machine learning platform. In FIG. 15B, an example is illustrated at stage 1586 of the continuous deployment process, where a model 1572 (e.g., similar to model 1522) is selected (e.g., via machine learning platform) based on feature engineering in association with the training data 1570. Referring again to FIG. 14, at processing block 1408, a processor validates the model (e.g., with a portion of the training data). In FIG. 15B, an example is illustrated at stage 1588 of the continuous deployment process, where a portion of the training data 1570 (that was not used during training) is used to validate the model 1572. Referring again to FIG. 14, at processing block 1410, a processor deploys the model for a front-end application to consume. In FIG. 15B, an example is illustrated at stage 1590, where the validated model 1572 is then deployed as a service 1592 accessible via a front-end application 1540 (e.g., via app store application, via a model management application, etc.).

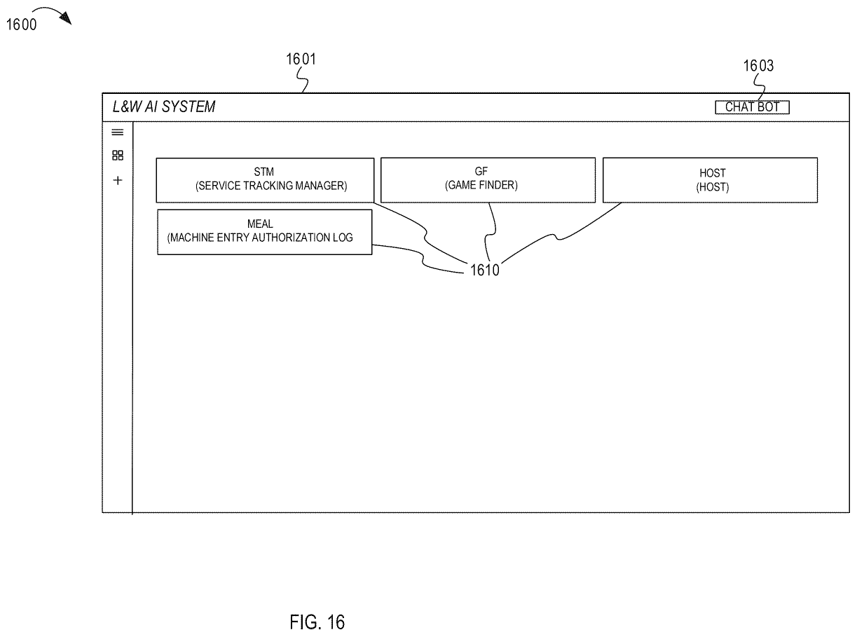

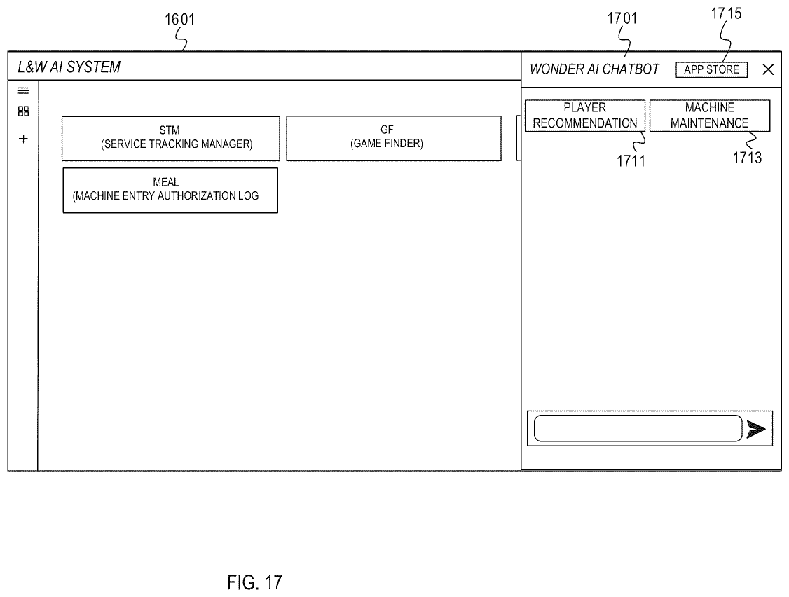

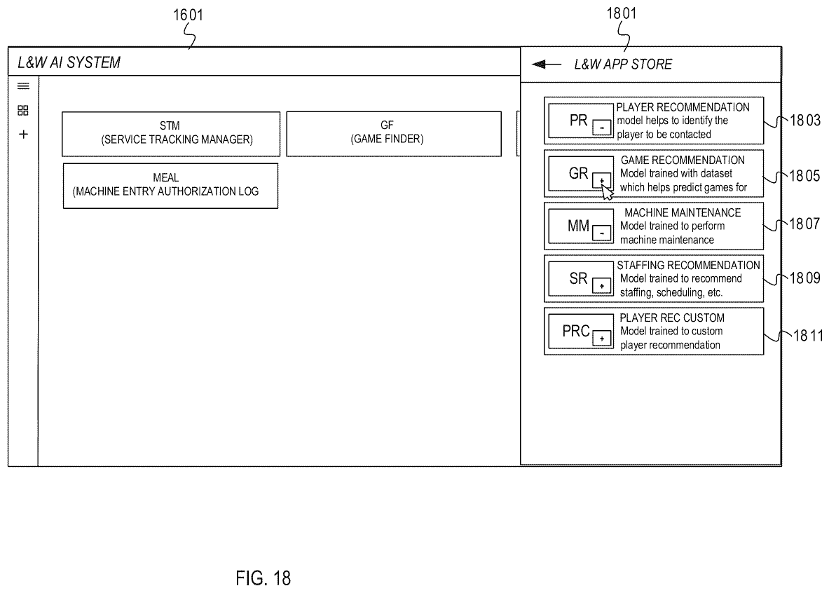

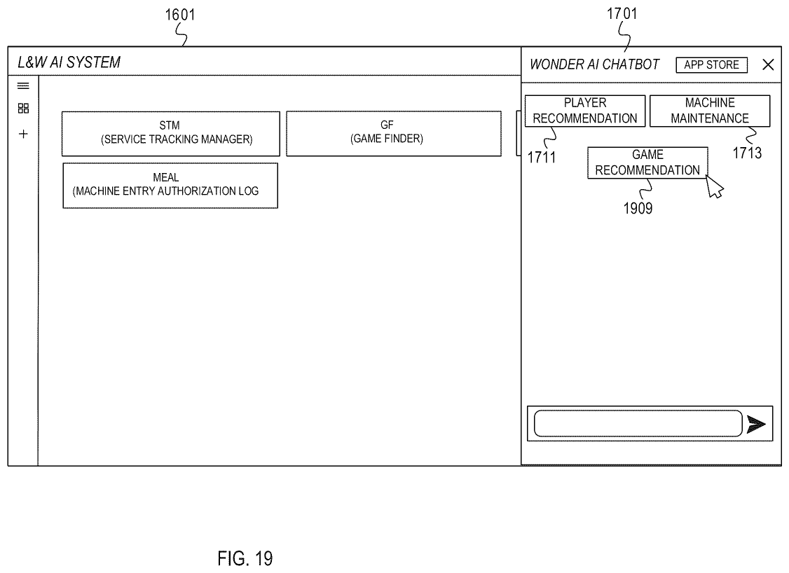

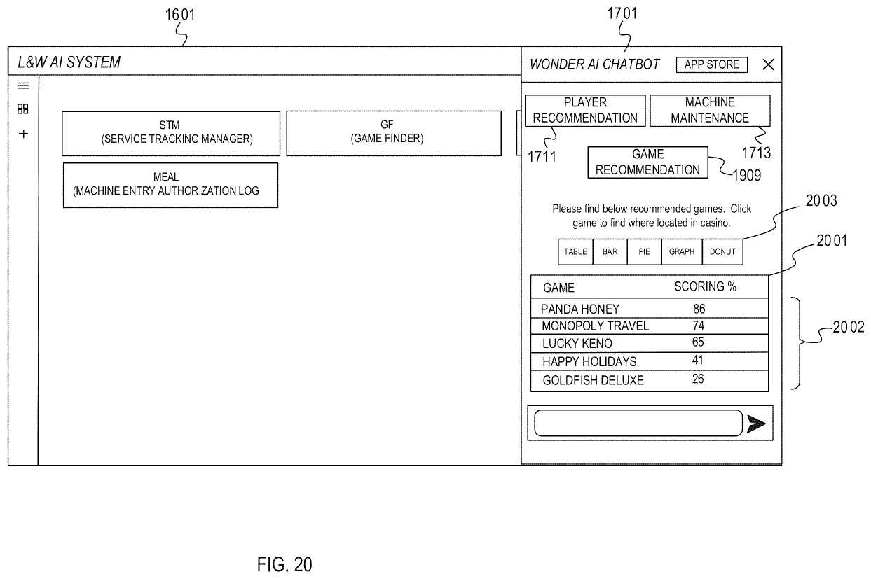

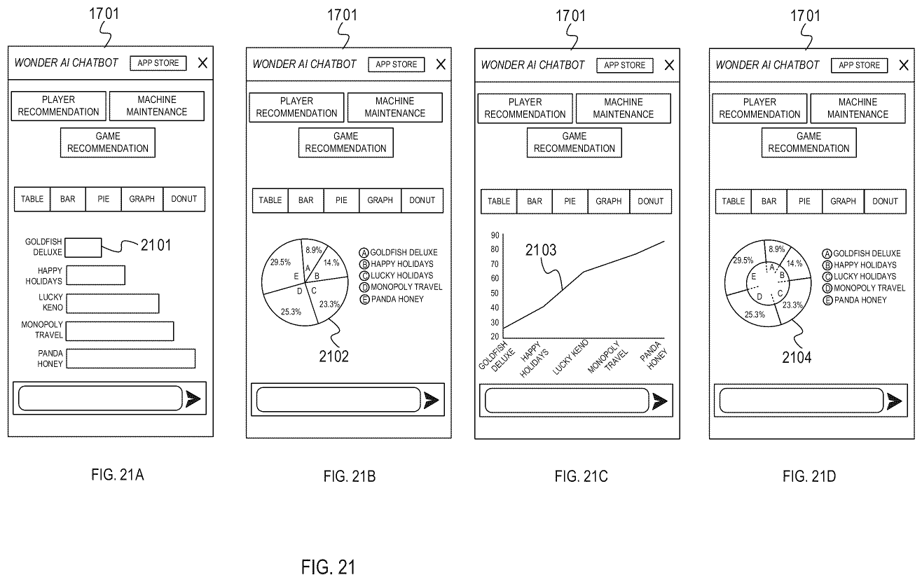

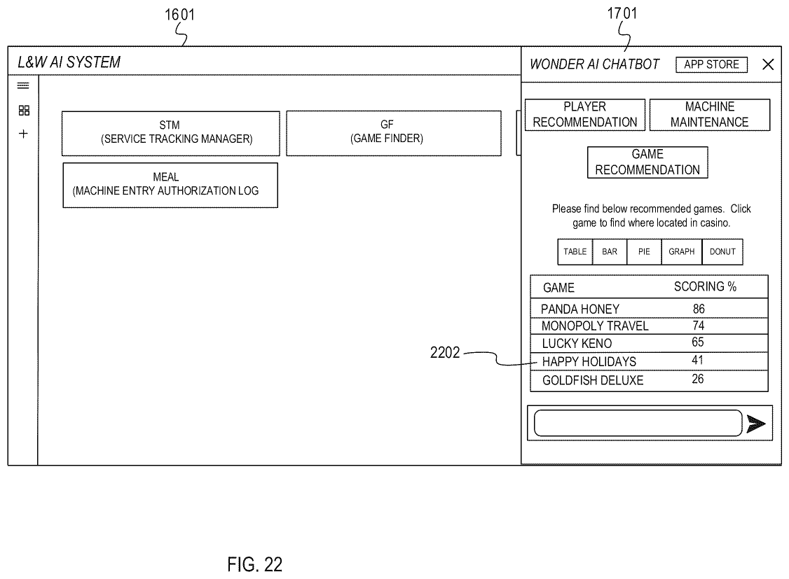

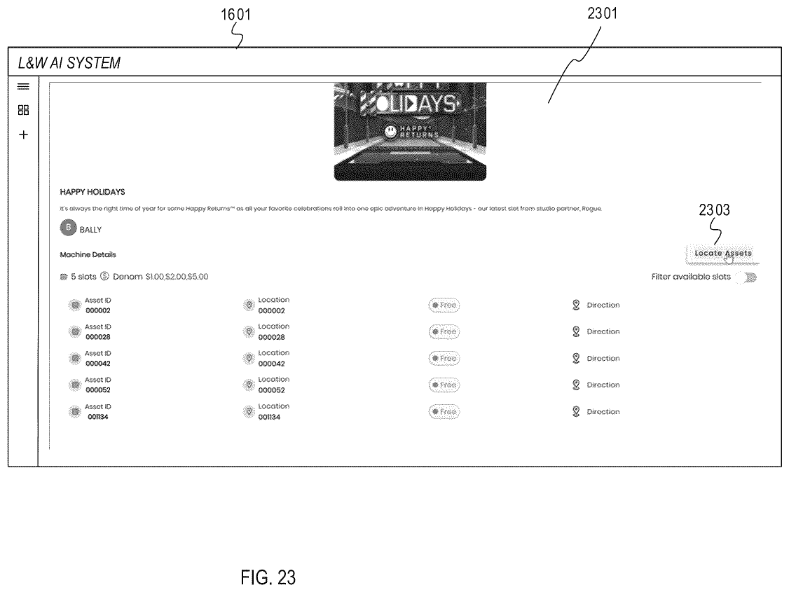

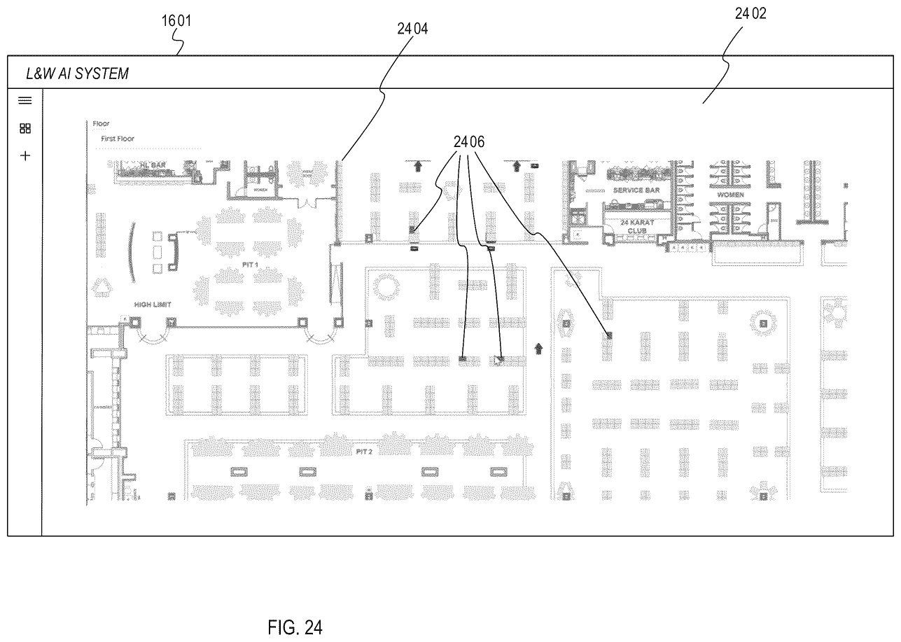

FIG. 16 illustrates an AI tool having an AI tool interface (“interface 1601”). The interface 1601 includes interface controls 1610 to launch AI based applications. The interface 1601 further includes an AI chatbot launch control 1603, which when selected launches AI chatbot interface (“interface 1701”) as shown in FIG. 17. Referring now to FIG. 17, the interface 1701 presents a text input control 1705 in which to enter textual prompts for the AI chatbot. Furthermore, the interface 1701 presents model-access controls (e.g., controls 1711 and 1713) to access already installed models. To install an additional model into the interface 1701, app store control 1715 can be selected to launch, when selected, app store interface (“interface 1801”) as shown in FIG. 18. Referring now to FIG. 18, the interface 1801 includes several selectable controls 1803, 1805, 1807, 1809, and 1811, each of which is associated with a separate installable AI model available via the AI tool (e.g., control 1803 is associated with a “Player Recommendation” model which assists a subscribed user to identify a player to be contacted, control 1805 is associated with a game recommendation model to assist a subscribed user to predict games for recommendation, control 1807 is associated with a machine maintenance model to provide maintenance and maintenance information to a subscribed user, control 1809 is associated with a staffing model to assist a subscribed user to manage staffing, etc.). When one of the controls 1803, 1805, 1807, 1809, or 1811 is selected (e.g., when control 1805 is selected), as shown in FIG. 19, another model-access control (control 1909) appears within the interface 1701 and is ready to be used. When control 1909 is selected, as shown in FIG. 20, a visualization (e.g., a table visualization 2001) of a list of prediction outcomes for the selected model is presented (e.g., a list of recommended games, i.e., list 2002, is presented). A visualization-type selection control (control 2003) can be used to selected, via user input, a type of visualization for the list of prediction outcomes, such as, but not limited to, the table visualization 2001 (as shown in FIG. 20), a bar visualization 2101 (as shown in FIG. 21A), a pie visualization 2012 (as shown in FIG. 21B), a graph visualization 2103 (as shown in FIG. 21C), a donut visualization 2104 (as shown in FIG. 21D), etc. Referring to FIG. 22, when one of the output items from the list 2002 is selected (e.g., when game-recommendation item 2202 is selected), a game-description screen 2301 is presented via the interface 1601, as shown in FIG. 23. Referring to FIG. 23, the game-description screen 2301 presents details about gaming machines, as well as a locator control 2303, which when selected can, as shown in FIG. 24, launch, via interface 1601, a map 2402 of the casino floor (or of any casino environment including a virtual environment) where a gaming machine (e.g., a physical gaming machine, a virtual gaming machine, etc.) can be found for the recommended game. For example, referring to FIG. 24, the map 2402 shows a visual layout 2404 of a casino environment and presents indicators 2406 of the locations of the gaming machines associated with the selected game theme. The indicators 2406 can be colored and/or animated graphics (e.g., blinking red indicators) to better highlight the locations.

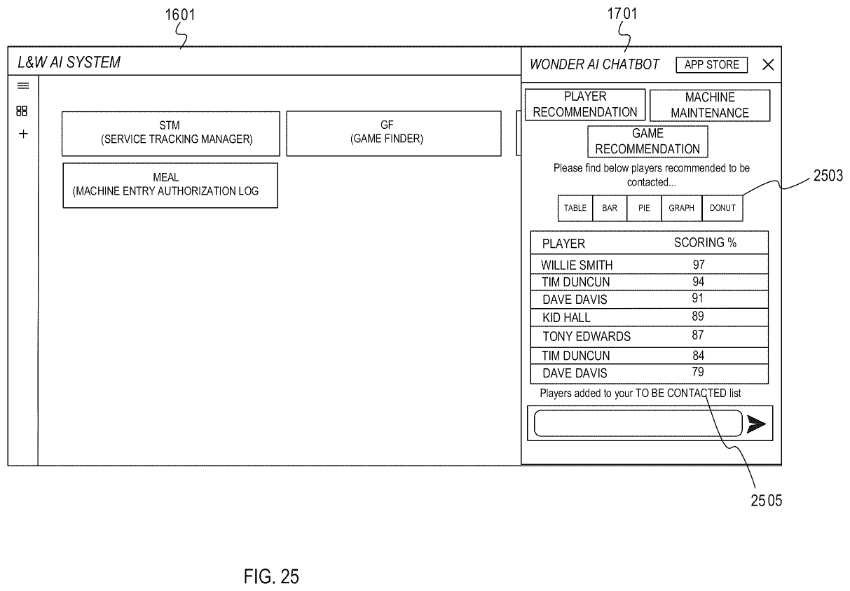

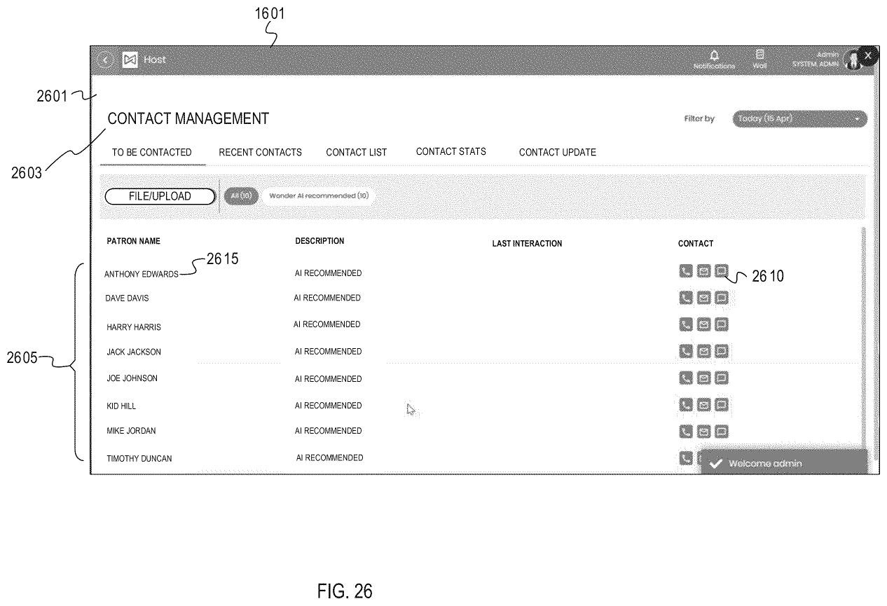

Referring momentarily back to FIG. 17, when model-access control 1711 (e.g., to use the model to get player recommendations) is selected, a list 2503 of recommended players is presented via the interface 1701 (as shown in FIG. 25), each with a predicted score indicating an order or degree to which the recommended player should be contacted, such as an ordered list showing a degree to which a player is most likely to respond to a promotional offering, a degree to which a player is most likely to be in the casino environment, a degree to which a player is most likely to be located or visiting the casino within a given period, or any other criterion or combinations of criteria associated with the recommended player. A link 2505 can be selected which integrates with a host application 2601 as shown in FIG. 26.

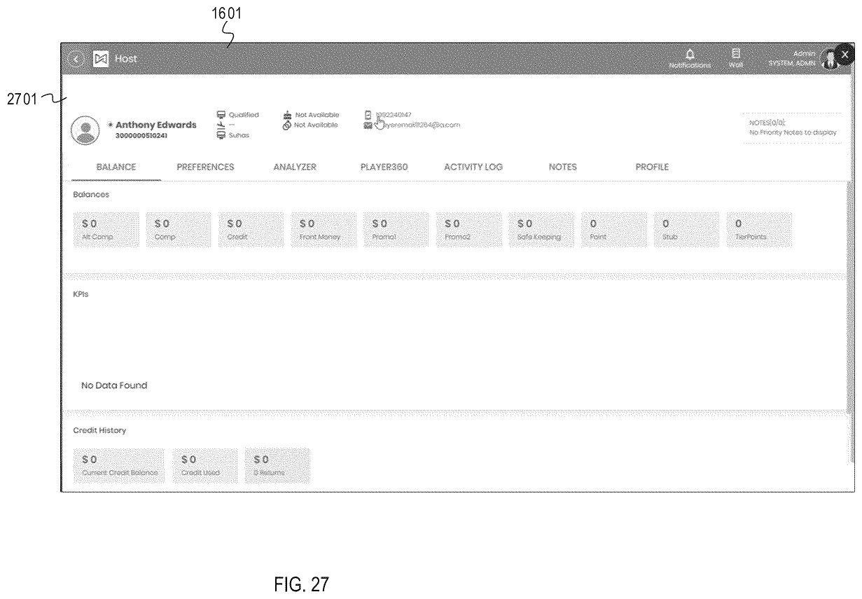

Referring to FIG. 26, a contact-management screen 2603 appears in the interface 1601. The contact-management screen 2603 includes a list 2605 in the host application 2601, which list 2605 is an equivalent representation of the list 2503 of recommended players presented via the interface 1701 (as in FIG. 25). Still referring to FIG. 26, controls 2610 are accessible to contact (e.g., electronically) the recommended player in the list 2605. When a control or link (e.g., link 2615) is selected (e.g., for the player “Anthony Edwards”), then, as shown in FIG. 27, a player-details screen 2701 appears via the interface 1601. Referring to FIG. 27, the player-details screen 2701 presents information about a player account, showing balances of specific tracking meters, key performance indicators (KPIs) associated with the player account, credit history, player preferences, activity logs, notes, profile information, etc.

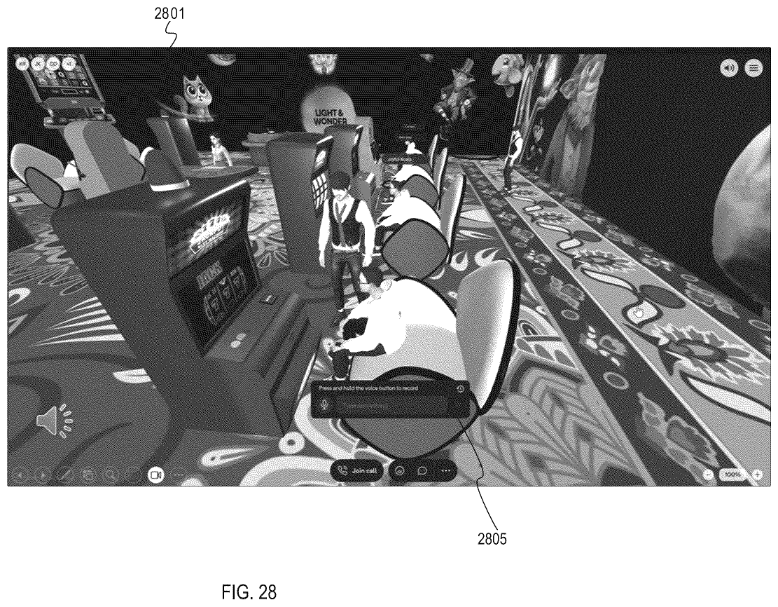

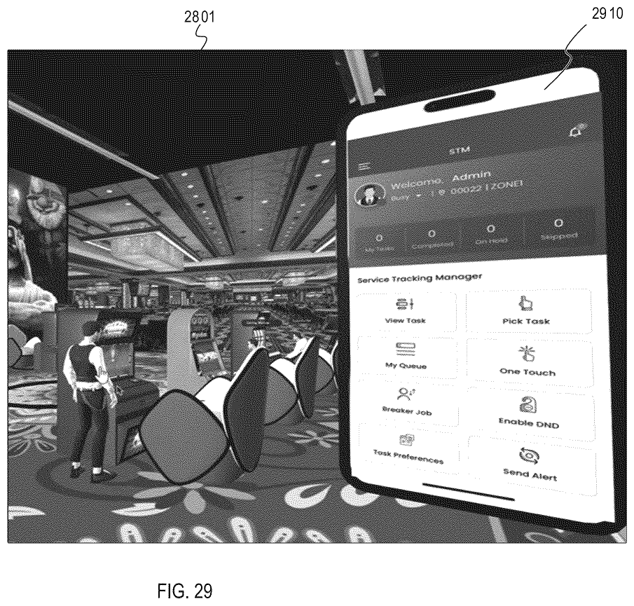

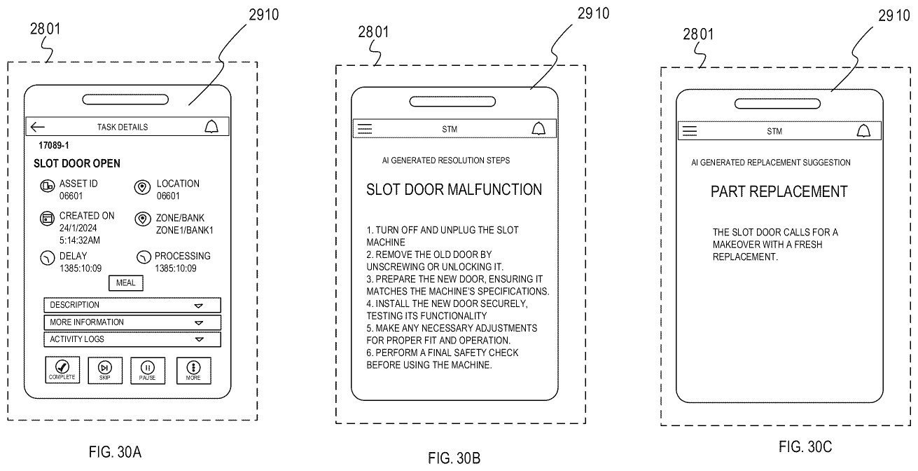

FIG. 28 illustrates an example casino environment using an AI tool according to some embodiments. In FIG. 28, a casino environment (e.g., virtual casino environment 2801, physical casino environment, etc.) includes multiple gaming machines. As time goes on, the machines may be filled by patrons generating data regarding machine use. In a virtual environment, certain virtual assets may be associated with a given gaming machine instance, identity, serial number, etc. A patron may utilize a control (e.g., via a player interface device on the gaming machine, via virtual interface control 2805, etc.) to request assistance. In one embodiment, the gaming machines are connected to an STM application to provide data to a casino staffing application to ensure that staff are allocated to a given location of the casino environment as the area becomes busy with patrons.

In FIG. 29, an application 2910 is presented by the AI tool for use via a casino employee to specify information related to the employee's tasks (e.g., service-related tasks) and to identify and manage service-related tasks (e.g., staffing, scheduling, etc.) using the subscribed AI staffing model. FIG. 30A illustrates an example of a task details interface used, via application 2910, in association with a subscribed machine-maintenance model. FIG. 30B illustrates an example of the application 2910 with information obtained by, and presented by, the AI tool (e.g., using the machine-maintenance model), to provide guidance, recommendations, how-to's, instructions, help manuals, chat assistance, etc. regarding machine errors and how to resolve the errors. FIG. 30C illustrates an example of the application 2910 showing information regarding replacement parts, how to replace them, etc. By identifying the parts that differently cause issues, the AI tool highlights the area(s) of the gaming machine that require attention and maintenance. In some embodiments, the AI tool also monitors the lifespan of various components in a gaming machine, and thus can predict potential failures. The AI tool can further proactively address maintenance issues, such as predicting potential failures before they occur and proactively addressing the failure (e.g., scheduling, prioritizing, etc.). The AI tool can further analyze a history of events such as certain types of historical machine events (e.g., types of errors, type of machine-related events, types of message triggered, etc.) as well as analyze other machine-specific features (e.g., software, cabinet type, game theme, game version, etc.) and, based on the analysis predict a potential time to failure of one or more parts. Based on the predicted time to failure (or based on other related predictions), the AI tool can schedule a priority level for the maintenance of the machine and/or prepare for the maintenance before the failure occurs. Furthermore, the AI tool can deliver automated alerts, such as when an error rate (e.g., soft tilts, screen errors, bill rejection rate, etc.) is above a certain threshold.

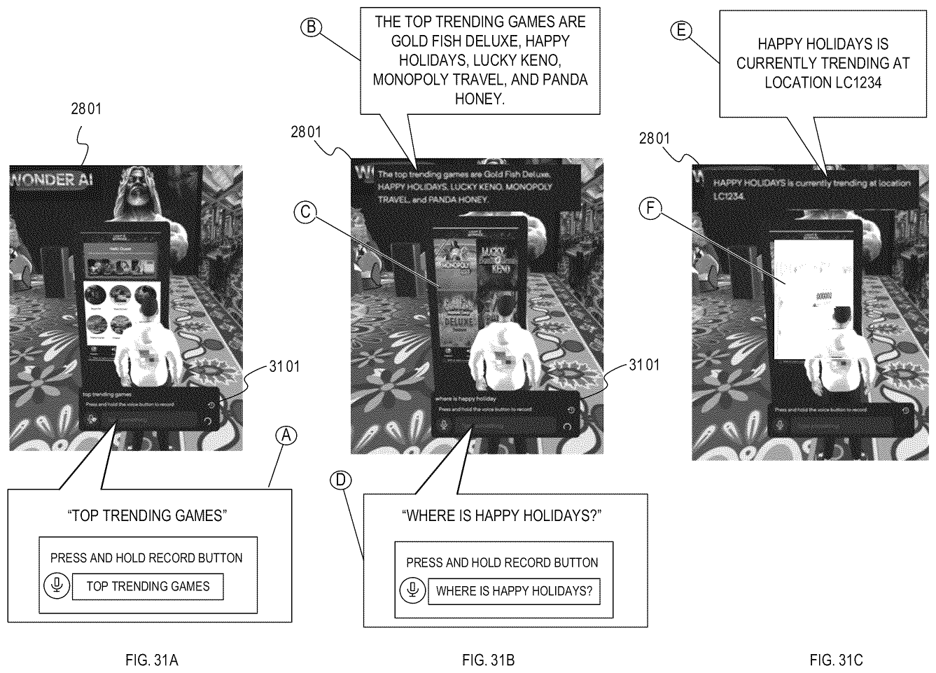

FIG. 31A, FIG. 31B, and FIG. 31C illustrate an example of finding and locating game recommendations using an AI tool according to one or more embodiments of the present disclosure. In FIG. 31A, an AI tool presents, via casino environment 2801 (e.g., via a virtual casino environment screen, via a virtual gaming kiosk, via a physical machine or device on a casino floor, etc.) a control 3101 by which a user can record or enter input regarding a question for the AI tool. One example question includes locating “top trending games,” or rather games that are performing well, popular, etc. Thus, as illustrated in FIG. 31A, at stage “A,” user input indicates a request for the AI tool to recommend “top trending games.” In FIG. 31B, at stage “B,” the AI tool uses the subscribed game recommendation model to analyze the request based on various recommendation features associated with the game recommendation model, and the AI tool presents (e.g., via the virtual environment, via the kiosk, via a display, etc.), as the result of the analysis, a message showing a list of recommended top trending games. At stage “C,” the AI tool presents details regarding the top trending games. At stage “D,” the AI tool identifies additional user input, such as a request to locate one of the recommended games (e.g., “Where is Happy Holidays?”). The AI tool recognizes the name of the requested game and determines the location of a gaming machine (or representative virtual object) that provides the game. Then, as illustrated in FIG. 31C, at stage “E,” the AI tool presents a message indicating the location of the requested game, and at stage “F,” the AI tool presents a map of the location (e.g., via the virtual environment, via a kiosk display, etc.).

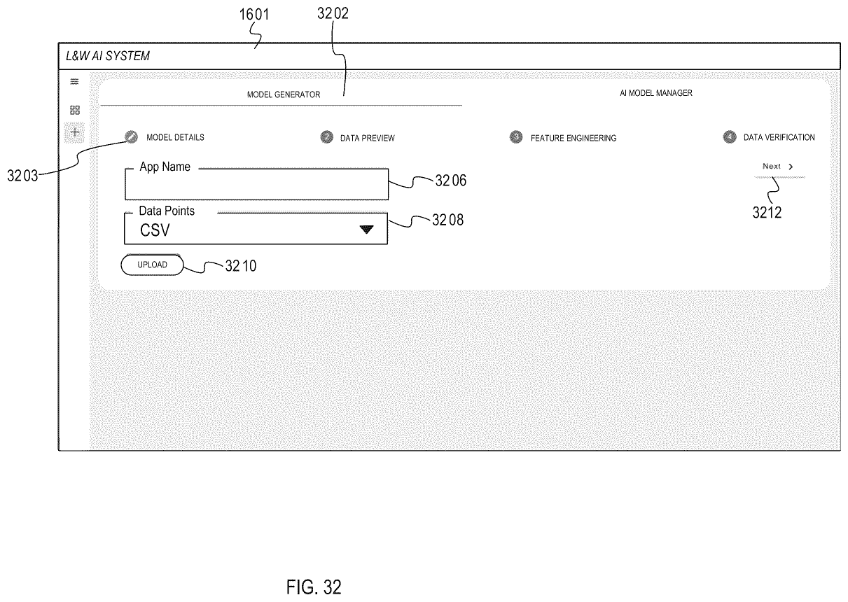

FIG. 32 through FIG. 42 illustrate an example of generating a machine learning model via an AI tool according to one or more embodiments of the present disclosure. In FIG. 32 a model generator 3202 is accessed via the interface 1601. The model generator 3202 provides a series of sections associated with a model generation process. In one embodiment, the process involves four stages for creating a model, namely (a) model details, (b) data preview, (c) feature engineering, and (d) data visualization. At a first stage, as shown in FIG. 32, a model details section 3203 specifies fields for input related to model details. A model name field 3206 receives input regarding a name for the model (or application based on the model). A data format field 3208 specifies different types of data input (e.g., the data points) that can be uploaded for generating the model. The data points, for example, may be in one of various formats or types, including, but not limited to, comma separated value (CSV), structured query language (SQL), cloud-based formats (e.g., Amazon Web Services (AWS) cloud computing services, Microsoft AzureTM cloud computing platform, Google Cloud Platform (GCP), etc.), and so forth. An upload control 3210 can be selected to upload a data set (e.g., to upload a CSV file containing the data). A continuation control 3212 is selected to move to the next stage of the model generation process.

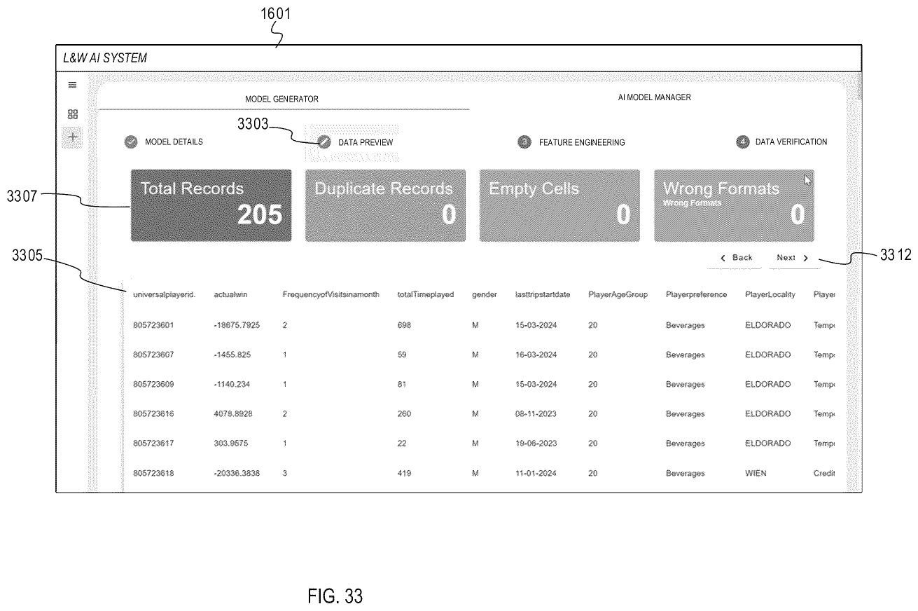

FIG. 33 illustrates an example of the next stage of the model generation process (i.e., “data preview”). For example, in FIG. 33, data preview section 3303 is presented, which presents data report details 3307 having an analysis report of the data set (e.g. indicating a report of a number of total records (e.g., rows) in the data set, indicating a report of a number of duplicate records, indicating a report of a number of empty data fields/cells, indicating a report of proper data formats, etc.). The data from the uploaded data set file (i.e., data details 3305) is also presented. Continuation control 3312 can be selected to move to the next phase of the model generation process.

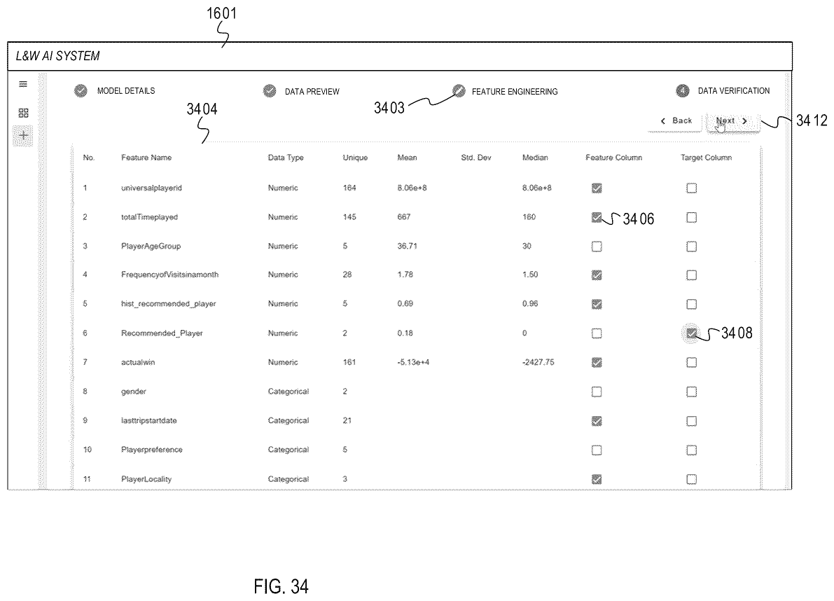

FIG. 34 illustrates an example of the next stage of the model generation process (i.e., “feature engineering”). For example, in FIG. 34, feature engineering section 3403 is presented, which presents feature engineering details 3404 listing the features (e.g., the data variables), the feature data types, a uniqueness score, a mean value, a median value, a feature column control 3406 to select whether a data variable is a feature column, a target column control 3408 to select whether a data variable is a target column, etc. After specifying whether each of the data variables are either a feature column or a target column, continuation control 3412 can be selected to move to the last key phase of the model generation process.

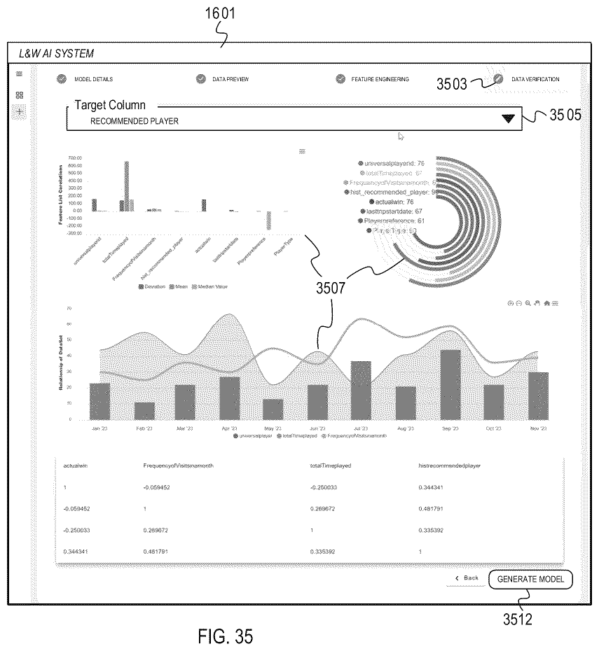

FIG. 35 illustrates an example of the last key stage of the model generation process (i.e., “data visualization”). For example, in FIG. 35, data visualization section 3503 is presented, which presents target column selector 3505 to select a target column for which to visualize relationships between the target column and feature columns in the data set. For example, charts can describe (e.g., via visualizations 3507) a correlation between a selected feature column versus a target column, a unique count about each feature column, a relationship between highest mean and standard deviation feature columns, etc. A model generation control 3512 can be selected to generate the model.

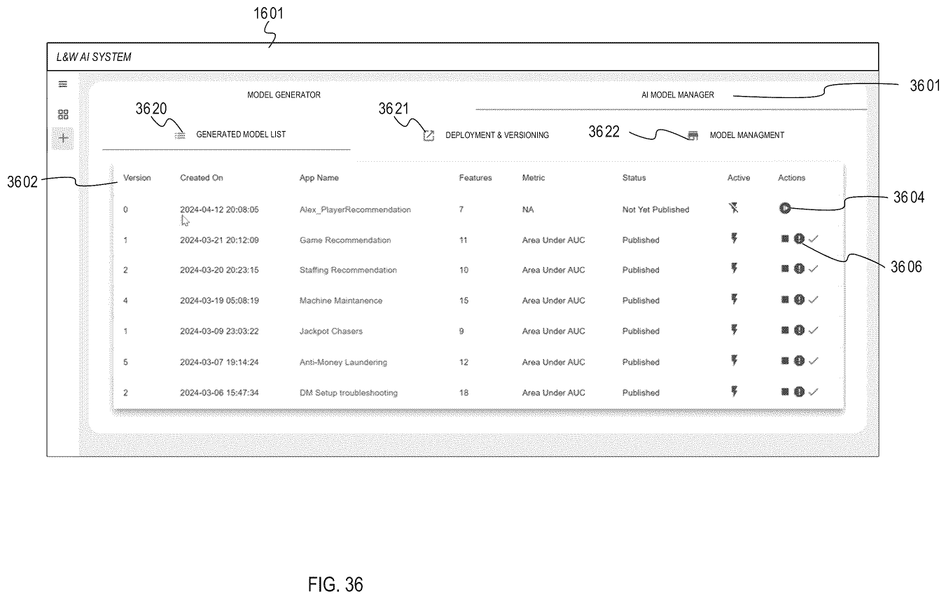

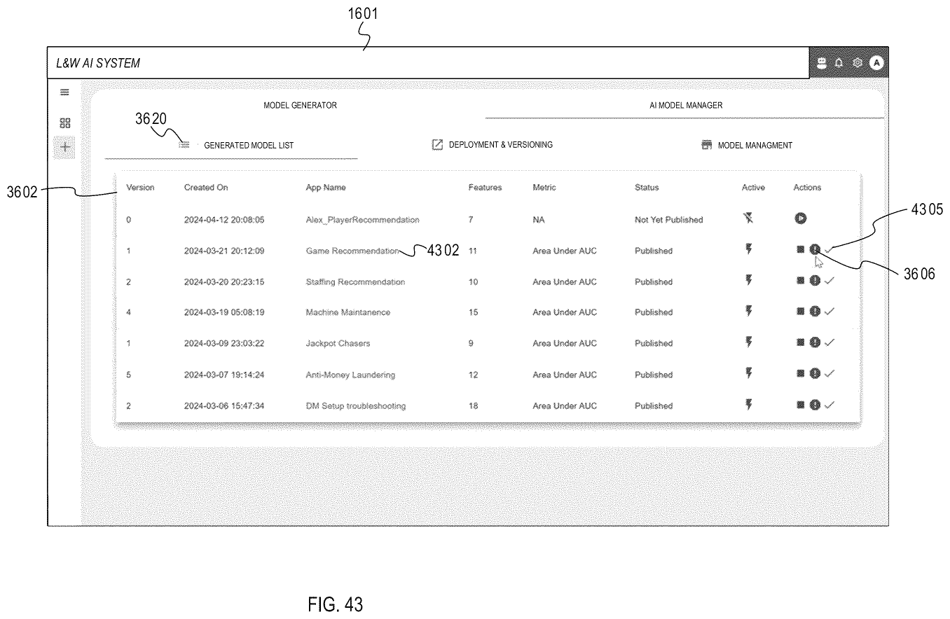

FIG. 36 illustrates an example of model management according to one or more embodiments of the present disclosure. In FIG. 36, a model manager 3601 is accessible via the interface 1601. The model manager 3601 includes three tabs or sections, a generated model list section 3620, a deployment and versioning section 3621, and a model management section 3622. In the generated model list section 3620, as shown in FIG. 36, a models list 3602 is presented specifying certain information about the generated models, such as a version number, a creation date, an application name (by which the model is known), a number of features in the model, a metric for the model, a publication status of the model, an activity status, and one or more action controls, such as a publishing control 3604 to publish an unpublished model or a warning indicator 3606 to indicate any issues or problems with the model (e.g., refer to FIG. 43-45 for an example of model governance in response to user selection of the warning indicator 3606).

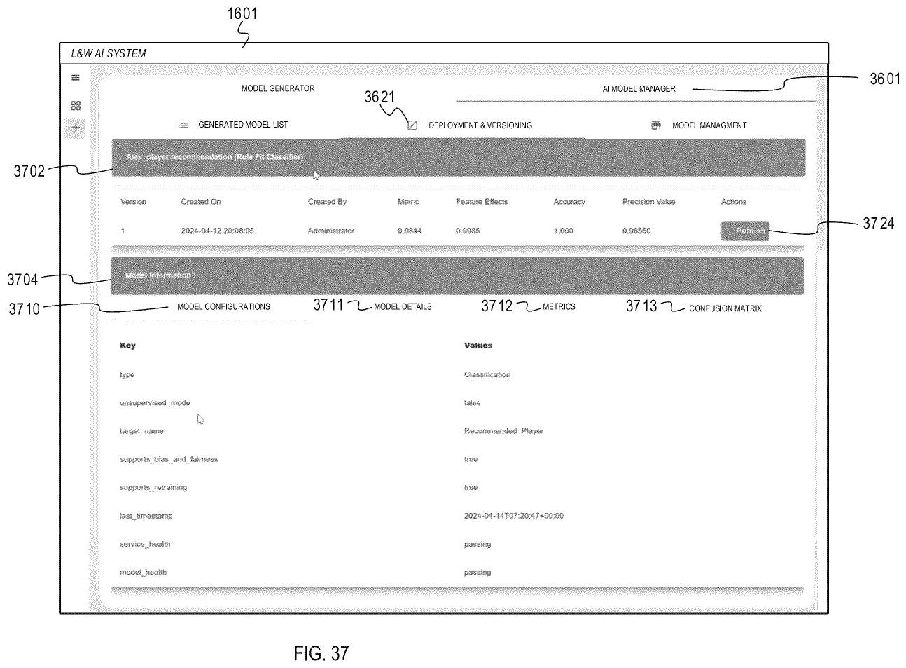

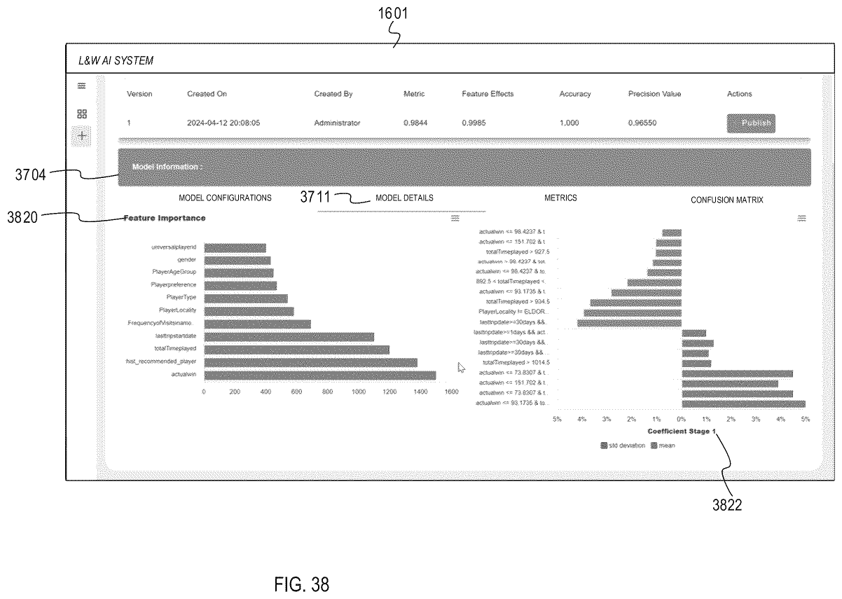

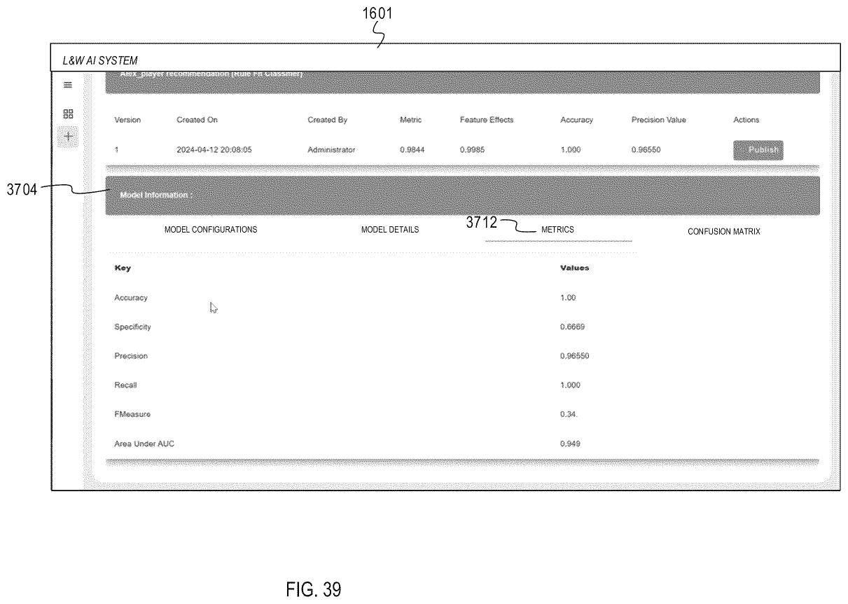

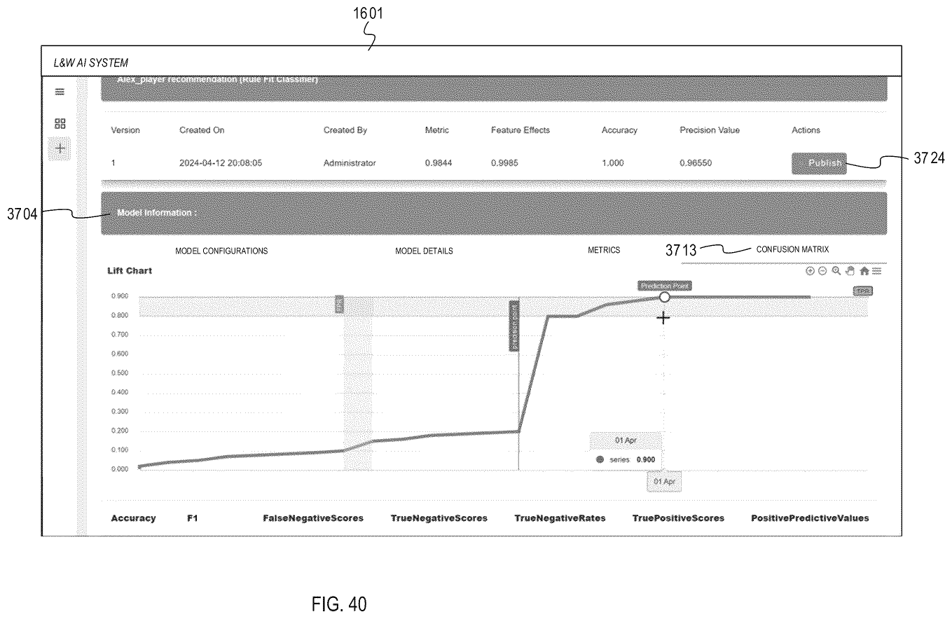

FIG. 37 illustrates an example of deployment and versioning section 3621. A selected model details 3702 presents specific information about the selected model, such as a model name, a model algorithm (e.g., rule fit classifier chosen by machine learning platform), a version number, a creation date, a creator, a metric value, a feature effect value, an accuracy value, a precision value, and one or more action controls, such as publishing control 3724. Furthermore, model information section 3704 presents four tabs, including model configurations tab 3710 (illustrated in FIG. 37), model details tab 3711 (illustrated in FIG. 38), model metrics tab 3712 (illustrated in FIG. 39), and model confusion matrix tab 3713 (illustrated in FIG. 40). The model configurations tab 3710 describes model type, model targets, etc.

Referring to FIG. 38, the model details tab 3711 illustrates feature importance chart 3820 (specifying feature importance scores showing a degree to which the given feature is correlated with a target, a measure of a predictive power of the feature to predict the target, etc.) and coefficient of feature columns chart 3822 (specifying feature coefficient representing a relationship between a given feature and the target).

Referring to FIG. 39, the model metrics tab 3712 illustrates optimization metrics for the model, such as, but not limited to, an accuracy value (a model accuracy), a specificity value (e.g., a ratio of true negatives (correctly predicted as negative) to all actual negatives), a precision value (e.g., for all the positive predictions, the percentage of cases in which the model was correct), a recall value (e.g., a balanced accuracy value that measures true positives and false negatives for each class), an Fmeasure value (e.g., a measure of a model's accuracy computed based on precision and recall), an Area Under Curve (AUC) value (e.g., a performance measurement of an area under a probability curve (“ROC curve”) indicating a plot of a true positive rate against a false positive rate for a given data source), and so forth.

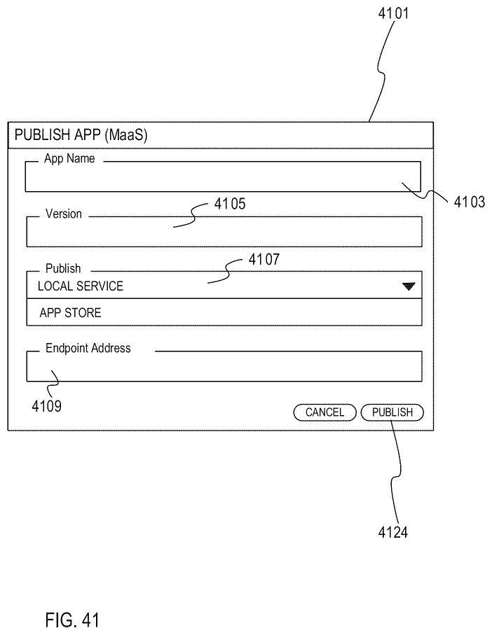

Referring to FIG. 40, the model confusion matrix tab 3713 illustrates a confusion matrix to illustrate a trade-off between true positive and false positive rates at various classification thresholds to achieve a prediction point, such as via a Lift Chart (e.g., depicting how well a model segments a target population and how capable the model is of predicting the target, illustrating a visual of the model's effectiveness). Setting different thresholds for classifying positive classes, the data points will inadvertently change the sensitivity and specificity of the model. In one embodiment, in response to selection of publishing control 3724, a publication section 4101 appears as illustrated in FIG. 41.

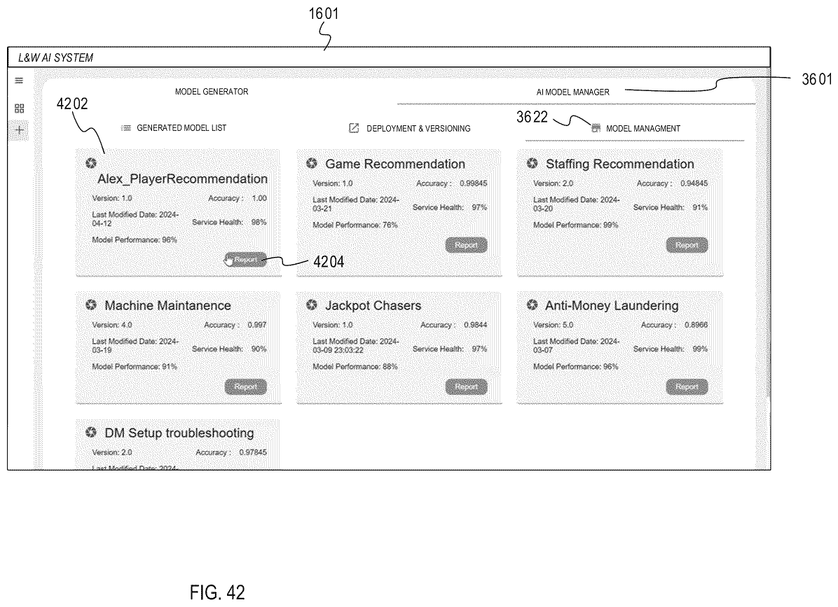

Referring to FIG. 41, publication section 4101 includes an application name field 4103 (e.g., name of model), a version field 4105 (e.g., version of model), a publish type field 4107 (e.g., publish to a local service, publish to an app store, etc.), and a publish location field 4109 (e.g., an endpoint location, such as a URL or network address to where the application for the model is published). In response to selection of the publish control 4124, the model is published and, and illustrated in FIG. 42, a published model object 4202 appears via the model management section 3622. A report control 4204 is selectable to generate one or more reports regarding the model.

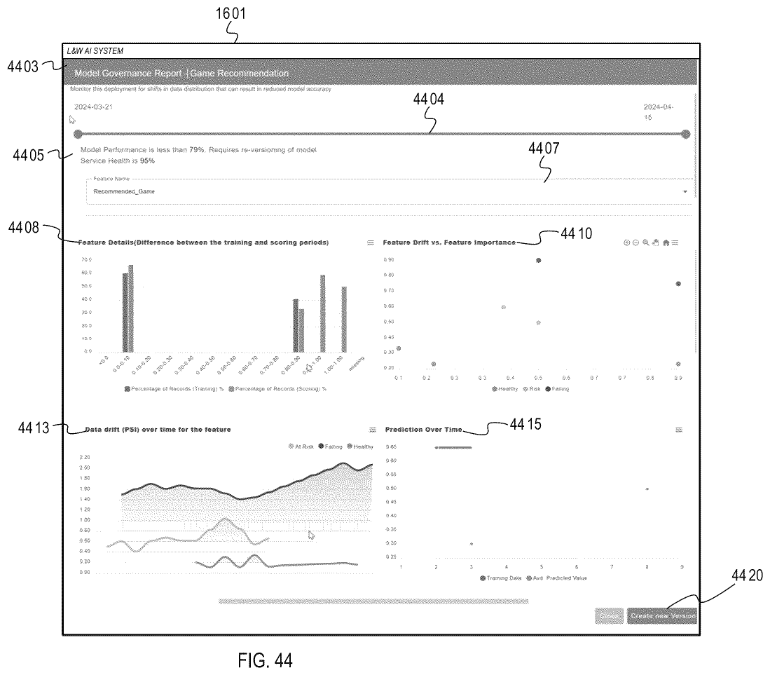

FIG. 43 through FIG. 45 illustrate an example of testing model accuracy and/or performance via an AI tool according to one or more embodiments of the present disclosure. Referring to FIG. 43, the generated model list section 3620 presents the models list 3602. From the models list 3602, one of the models (i.e., model 4302) has an activated warning indicator (i.e., warning indicator 3606 is activated, which specifies that the model requires attention). Upon selection of the warning indicator 3606, a model governance report 4403 (see FIG. 44) is presented via the interface 1601. The model governance report 4403 is generated for a given time period indicated by a model report timeline 4404 (e.g., the report covers a month period). Model performance details 4405 specify a model performance metric for the time period. For instance, the model performance metric is specified as less than seventy-nine percent and service health metric is specified as ninety-five percent. A feature selector 4407 specifies a given feature from the model to select for analysis. The model governance report 4403 further provides a feature details chart 4408, a feature drift chart 4410, a data drift chart 4413, and a prediction over time chart 4415. The feature details chart 4408 specifies a difference between training and scoring periods. The feature drift chart 4410 specifies a degree of feature drift versus feature importance. The data drift chart 4413 specifies a degree of data drift away from a baseline established with the training dataset, which data drift is measured, for example, using the Population Stability Index (PSI). For the prediction over time chart 4415, training data is charted in comparison to an average predicted accuracy. In one embodiment, with continuous training and/or continuous engineering (e.g., see FIG. 11, 12, 13, 14, 15A, and/or 15B) model prediction accuracy may increase over a period of time (e.g., based on the original training data), yet as live data is added and analyzed (which live data is different from the training data), the model accuracy can decrease. A decrease in model accuracy indicates a need to create a new version of the model to account for the added live data. New version control 4420 can be selected to generate a new version of the model.

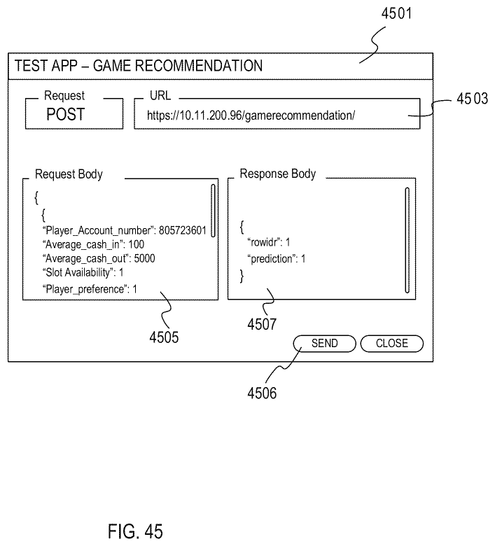

Referring momentarily back to FIG. 43, to test the model the model test control 4305 can be selected, which launches the test application 4501 illustrate in FIG. 45. Referring to FIG. 45, the test application 4501 includes a model URL field 4503, a request body field 4505, a send control 4506, and a response body field 4507. Testing request information can be input into the request body field 4505. When the send control 4506 is selected the testing request information is sent to the model at URL indicated in the model URL field 4503. If the model is functioning properly, a response to the testing request information will appear in the response body field 4507, indicating a successful test of the model's functionality.

In one embodiment an AI tool is configured to provide gaming insights (e.g., to converse with a user, provide answers, present data in charts, generate predictions, provide recommendations based on historical data, etc.). Use of the AI tool can increase operational efficiency of casino systems and provide gaming insights to operators, patrons, etc. For example, use of the AI tool can perform ad hoc gaming data queries, provide rapid reporting, provide visual presentation, generate game level insights (e.g., top performing games, top players, casino floor hotspots, etc.), provide marketing insights and player development (e.g., to select player promotions, to identify high rollers by period, etc.), etc. Furthermore, in some embodiments, the AI tool can provide floor level information (e.g., show high traffic areas, show machines that need attention, etc.), provide floor optimization recommendations (e.g., optimize a casino floor based on manufacturer, game type, denomination, popular games that a casino can buy with an estimated budget based on predictions, etc.), provide AI based recommendations for slot machines (e.g., determine slot replacement, determine slot relocation, etc.), and so forth.

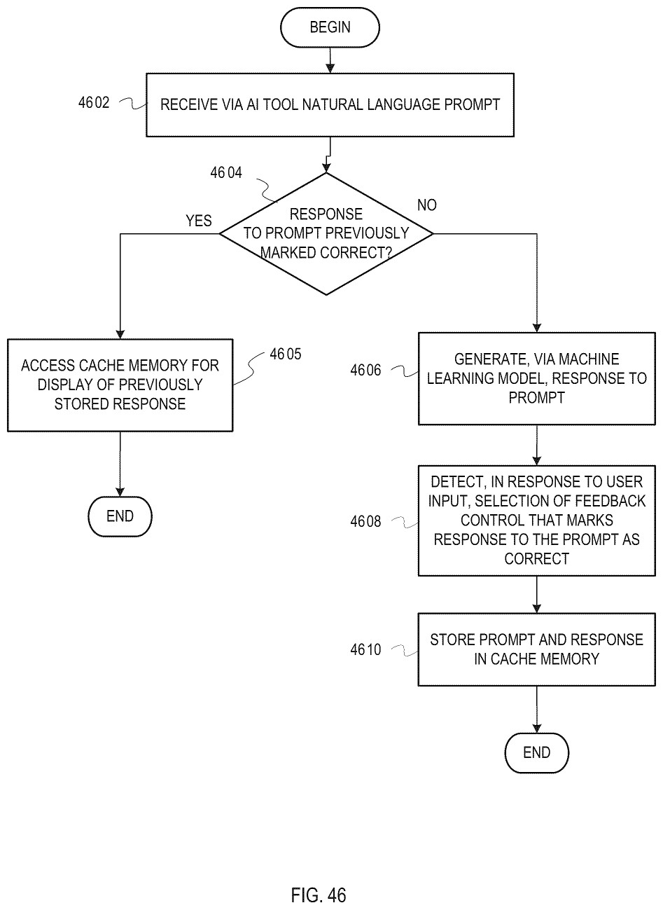

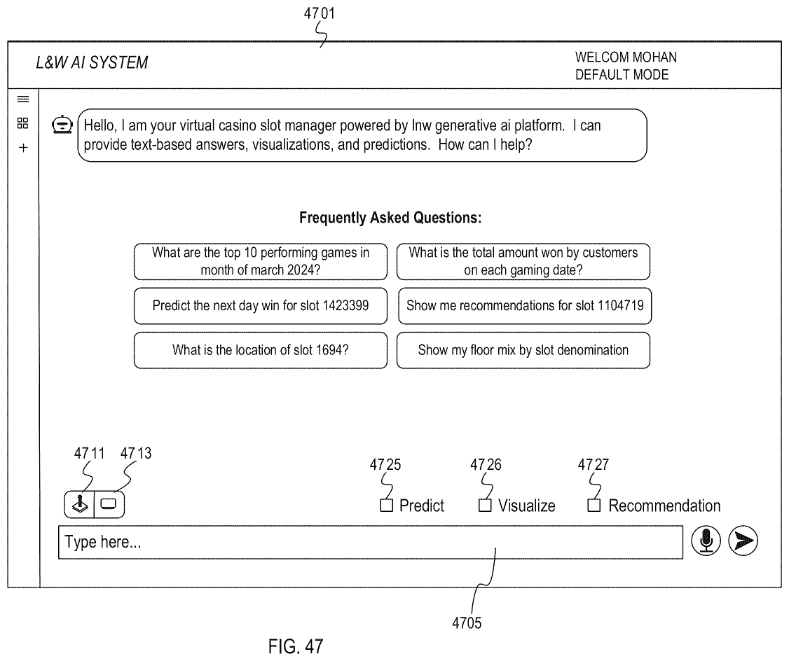

FIG. 46 illustrates a flow 4600 according to one or more embodiments of the present disclosure. The flow 4600 is described in association with FIG. 47 through FIG. 52 and will refer to elements thereof. The description of the flow 4600 refers to a “processor” that performs operations associated with the flow 4600. It should be noted that the reference to the processor may refer to the same physical processor or it may be one of a set of a plurality of processors. The set of processors may operate in conjunction with each other and may be distributed across various networked devices (e.g., across the network 100, via the components of the architecture 1100, etc.). The types of processors may include a central processing unit, a graphics processing unit, any combination of processors, etc. In one embodiment, the processor may be included in, or refer to, one or more devices of the network 100, such as any one of the devices connected via the casino network 132 (e.g., gateway 120, CMS 135, gaming machine 110, player interface device 111, etc.) or any device connected via the telecommunications network 160 (e.g., the data platform system 140, third-party system(s) 150, etc.). In one embodiment, the processor may be the central processing unit (CPU) 242 (see FIG. 2) or a processor in another device mentioned herein, such as the processor 342 associated with the computer 300, a table controller, a card-handling device, a camera controller, a game controller (e.g., game controller 112), a gaming server, etc.

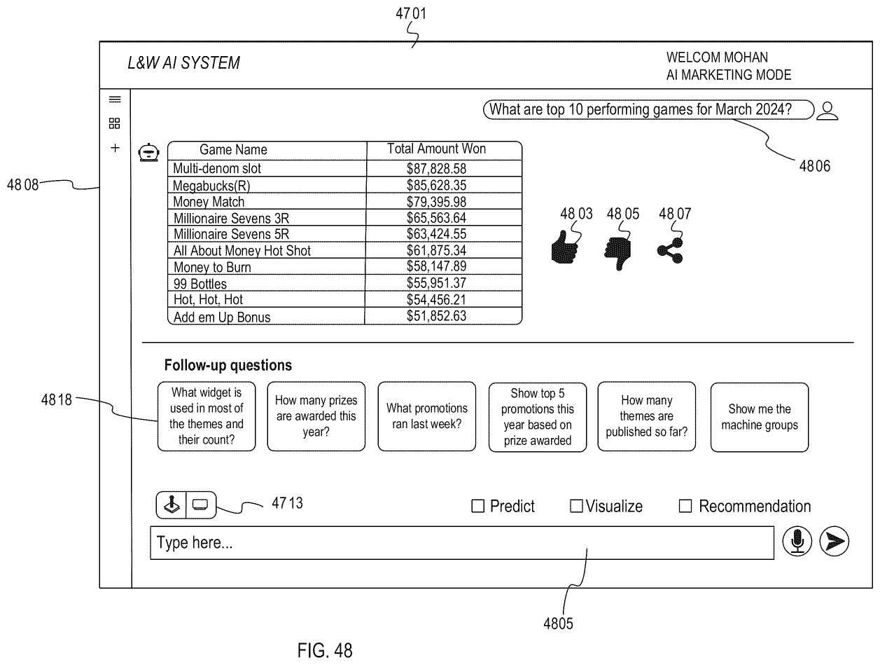

Referring to FIG. 46, the flow 4600 begins at processing block 4602, where a processor receives (e.g., via the AI tool) a natural language prompt. FIG. 47 illustrates an example of an AI tool, according to one embodiment, which AI tool is accessible via interface 4701 (e.g., via a website, via an application running on a gaming system, etc.). In one example, the AI tool utilizes an LLM (e.g., a chatbot) to generate natural language responses. In one example, the interface 4701, an input field 4705 receives user input (e.g., textual input) or prompt(s) (e.g., natural language prompts). In one embodiment, the AI tool is configured via prompt engineering (e.g., via input field 4505). The AI tool self-learns and converses naturally using various techniques (e.g., via one or more of general-purpose language generation, natural language processing (NPL), classification, generative AI, Large Language Model(s) (LLMs), etc.). Furthermore, the AI tool learns based on any prompt input it receives and in response to conversations that occur with the user. Referring now to FIG. 48, as shown, a prompt 4806 is entered (e.g., via the input field 4705 shown in FIG. 47), to which the AI tool generates a response 4808 (shown in FIG. 48).

Referring again to FIG. 46, the flow 4600 continues at processing block 4604, where a processor determines whether a response to the prompt has been previously generated and marked as being correct. If the response to the prompt has been previously generated and marked as correct, then the flow 4600 continues at processing block 4605 where a processor accesses a cache memory (where the previously generated response had been stored) for display (e.g., via AI tool interface) of previously stored response. By accessing the previously stored response, the processor does not need to utilize the machine learning model again, thus saving computing resources required to run the machine learning model again. If, however, at processing block 4604 the processor detects that there was no previously marked correct response, then the flow continues at processing block 4606, where the processor generates (e.g., via the machine learning model) a response to the prompt. The flow 4600 continues at processing block 4608 where the processor detects, in response to user input, selection of a feedback control (associated with the response), which feedback control marks the response to the prompt as correct. The flow 4600 continues at processing block 4610 where the processor stores, in response to detecting the selection of the feedback control, the prompt and the response in the cache memory. For example, as shown in FIG. 48, the AI tool interface 4701 includes controls to receive user feedback regarding the quality or accuracy of any data or responses that the AI tool generates. For instance, prompt 4806 requests to know what are top performing games during a given time period, and the AI tool generates response 4808 based on data that AI tool has access to (e.g., based on gaming data accessible via data sources). The AI tool presents one or more feedback controls (e.g., feedback controls 4803 and 4805) in association with (e.g., positioned next to, having a corresponding similar indicator as, etc.) the response 4808. If the feedback control 4803 is selected, then the AI tool determines that the response 4808 is correct. If the feedback control 4805 is selected, then the AI tool determines that the response is incorrect. In some embodiments, the feedback control(s) may be granular and may request additional information, such as to specify which part of the response is incorrect, or how the response may be incorrect. The AI tool uses the response information for improvement or self-learning (e.g., to correct itself, to retrain itself, etc.).

In response to detection of the feedback control 4803 (i.e., after determining that the response 4808 correct), the AI tool can store the correct response in cache memory (e.g., access a cache storage via SQL schema), so that if the query is made again, the AI tool does not have to regenerate the response 4808 via use of the machine learning algorithm, but can refer to and/or access the previously generated response from the cache memory and re-present the stored correct response. The AI tool thus improves a gaming system by saving computing resources (e.g., processor usage) by not having to re-generate the response, but rather refer to it via the cache memory. In addition to feedback control(s), the interface 4701 presents control 4807, which can be selected to generate a report of the response 4808 (e.g., to save as a file, to export, etc.), and/or to transfer (e.g., export/import) the response into a communication application (e.g., into a messaging application, into an email application, into a word processor, etc.)

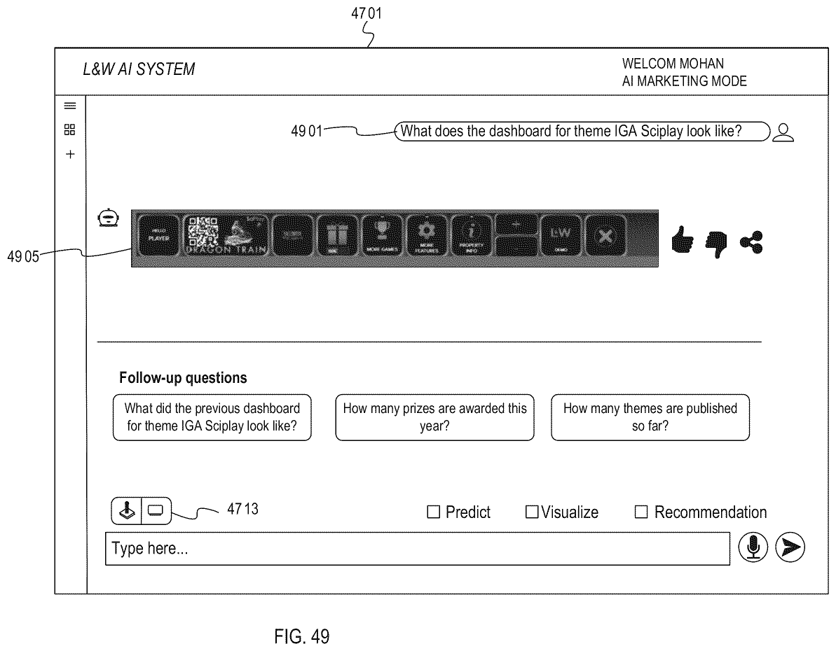

FIG. 49 illustrates an example use where the AI tool integrates with and/or interfaces with an external application. For example, the AI tool can have a default mode (e.g., when switch 4711 is selected as shown in FIG. 47), or a secondary mode (e.g., when switch 4713 is selected) that integrates with one or more applications (e.g. and/or their accompanying data source(s)). For example, when the switch 4713 is selected, the AI tool enters a marketing mode and integrates with a specific type of application (e.g., with a marketing type of application, with a customer-loyalty application, etc.). In some embodiments, for example, when switch 4713 is selected, the AI tool integrates with (e.g., uses, accesses, queries, etc.) the Web Content Manager (WCM) application or the Elite Bonusing Suite™ (EBS) application both manufactured by Light & Wonder, Inc. When the switch 4713 is selected, follow-up questions appear after a response is generated, which follow up questions are related to the application to which the AI tool has been integrated. For example, as shown in FIG. 48, follow-up questions 4818 appear, which are related to marketing.

Furthermore, the AI tool can generate (e.g., via a generative machine learning model) images as a response. For instance, in FIG. 49, a prompt 4901 was entered (“What does the dashboard for the theme IGA Sciplay look like?”). The AI tool obtains (e.g., via the integrated application link) descriptive data associated with the subject matter of the prompt and generates response 4905 having an image that represents the descriptive data. In one embodiment, the descriptive data may be of any type (e.g., textual, graphical, etc.), which the AI tool incorporates together (e.g., as additional prompt text, as links to image files for each of the icons presented on the dashboard, etc.) to generate the response 4905 (e.g., as an image, as multi-media, etc.).

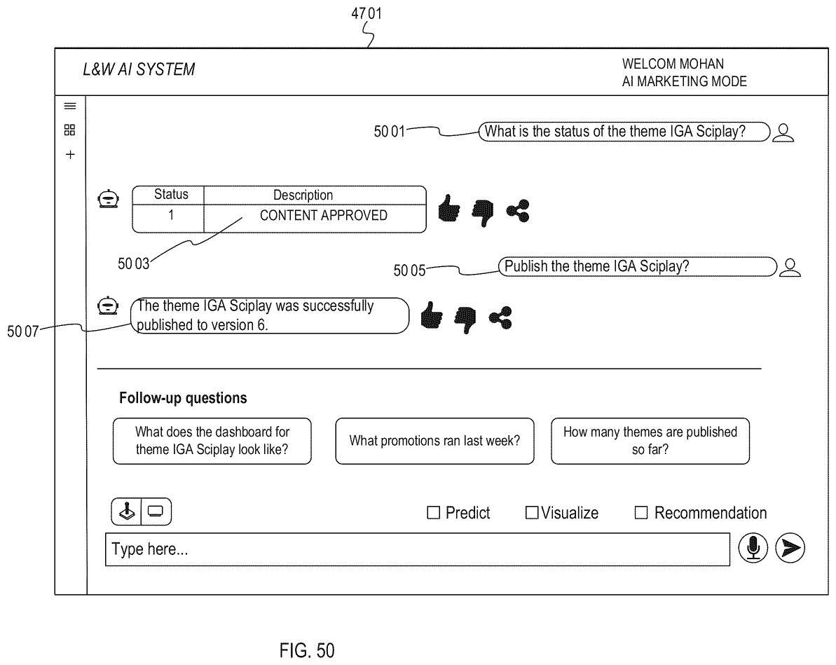

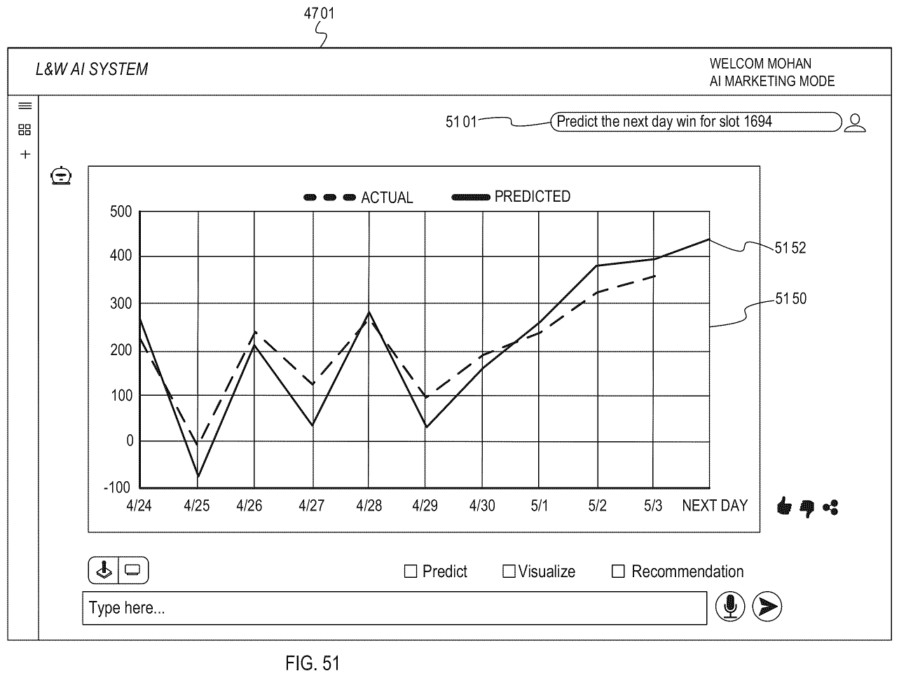

In addition, the AI tool can perform functions of the application to which it has been integrated (e.g., via switching to the mode that integrates with the application). For example, as illustrated in FIG. 50, prompt 5001 is entered into the interface 4701, which prompt 5001 requests to know a status of the image generated via the response 4905 (e.g., prompt 5001 asks “What is the status of the theme IGA Sciplay?”). The AI tool accesses the integrated application to detect the status and returns a response 5003 indicating that the image is approved, but not yet published (e.g., the response 5003 states “Content Approved”). Further, an additional prompt 5005 is entered which requests the AI tool to publish the content associated with the image generated via the response 4905. Consequently, the AI tool accesses the functionality of the integrated application and causes the integrated application to perform the function (e.g., to approve the content, to publish the content for real-time use via the gaming application, etc.). The AI tool then provides response 5007 indicating that the function was performed (e.g., response 5007 states, “The theme IGA was successfully updated to version 6”). This feature of the AI tool saves time and computing resources by allowing the user to access the features of the integrated application without having to open the integrated application, find the appropriate content therein, access the functionality controls of the integrated application to perform the function, etc. Instead, the AI tool understands the context for the content (e.g., based on the prompt(s) and/or based on its training) and can correctly infer and/or select the appropriate control(s), setting(s), data, etc. that are required to perform the functionality. In some embodiments, the AI tool is trained on the integrated application (e.g., via supervised learning) and/or trains itself on the use of the integrated application (e.g., via unsupervised learning), to understand and perform all of the functionality of the integrated application via use of prompt(s) via the interface 4701.

Furthermore, the AI tool includes additional features associated with one or more prompt assistance controls 4725, 4726, and 4727 (as shown in FIG. 47). Prompt assistance control 4725, when selected, causes the AI tool to integrate with a source of machine learning models, such as a machine learning platform (e.g., machine learning platform 1106) to perform predictions based on the prompt, to access subscribed models, etc. For example, as shown in FIG. 51, a prompt can be entered to “predict next day win for slot 1694,” and the AI tool accesses the source of the machine learning models (e.g., the subscribed or accessible machine learning model that was created and deployed to make next day win predictions for any given gaming machine given historical data related to that particular gaming machine). Then, as illustrated in FIG. 51, the AI tool then returns a chart 5150 as a response showing, for several days prior, the total amount for wins per day compared against a total predicted amount for the win for the day, as well as a prediction 5152 (by the machine learning model) for the predicted next day total win amount. In one embodiment, the data is fetched, via the machine learning model, via JavaScript Object Notation (JSON).

Referring momentarily again to FIG. 47, prompt assistance control 4726, when selected, causes the AI tool to return a visualization (e.g., a chart, a graph, etc.) along with the response (e.g., to cause the response to graph a set of numerical data returned via the response).

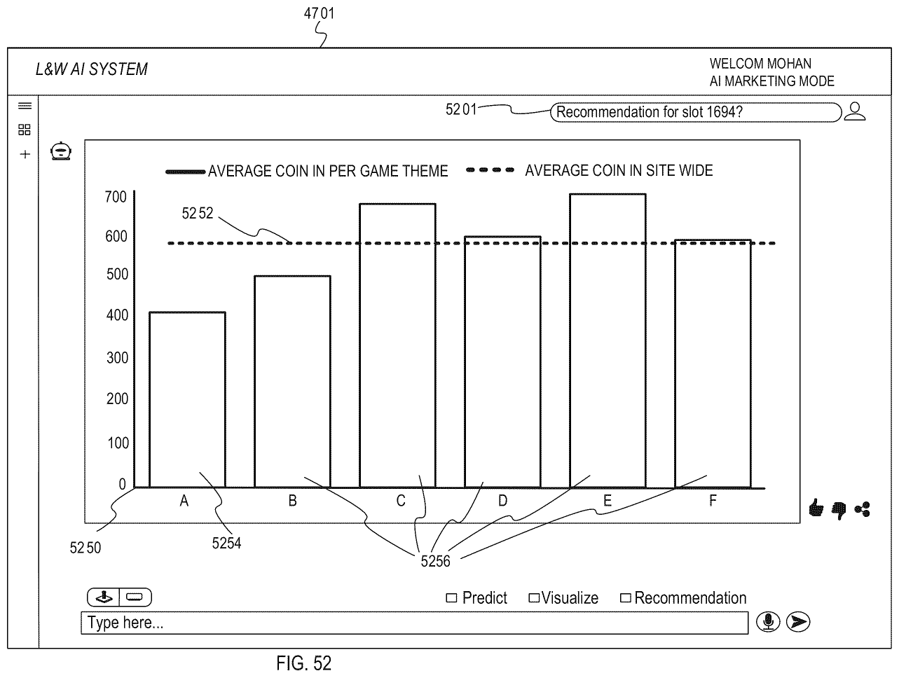

Prompt assistance control 4727, when selected, causes the AI tool to generate a recommendation. For example, the AI tool can receive a prompt to provide a recommendation for game replacement, promotion, swapping, etc. For example, as illustrated in FIG. 52, a prompt 5201 is entered via interface 4701 to “provide a recommendation for slot 1694,” and the AI tool returns a graph (e.g., a bar graph 5250) showing an average coin-in amount (e.g., line 5252) for game themes site-wide, an average coin-in of the current game theme (e.g., bar 5254, showing lower than average coin-in for “A,” the game theme of the “slot 1694”), as well as other possible (e.g. higher performing) game themes (e.g., bars 5256 showing different coin-in averages for games themes “B,” “C,” “D,” “E,” and “F”). The other game themes may be game themes that are recommended for game replacement or swapping of the underperforming game theme “A.” In other example, the AI tool can present a recommendation for a promotion for the underperforming game theme based on how well the same promotion worked for other underperforming games, etc. In some embodiments, the AI tool integrates with a service-based application so that a task can be created regarding jurisdictional requirements (e.g., a task to initiate a jurisdictional process for replacement, a task to track a timing period for a game theme replacement requirement, etc.).

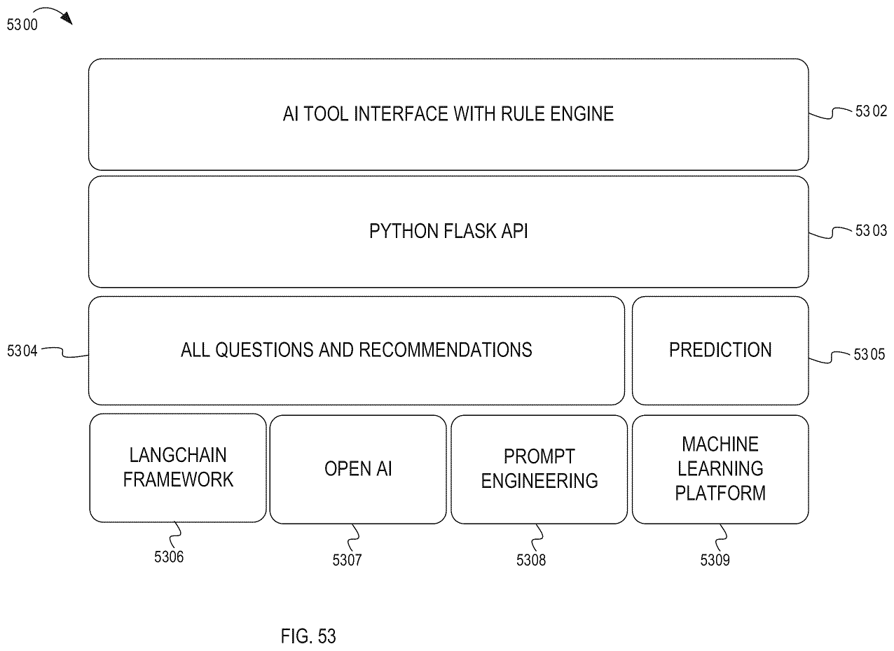

FIG. 53 illustrates an example architecture 5300 according to one or more embodiments of the present disclosure. The architecture 5300 is an example high-level design architecture showing several components 5302, 5303, 5304, 5305, 5306, 5307, 5308, and 5309. Regarding component 5302, the AI tool interface uses a rule engine (e.g., interface 4701). Regarding component 5303, the AI tool and/or rule engine communicate via an API (e.g., via a Python Flask API, which is a Representational State Transfer (REST) API built via the Python™ programming language and the Flask micro web framework). Regarding components 5304, 5306, 5307 any questions and recommendations are generated using the LangChain framework (i.e., for developing applications powered by LLMs) connected to an OpenAI endpoint (i.e., component 5307) for dynamic SQL code generation, access and use of a chatbot (e.g., the ChatGPT product available from the OpenAI company). Prompt engineering (component 5308) is used for training on the data. Regarding components 5305 and 5309, a machine learning platform endpoint (e.g., a DataRobot™ platform endpoint) is used to generate any predictions (i.e., component 5305).

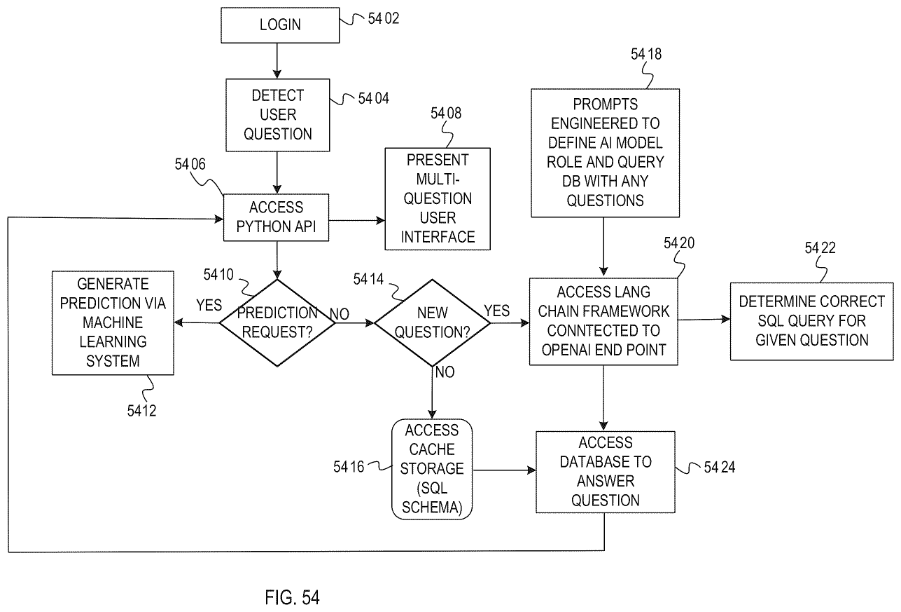

FIG. 54 illustrates an example flow 5400 according to some embodiments of the present disclosure. The description of the flow 5400 refers to a “processor” that performs operations associated with the flow 5400. It should be noted that the reference to the processor may refer to the same physical processor or it may be one of a set of a plurality of processors. The set of processors may operate in conjunction with each other and may be distributed across various networked devices (e.g., across the network 100, via the components of the architecture 1100, via devices associated with architecture 5300, etc.). The types of processors may include a central processing unit, a graphics processing unit, any combination of processors, etc. In one embodiment, the processor may be included in, or refer to, one or more devices of the network 100, such as any one of the devices connected via the casino network 132 (e.g., gateway 120, CMS 135, gaming machine 110, player interface device 111, etc.) or any device connected via the telecommunications network 160 (e.g., the data platform system 140, third-party system(s) 150, etc.). In one embodiment, the processor may be the central processing unit (CPU) 242 (see FIG. 2) or a processor in another device mentioned herein, such as the processor 342 associated with the computer 300, a table controller, a card-handling device, a camera controller, a game controller (e.g., game controller 112), a gaming server, etc.

Referring to FIG. 54, the flow 5400 begins at processing block 5402, where a processor logs in a user to the AI tool. The flow 5400 continues at processing block 5404 where a processor detects a user question (e.g., via a text-based prompt). The flow 5400 continues at processing block 5406 where a processor accesses a Python API. The flow 5400 continues at processing block 5408 where a processor presents a multi-question user interface (e.g., interface 4701). The flow 5400 continues at processing block 5410 where a processor detects whether the user question (e.g., entered at processing block 5404), is a request for a prediction (e.g., via selection of prompt assistance control 4725). If, at processing block 5410, a request is made for a prediction, then the flow 5400 continues at processing block 5412 where a processor generates the prediction via access to the machine learning platform. If, at processing block 5410 it is determined that a request is not made for a prediction, then the flow continues at processing block 5414 where a processor determines whether the question was a new question. If, at processing block 5414 it is determined that the question is not a new question, then the flow continues at processing block 5416 where a processor accesses cache storage (e.g., via a SQL schema), which, at processing block 5424 accesses the database to obtain answer (e.g., see element 4606 of flow 4600). If, at processing block 5414, it is determined that the question is a new question, then the flow 5400 continues at processing block 5420 where a processor accesses a Lang Chain framework connected to an endpoint associated with the OpenAITM platform. Prior to accessing the Lang Chain framework, the flow 5400 performed processing block 5418 where a processor performs prompt engineering to define an AI model role and to query a database with any questions. Furthermore, in response to processing block 5420, the flow 5400 continues at processing block 5422 where a processor determines a correct SQL query for the given question. In response to performance of processing block 5422, the flow 5400 continues at processing block 5424 where a processor uses the SQL query to access the database and answer the question.

In one embodiment, an AI tool is described that can predict and identify fraudulent activities, sending live and enhanced data to a machine learning platform, etc. For instance, the AI tool can leverage slot machine transactions from a range of player-specific and operational information to detect potential money laundering schemes, suspicious behaviors, anomalies that deviate from usual or expected patterns, etc. In some embodiments, the enhanced data includes player identifiers (IDs), demographic information, player transaction histories, information about player behaviors, information about environmental context (e.g., time of day, special events, etc.), and so forth, thus providing a holistic view of activities within a casino. An AI tool that detects and protects against fraud is a solution to various problems facing gaming technology including, but not limited to protecting the integrity and/or value of gaming assets, ensuring regulatory compliance, preventing crime, ensuring fairness to patrons, safeguarding operator reputation, preventing crimes from occurring on a casino property, preventing financial losses, maintaining trust, and so forth. Furthermore, the AI tool solves the problems in various technical ways including, but not limited to, (a) holistic fraud detection through comprehensive data (e.g., use of a machine learning model that utilizes an extensive data set combining slot machine data, player specific information, and behavior and operational information to detect fraudulent activities, facilitate predictive modeling, implement intelligent decisions, optimize operations, and so forth), (b) regulatory compliance and reporting (e.g., aiding casinos to comply with anti-money laundering regulations through details tracking and reporting of player activities and transactions for compliance and gaming board regulations), (c) operational efficiency (e.g., providing casino operators and security teams with actionable insights for preemptive fraud control and efficient investigation based on real-time data, providing alerts, etc.), (d) enhancing a play experience (e.g., safeguarding players from fraudulent gaming activities via unscrupulous gamers), etc. For example, to solve these problems, the AI tool uses a specifically designed machine learning model that uses a multi-class classification type and which has a clear description of fraud types (e.g., via features and weightage information, such as, but not limited to, funds in, funds out, number of games played, amount won, session duration, voucher out information, jackpot information, hand pays, etc.). The AI model can detect and/or prevent or reduce occurrences of (a) repeated large transactions with minimal play and short sessions (a behavior indicative of possible money laundering as it varies from typical gaming play where a player would typically plays various times before cashing out), (b) frequent jackpot wins or hand pays across different machines (frequent jackpot wins or hand pays across different machines indicates a possible manipulation or exploitation of a machine vulnerabilities), (c) discrepancies between player profile and activity, (d) abnormal use of promotional credits, (e) anomalies in play patterns during special events, (f) inconsistencies in trip details and gaming activities, (g) etc.

In one embodiment, the AI tool performs various countermeasures, such as, but not limited to, marking a cashout voucher as suspicious (which will prevent the cashout ticket from being cashed out via an automated kiosk and would instead require cashout via a cashier station where a cashier can assess and/or vet the voucher based on the detected fraudulent behavior), automatically disabling a machine that has been used for suspected fraudulent activities until a machine investigation is completed, identifying collusion, transmitting notifications of the suspected fraud (and/or fraud type) to a decision support system (e.g., a gaming operator system associated with a casino employee or administrator, a security station, a cashier station, etc.), etc.

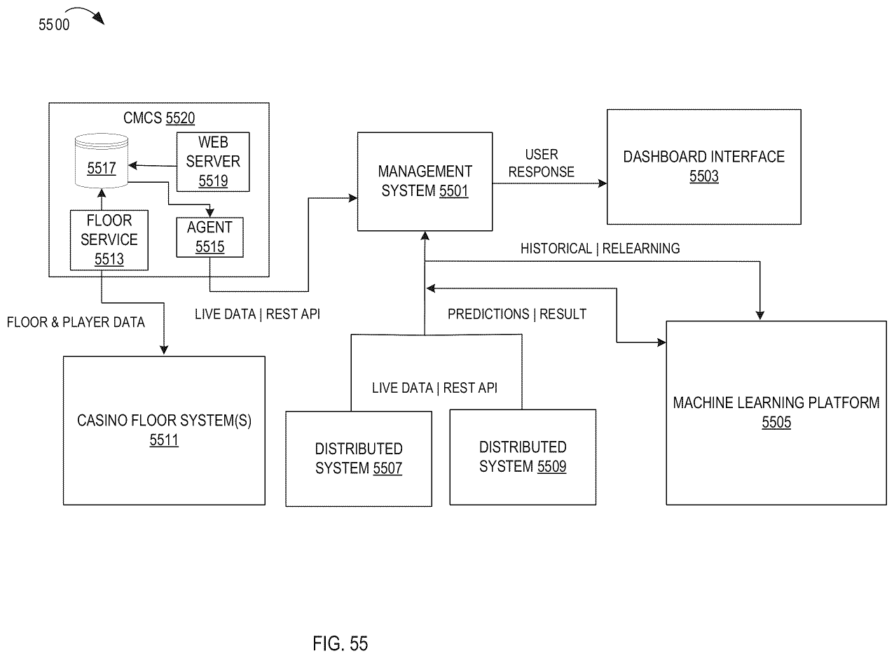

FIG. 55 illustrates an architecture 5500 associated with an AI tool according to one or more embodiments of the present disclosure. Referring to FIG. 55, an agent 5515 is included in central monitoring and control system (CMCS) 5520. In one embodiment, the CMCS 5520 includes a database 5517 to store data regarding all transactions, events, activities, etc. related to casino operations, game play, patron accounts, etc. In one example, the CMCS 5520 includes a floor service 5513 that communicates with one or more casino floor systems 5511 to provide floor and player data. Agent 5515 contains live data and provides access to data in the database 5517. Agent 5515 is a lightweight agent that uses a service-oriented network gateway. The agent 5515 constantly polls database 5517 for information and forwards the data immediately to management system 5501. The management system 5501 runs a prediction service based on the data. The management system 5501 analyzes the data, using machine learning platform 5505, and provides real-time insights of the data. The predictions are presented via a dashboard interface 5503 to permit an administrator to take immediate action. Additionally, the management system 5501 can trigger automated responses such as, but not limited to, mobile alerts, emails, etc. Further, the management system 5501 can suspend a player card or place a ticket (e.g., a cashout voucher) in a non-redeemable state (causing a player to visit a decision support station, such as a cage/cashier station to reactive the card and/or to redeem the ticket after some basic investigation or verification). The dashboard interface 5503 also provides features for an administrator (“admin”) to take action on some prediction results, such as by approving or rejecting the predictions. The action initiated by the admin feeds the data back to the model (e.g., to the machine learning platform 5505) to retrain the model and make the model more robust to predict fraudulent activities with more accuracy in the future. Furthermore, the architecture 5500 supports a distributed environment for many venues and seamlessly integrates with any systems or sources of data collection or player activity of the distributed system. For example, the management system 5501 receives live data from the agent 5515, and also receives live data from a first venue (e.g., via distributed system 5507), from a second venue (e.g., via distributed system 5509), and is scalable to many other venues. Each distributed system includes its own version or instance of agent 5515.

In one embodiment, the machine learning model used by the AI tool (e.g., via use of architecture 5500), includes a single classification model having only one type of fraud prediction. In another embodiment, the AI tool uses a multi-classification model having varied classifications of fraud. Some examples of the different classifications related to a fraud determination include, but are not limited to, the following: (a) no fraud, (b) frequent jackpot wins (e.g., if a certain amount is won above a certain limit from a venue multiple times per day), (c) faulty high tier wins, (d) faulty machine free plays, (e) perfect ticket fraud (e.g., when a ticket out is a round number of 100, or rather when modulus 100 equals 0), (f) balance manipulation fraud (when amount in and amount out are the same or almost the same), (g) etc. Thus, the model can predict various types of fraud as well as reasons for the prediction. One example model for the AI tool includes the light-gradient boosted trees classifier with early stopping. Furthermore, in some embodiments, when a fraud type is detected, the model further returns a list of the top features (e.g., top 3 features) that were responsible (e.g., most relevant, of most importance, etc.) to making the prediction.

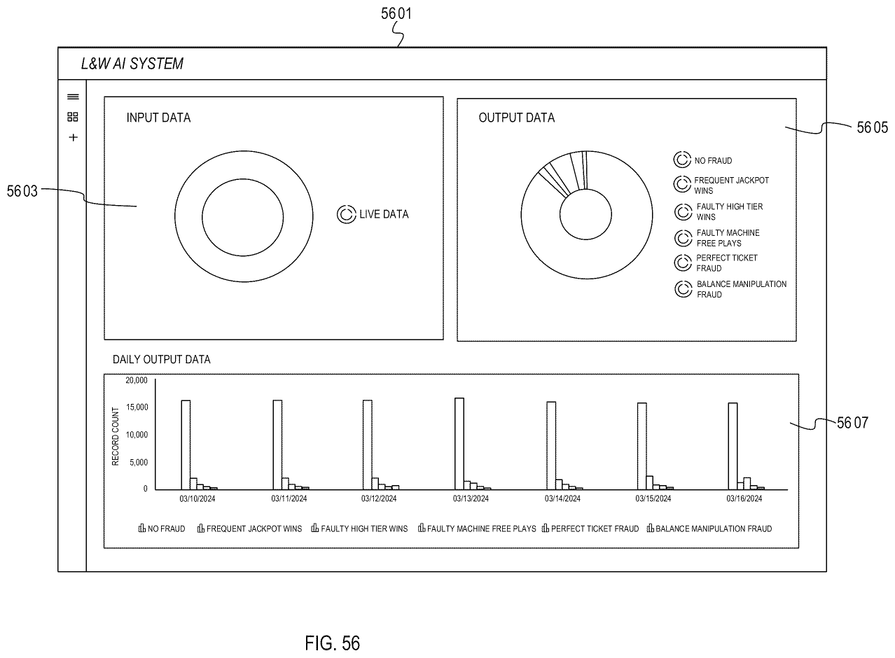

FIG. 56 illustrates an example interface for an AI tool according to one or more embodiments of the present disclosure. Referring to FIG. 56, a dashboard interface (interface 5601) presents widgets 5603, 5605 and 5607. Widget 5603 explains the data pipeline in (e.g., into the management system 5501). Widget 5605 explains the various classifications of the output data (e.g., no fraud vs. other fraud types). Widget 5607 explains the output data according to a daily basis (e.g., detected fraud types per day). The AI tool can further monitor, in real-time, activities that occur via a gaming machine by a gaming patron and can further enact countermeasures (e.g., notify a decision support system, initiate a workflow to prevent redemption, etc.) based on a detection of a type of possible fraud.

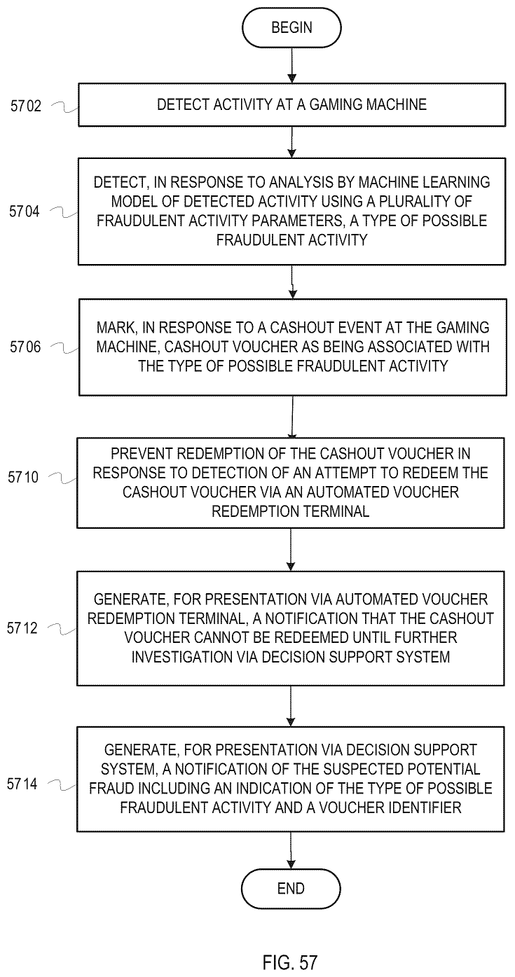

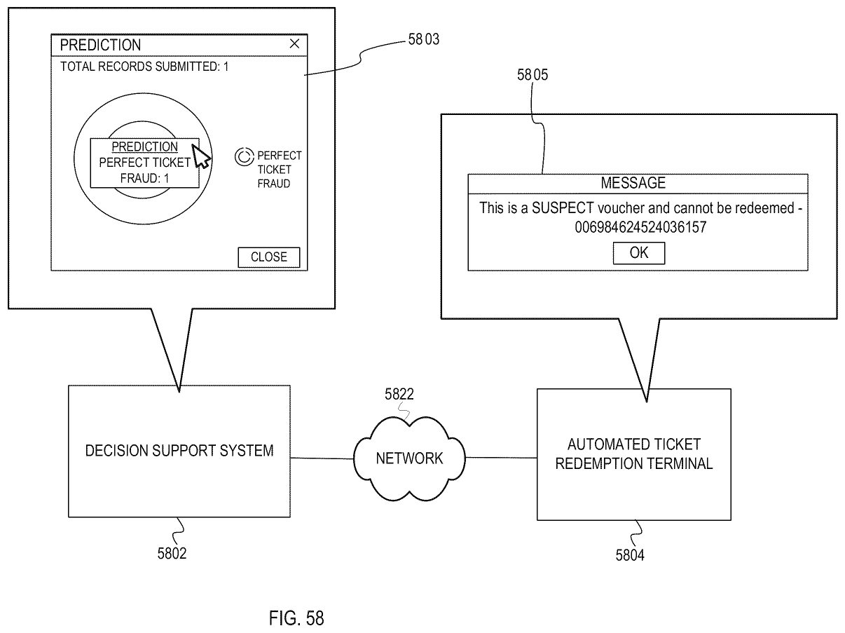

FIG. 57 illustrates a flow 5700 for detection of potential fraud and enactment of countermeasures according to one or more embodiments of the present disclosure. The flow 5700 is described in association with FIG. 58 through FIG. 60 and will refer to elements thereof. The description of the flow 5700 refers to a “processor” that performs operations associated with the flow 5700. It should be noted that the reference to the processor may refer to the same physical processor or it may be one of a set of a plurality of processors. The set of processors may operate in conjunction with each other and may be distributed across various networked devices (e.g., across the network 100, via the components of the architecture 1100, via devices associated with architecture 5300, via devices associated with architecture 5500, etc.). The types of processors may include a central processing unit, a graphics processing unit, any combination of processors, etc. In one embodiment, the processor may be included in, or refer to, one or more devices of the network 100, such as any one of the devices connected via the casino network 132 (e.g., gateway 120, CMS 135, gaming machine 110, player interface device 111, etc.) or any device connected via the telecommunications network 160 (e.g., the data platform system 140, third-party system(s) 150, etc.). In one embodiment, the processor may be the central processing unit (CPU) 242 (see FIG. 2) or a processor in another device mentioned herein, such as the processor 342 associated with the computer 300, a table controller, a card-handling device, a camera controller, a game controller (e.g., game controller 112), a gaming server, etc.

Referring to FIG. 57, the flow 5700 begins at processing block 5702, where a processor detects activity at a gaming machine. For example, a gaming patron performs one or more activities at the gaming machine including, but not limited to, a cash in event (e.g., to input a certain amount of cash), a cash out event (e.g., to generate a cash out voucher), one or more gaming inputs (e.g., to play one or more games at the gaming machine), etc.

The flow 5700 continues at processing block 5704 where a processor detects, in response to analysis by machine learning model of detected activity using a plurality of fraudulent activity parameters, a type of possible fraudulent activity. For example, the processor determines, using the machine learning model(s) described in association with architecture 5500, that the activity matches one of the classifications related to a fraud determination, such as whether there was no fraud detected, or whether there was one of specific types of fraud.

The flow 5700 continues at processing block 5706 where a processor marks, in response to a cashout event at the gaming machine, a cashout voucher as being associated with the type of possible fraudulent activity. For example, the processor associates a serial number associated with the cashout voucher with a record entry accessible to a decision support system (e.g., a system associated with architecture 5500, such as management system 5501, dashboard interface 5503, casino floor systems 5511, or any other operator system that may be connected to a network, such as a cashier station system, a security station system, etc.).

The flow 5700 continues at processing block 5710 where a processor prevents redemption of the cashout voucher in response to detection of an attempt to redeem the cashout voucher via an automated voucher redemption terminal. For example, referring to FIG. 58, the gaming patron takes the cashout voucher to automated voucher redemption terminal 5804 (e.g., a kiosk on the casino floor), to attempt to redeem the voucher for cash. The automated voucher redemption terminal 5804 reads a voucher identifier number (e.g., a voucher serial number) for the voucher and determines that the voucher identifier number has been marked (e.g., at processing block 5706) as being suspicious. Consequently, the automated voucher redemption terminal 5804 prevents the redemption of the voucher.

The flow 5700 continues at processing block 5712 where a processor generates, for presentation via automated voucher redemption terminal, a notification that the cashout voucher cannot be redeemed until further investigation via a decision support system. For example, in FIG. 58, the automated voucher redemption terminal 5804 presents message 5805 via a display of the automated voucher redemption terminal 5804 (e.g., message 5805 states, “This is a suspect voucher and cannot be redeemed”). In some embodiments, the message 5805 can further specify instructions for the patron to follow, such as visiting an investigation station associated with decision support system 5802, such as a cashier station, for further processing. In some embodiments, the message 5805 further presents a map to a location where the investigation station is located.

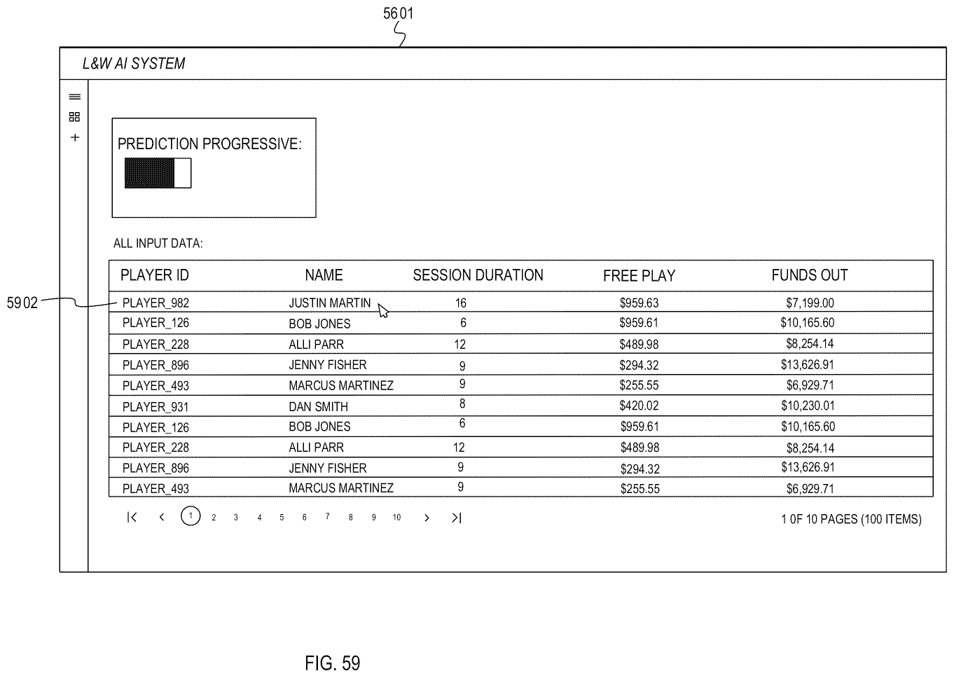

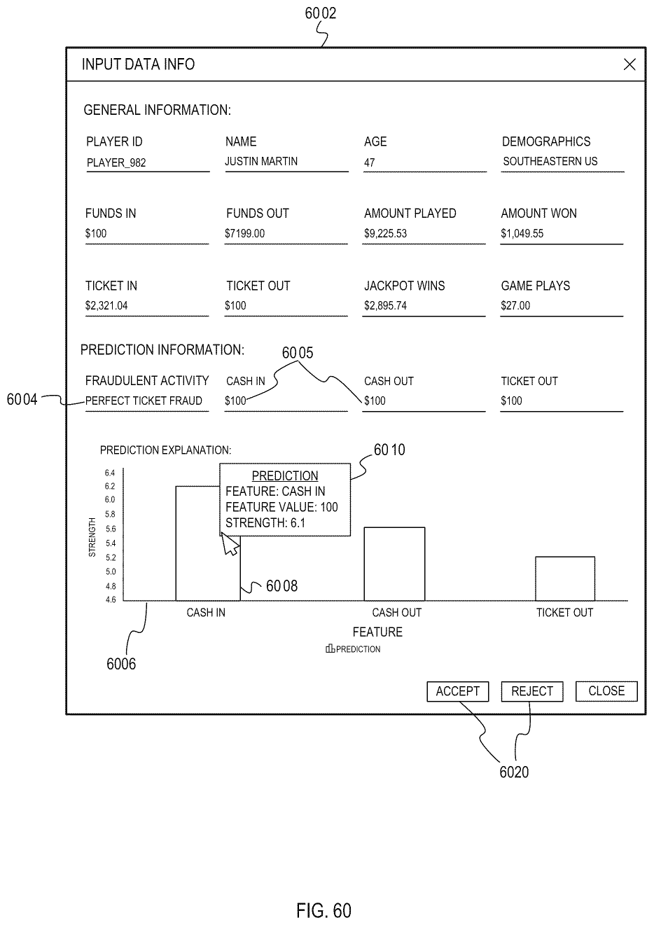

The flow 5700 continues at processing block 5714 where a processor generates, for presentation via decision support system, a notification of the suspected potential fraud including an indication of the type of possible fraudulent activity and voucher identifier. For example, as shown in FIG. 58, decision support system 5802 presents (e.g., via dashboard interface 5503, via interface 5601, etc.) notification 5803 showing the predicted type of fraud. In one embodiment, as illustrated in FIG. 59, an operator (e.g., a cashier or other decision maker that investigates the voucher) can access the interface 5601 and can select a record 5902 associated with the voucher. In response to selection of the record 5902, as illustrated in FIG. 60, a screen 6002 appears showing information related to the voucher, the patron, the gaming session, etc. Furthermore, the screen 6002 indicates the type of fraud (e.g., fraud type indicator 6004 indicates the type of fraud), as well as values 6005 for relevant features related to the fraud prediction analysis. Furthermore, the screen 6002 specifies prediction explanations, such as graph 6006. The graph 6006 is a bar chart with bars (e.g., bar 6008) associated with each of the relevant features used for the prediction, along with an indicator of the basis and strength associated with the relevant feature for making the prediction. When a bar (e.g., bar 6008) is selected, a pop-up screen 6010 occurs, which hovers over the bar 6008 and which indicates details about the feature (e.g., the feature name, the feature value, the feature strength, etc.). Furthermore, the screen 6002 includes controls 6020 for an operator decision regarding the potentially detected fraud type. For example, the operator can accept or reject the indication of detected potential fraud. If the indication of detected potential fraud is accepted as a fraud the voucher remains unredeemable and the activity is stored in the system as fraudulent. If the indication of detected potential fraud is rejected by the operator, the voucher is made redeemable. Furthermore, details regarding the operator decision are stored via the decision support system and submitted for regular reinforcement and/or retraining of the machine learning model(s). Thus, any previous data already predicted as fraud can be updated to non-fraud, and in the future any similar activity identified as potential fraud will be classified as non-fraud.

In one embodiment, an AI tool (e.g., a smart-audit AI tool) can optimize performance of casino revenue audits. For example, the smart-audit AI tool can leverage machine learning and artificial intelligence to consolidate and automate a casino revenue audit system. Casino revenue audits are essential for maintaining the financial integrity of a casino. However, conventional casino revenue audit systems are time consuming, resource intensive, and prone to human error. The smart-audit AI tool provides a smart audit process that automates the casino audit process, increases efficiency and precision of the casino audit system, and saves significant amount of time required for investigation, adjustment, and reconciliation. For instance, a current manual auditing process involves, an auditor, at audit start of day, manually analyzing and processing reports (e.g., financial detail reports, system adjustment reports, standard meter exception reports, etc.), which the auditor must import into a casino accounting system (e.g., the SDS® slot-management product) for the auditor to make manual system adjustments and/or reversals based on their analysis. Afterwards, the auditor must perform additional manual steps of analyzing and processing data for audit checking (e.g., for accuracy reporting, for data reconciliation, etc.). Various types of audits exist for various aspects of casino operations (e.g., slot machine audit, tables audit, food and beverage audit, cage audit, vault audit, hotel audit, kiosk audit, etc.), all of which follow similar procedures.

The smart-audit AI tool improves the auditing system for performance of any of the audit types. For example, the AI tool automatically fetches transaction data (e.g., gaming data, revenue reports, accounting reports, etc.) to be audited from data sources of the financial information. The smart-audit AI tool automatically trains machine learning model(s) based on the transaction data. The smart-audit AI tool further automatically calculates audit predictions using the machine learning model(s). The AI smart-audit tool further presents the calculated audit predictions via a dashboard or interface for execution, reporting, etc. by an auditor. In one embodiment, the smart-audit AI tool can perform automated adjustments to the data and store, in one or more logs, details about the audit, thus creating an audit trail. Furthermore, the smart-audit AI tool can mark any auto-adjustments as being made by the smart-audit AI tool as opposed to being made by a user. In addition, the smart-audit AI tool can store the transaction data per site, per date, etc. for review by an auditor, who can indicate whether there is a discrepancy in the automatically calculated audit predictions, which discrepancy can be reported and/or used for additional training of the machine learning model(s).

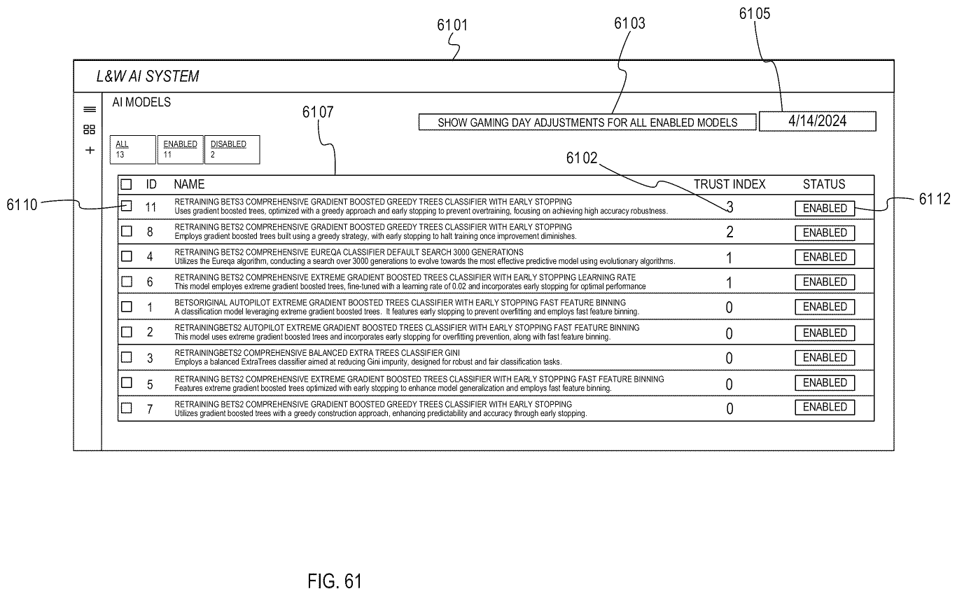

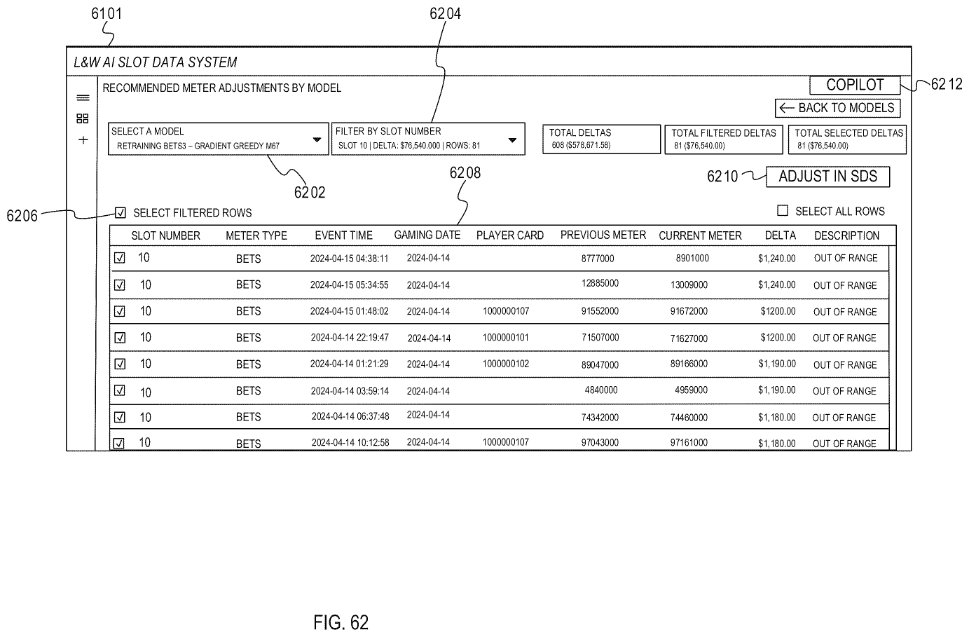

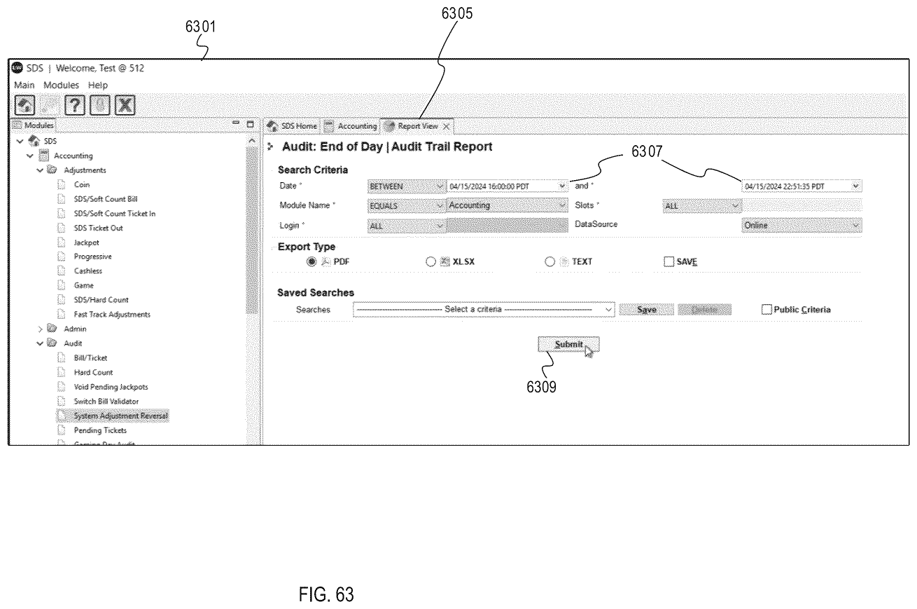

FIG. 61, FIG. 62, and FIG. 63 illustrate an example of a smart-audit AI tool according to one or more embodiments of the present disclosure. The descriptions of FIG. 61, FIG. 62, and FIG. 63 describe an example of a meter audit performed via the smart-audit AI tool. For example, a meter audit determines whether the deltas of a previous meter value and a current meters are correct. If, during the meter audit, the smart-audit AI tool determines that the meters are not correct, the smart-audit AI tool automatically makes adjustments to modify one or more gaming transactions (e.g., reverse, return to revenue, etc.). Based on the adjustments, the smart-audit AI tool can further generate a system adjustment report. The machine learning model(s) for the smart-audit AI tool can be trained using a data set having various variables or inputs including, but not limited to, a previous meter value, a current meter value, a delta (i.e., the difference between the current meter value and the previous meter value), a target input value (i.e., specifying whether the delta is valid via a 1 or 0 value), a transaction identifier, a slot machine identifier, a gaming date, an employee card identifier, a player card identifier, etc. In one embodiment, a gradient boosted greedy trees classifier with early stopping is used for at least one machine learning model.

FIG. 61 illustrates an interface 6101 for the smart-audit AI tool according to one or more embodiments. The interface 6101 includes a models list 6107 specifying all of the models that are trained and deployed for use with the smart-audit AI tool. The models list 6107 includes one or more controls 6112 to indicate a status for the model (e.g., enabled, not enabled), as well as a selection control 6110 (e.g., regarding which model is selected for use, configuration, etc.). A trust index score 6102 is specified for each model in the models list 6107 (e.g., a higher trust score indicates a better performing model). Control 6105 specifies a gaming date and control 6103 is selectable to show gaming day adjustments for any available model for the date specified in the control 6105. When the control 6103 is selected, an additional screen appears via the interface 6101 as shown in FIG. 62.

As illustrated in FIG. 62, the interface 6101 includes a model selection control 6202, which is a dropdown to select any of the models that were listed in the models list 6107 (e.g., see FIG. 61). In one embodiment, the model selection control 6202 defaults in value to the most trusted model specified in the models list 6107 (e.g., the model with the highest trust index score 6103). Filter control 6204 permits selection of totals based on specific filters, such as totals for a specific gaming machine or totals for all gaming machines. One or more selection controls (e.g., selection control 6206) select the rows specified in a slot data table 6208. Button control 6210 can be selected to automatically perform adjustments in the slot accounting system (e.g., via API access to the slot accounting system). The smart-audit AI tool can further include a control 6212 that launches a chatbot feature to answer questions about the system and/or auditing without having to run reports solely via prompt engineering.

FIG. 63 illustrates an example interface 6301 for a slot accounting system (e.g., for the SDS® slot-management product), from which a report tab 6305 presents time range field 6307 to specify a time range (e.g., a date range for an end of day audit trail report), and a submit button 6309 to generate a report showing the automatic adjustments made by the smart-audit AI tool for that time range, such as a report specifying a “change field” entry specifying each auto-adjustment made (e.g., the change field entry states “SmartAudit System Adjustment Reversal”).

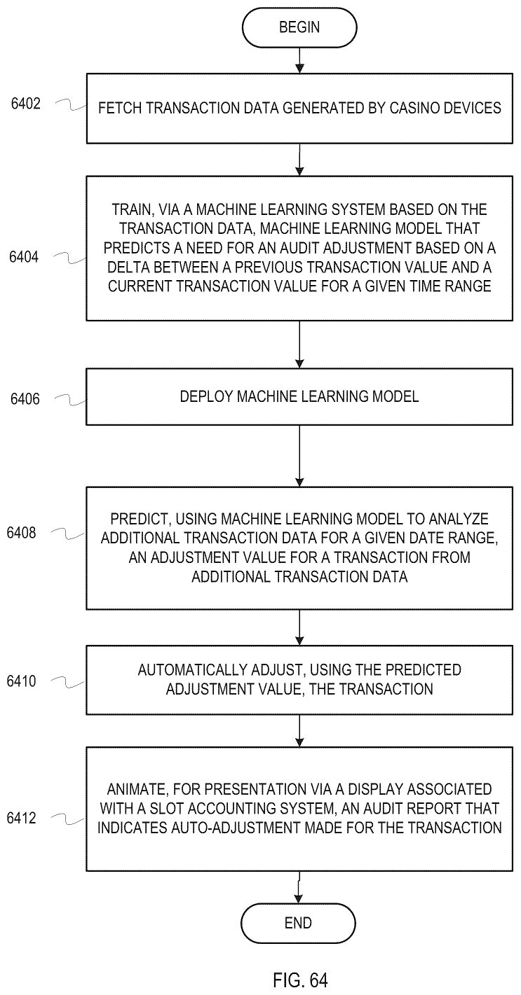

FIG. 64 illustrates an example flow 6400 according to an embodiment of the present disclosure. The description of the flow 6400 refers to a “processor” that performs operations associated with the flow 6400. It should be noted that the reference to the processor may refer to the same physical processor or it may be one of a set of a plurality of processors. The set of processors may operate in conjunction with each other and may be distributed across various networked devices (e.g., across the network 100, via the components of the architecture 1100, via devices associated with architecture 5300, via devices described in association with FIG. 61-63 etc.). The types of processors may include a central processing unit, a graphics processing unit, any combination of processors, etc. In one embodiment, the processor may be included in, or refer to, one or more devices of the network 100, such as any one of the devices connected via the casino network 132 (e.g., gateway 120, CMS 135, gaming machine 110, player interface device 111, etc.) or any device connected via the telecommunications network 160 (e.g., the data platform system 140, third-party system(s) 150, etc.). In one embodiment, the processor may be the central processing unit (CPU) 242 (see FIG. 2) or a processor in another device mentioned herein, such as the processor 342 associated with the computer 300, a table controller, a card-handling device, a camera controller, a game controller (e.g., game controller 112), a gaming server, etc.

Referring to FIG. 64, the flow 6400 begins at processing block 6402, where a processor fetches transaction data generated by casino devices. For example, the casino devices may be connected via a casino network and the transaction data may be aggregated or collected over a period of time (e.g., historical data).Referring still to FIG. 64, the flow 6400 continues at processing block 6404, where a processor trains, via a machine learning platform based on the transaction data, a machine learning model that predicts a need for an audit adjustment. In one embodiment, the machine learning model is trained to predict the need for the audit based on a delta between a previous transaction value and a current transaction value for a given time range.

Referring still to FIG. 64, the flow 6400 continues at processing block 6406, where a processor deploys the machine learning model from the set of machine learning models. An example is illustrated in FIG. 61 where the deployed model(s) is/are presented in the interface 6101 via the models list 6107. In one embodiment, the processor deploys the machine learning model to a subscription service or platform (e.g., via the MaaS structure).

Referring still to FIG. 64, the flow 6400 continues at processing block 6408, where a processor predicts, using machine learning model(s) to analyze additional transaction data for a given date range, an adjustment value for a transaction from additional transaction data. In some embodiments, the processor predicts the adjustment value based on use of a subscription service for the machine learning model.

Referring still to FIG. 64, the flow 6400 continues at processing block 6410, where a processor automatically adjusts, using the predicted adjustment value, the transaction. The processor stores in computer memory a record (e.g., a transaction adjustment log) detailing the auto-adjustment. In some embodiments, the interface 6101 shown in FIG. 62 can be used to initiate and/or monitor the performance of the auto-adjustment(s) made to many records (e.g., in a batch process).

Referring still to FIG. 64, the flow 6400 continues at processing block 6412, where a processor animates, for presentation via a display associated with a slot accounting system, an audit report that indicates the auto-adjustment made for the transaction (e.g., the processor recalls from memory the details of the auto-adjustment). For example, as shown in FIG. 63, the report can be generated via the example interface 6301 for the slot accounting system.

In some embodiments, a system (e.g., an AI tool) described herein uses one or more machine learning models that is/are designed and trained to predict player behavior, detect specific risks (and/or risk levels), and optimize casino operations based on the predicted player behavior and/or risk(s). In one embodiment, the machine learning model relies on Recency, Frequency and Monetary (RFM) engagement metrics, such as to analyze reinvestment behavior and denomination (“denom”) change behavior. Such detected change in behavior provides valuable insights into how players respond to incentives and adjust their betting strategies. An operator can use these detected insights to fine-tune loyalty programs, promotions, and game mechanics, target specific player segments, optimize marketing spending, and so forth. The following paragraphs describe examples of one or more machine learning models (machine learning model(s)) according to one or more embodiments of the present disclosure.

Referring to said examples of machine learning model(s), in one example an AI tool uses a “player decliner” model to predict players who are declining or disengaging in a gaming experience by identifying when players are likely to reduce their attention, focus, activity, etc. based on their historical gaming patterns. For instance, an AI tool uses the player decliner model to enable an operator to target players flagged by the model with personalized incentives, such as bonuses or loyalty offers, to re-engage them and prevent churn. The AI tool thus improves player retention rates by addressing declining behavior early and encouraging return visits.

Still referring to examples of machine learning model(s), in another example an AI tool uses a “quick loss” model to predict players who are likely to experience quick losses and become disengaged. The quick loss model analyzes factors such as the size of bets, frequency of losses, and session duration to identify players at risk. For instance, an AI tool uses the quick loss model to enable operators to intervene by offering players incentives such as bonus rounds or free plays to keep them engaged and to prevent frustration from leading to churn. The AI tool thus enhances player satisfaction by mitigating early session losses and improving an overall gaming experience.

Still referring to examples of machine learning model(s), in another example an AI tool uses an “anti-money laundering” (AML) model to detect suspicious player transactions and behaviors that may indicate potential money laundering activities. For example, the AML model monitors for anomalies such as large cash-ins followed by immediate cash-outs, atypical betting patterns, or deviations from a registered player's historical behavior. In one instance, the AI tool enables operators to flag high-risk transactions for further investigation, ensuring adherence to financial regulations and preventing illegal activities. By automating the detection of suspicious behaviors, the AI tool helps reduce both financial and reputational risks, reinforcing compliance with anti-money laundering laws.

Still referring to examples of machine learning model(s), in another example an AI tool uses a “slot optimization” model to analyze game performance metrics such as time on device (TOD), average bet size, and session frequency to optimize the configuration of slot machines. The slot optimization model can assist operators to identify which slot machines need adjustments to their volatility, payout structure, or bonus frequency. For instance, an AI tool uses the slot optimization model to enable operators to reconfigure underperforming slot machines or adjust them based on player preferences to enhance engagement and revenue. The AI tool thus provides a technical solution that increases slot machine profitability by maximizing player satisfaction and optimizing a gaming experience.

Still referring to examples of machine learning model(s), in another example an AI tool uses a “player rank” model to rank players based on various engagement metrics such as spend, session duration, frequency, and loyalty program participation. The player rank model can segment players into tiers (e.g., very-important-person (VIP), casual, frequent) and help casinos tailor their promotions and loyalty offers accordingly. For instance, an AI tool uses the player rank model to personalize offers and incentives created for different player ranks and to maximize the value of high-tier players while nurturing lower-tier players to increase their engagement. The AI tool thus maximizes player lifetime value (PLV) by effectively targeting promotions and loyalty rewards to different player segments.

Still referring to examples of machine learning model(s), in another example an AI tool uses a “player future value” model to forecast a future value of a player by analyzing historical behavior, spending patterns, and engagement data. The player future value model assists an operator to estimate how much revenue a player is likely to generate over a given time period. For instance, an AI tool uses the player future value model to enable an operator to prioritize high-value players and focus retention efforts on those predicted to generate the most revenue. This also helps in allocating marketing resources efficiently. The AI tool thus increases profitability by focusing on high-potential players and ensuring that marketing efforts are aligned with predicted player value.

In some embodiments, an AI tool, or other system or devices described herein, can use the above described models to detect suboptimal game configurations through performance analysis (e.g., to identify games that are underperforming compared to others in terms of player engagement, revenue, and time on device). The AI tool can further be used to group games based on session experience (e.g., game themes, volatility, and in-game features) to enhance engagement and maximize player satisfaction. In one embodiment, the AI tool further (e.g., via player decliner model) signals decline or incline trends for RFM and, via one or more of the models, determines intervention strategies, analyzes reinvestment behavior (e.g., A/B testing for lift analysis and adjust reinvestment), and so forth.

In some embodiments, reinvestment behavior refers to enabling an operator system to use a portion of their profits or customer spending to provide incentives or rewards that encourage further player engagement and retention. This can involve, for example, reinvestment in the form of player loyalty programs, bonuses, comps (complimentary services), or other rewards aimed at incentivizing players to return and continue spending money at the casino. From a behavioral perspective, reinvestment behavior is observed in how effectively players respond to these incentives and return to engage with the casino.

Various types of reinvestments are described herein, such as loyalty points, promotional offers, comps, bonuses, etc. Player loyalty points can be earned based on a degree of detected game play. Player loyalty points can be redeemed for rewards like free play, hotel stays, meals, or other perks, to encourage players to continue gambling to accumulate more points. Promotional offers include targeted promotions, such as free spins, bonuses, or tournament entries, to bring players back after periods of inactivity. Complimentary offers (comps) are provided to high-value players or VIPs. This may include complimentary services like hotel rooms, meals, or event tickets to ensure they return and continue playing. Bonuses can include monetary offerings, such as free credits or bonus cash, which players can use during future visits.

An AI tool can measure reinvestment behavior in various ways, including, but not limited to, player retention rate, average spend per visit, player lifetime value, etc. Player retention rate refers to an effectiveness of reinvestment and can be measured by how many players return after receiving rewards. Higher retention rates indicate successful reinvestment strategies. Average spend per visit involves monitoring whether reinvestment leads to increased spend or more extended playtime from returning players. Player lifetime value (PLV) measures reinvestment in terms of increases of/to an overall lifetime value of players. Successful reinvestment maximizes PLV by encouraging sustained play over time.

Further, in some embodiments, an AI tool optimizes reinvestment behavior for operators by ensuring that offers of the right incentives are provided to the right players at the right time. The AI tool uses machine learning model(s) to analyze player data and optimize reinvestment strategies by segmenting players by their likelihood to respond to various incentives, predicting the impact of specific rewards on a player's future spending behavior, balancing the cost of reinvestment (e.g., offering comps) with the anticipated return (e.g., increased gaming activity), etc. The AI tool thus finds the right balance of incentives and encourages continued player engagement while ensuring profitability for the casino. The AI tool thus provides effective reinvestment strategies to drive player loyalty and to increase a frequency and volume of play over time.

The following are examples of optimizing reinvestment behaviors according to some embodiments of the present disclosure: player loyalty program optimization, targeted player retention campaigns, dynamic promotional offers, incentivizing responsible play, maximizing high-value player lifetime value (PLV), optimizing promotional costs, slot machine or game reinvestment strategies, cross-selling non-gaming experiences, predictive analytics for VIP experience customization, etc.

Referring to said examples of optimizing reinvestment behaviors, regarding player loyalty program optimization, an AI tool can offer tiered loyalty programs, where players earn points based on their spend and gameplay. In at least embodiment, the AI tool analyzes reinvestment behavior by enabling an operator to optimize programs by adjusting point accumulation rates, rewards, or bonuses. For example, an AI tool identifies that players who receive free play rewards are more likely to return and play for longer periods. The AI tool automatically adjusts its loyalty program to offer more frequent small free-play bonuses for mid-tier players, maximizing player retention and engagement. Similarly, the AI tool offers high-rollers exclusive comps (like VIP experiences) based on reinvestment data that shows a high return on providing these services. The AI tool thus causes increases in player loyalty, longer sessions, and higher spend per player.

Still referring to examples of optimizing reinvestment behaviors, regarding targeted player retention campaigns, an AI tool analyzes reinvestment behavior to segment players and predict who is at risk of churning (not returning to play). With this data, the AI tool can create personalized retention campaigns. The AI tool employes machine learning models to identify players who, based on their reinvestment patterns, are unlikely to return without intervention. AI tool automatically sends out personalized offers, such as free play or bonus credits, to these players to re-engage them. For example, if a player hasn't visited the casino for a month but typically responds to free play offers, the AI tool can send an offer for $50 in free credits if they return within the next week. The AI tool thus improves player retention rates and reduces churn.

Still referring to examples of optimizing reinvestment behaviors, regarding dynamic promotional offers, an AI tool can analyze reinvestment behavior to adjust promotional offers in real-time or on a rolling basis. These offers can be tailored to maximize a player's likelihood of returning and increasing their spend. For example, the AI tool tracks player reinvestment behavior in real time. If a player starts to decrease their reinvestment rate after losing a certain amount of money, the AI tool can dynamically offer a promotion to keep the player engaged. For instance, the AI tool might offer the player 10% back on their losses in the form of loyalty points if they continue playing for another hour. Alternatively, the AI tool may offer a high-roller an upgraded hotel room or a free dinner at a premium restaurant based on their reinvestment rate. The AI tool thus causes higher player engagement during sessions and maximizes lifetime player value (PLV).

Still referring to examples of optimizing reinvestment behaviors, regarding incentivizing responsible play, an AI tool performs reinvestment behavior analysis to encourage responsible gaming. By identifying patterns that may indicate problematic gambling behavior, the AI tool can offer tailored incentives that encourage lower-risk play. For example, the AI tool tracks that a player is consistently reinvesting a high percentage of their winnings back into play, signaling potential problem behavior. In response, the AI tool can send personalized messaging promoting responsible play practices, such as bonus offers that encourage the player to take a break or play at lower denominations. The AI tool can also automatically cap bonuses for players who show signs of chasing losses to prevent compulsive behavior. This can result in reduced risk of problem gambling, enhanced player well-being, and improved compliance with responsible gaming regulations. In one example, the AI tool detects individual play habits and, in response, detects a risk factor or level outside a player's individual normal patterns which would indicate individual risky behavior of play that is outside a normal behavior of the player. The analysis can be based on responsible gaming rules and/or responsible gaming restrictions (e.g., based on jurisdictional responsible gaming restrictions/limits, based on casino responsible gaming restrictions/limits, based on player-specified responsible gaming restrictions/limits). In some embodiments, the AI tool can, based on the risk factor or level, generate an optimal strategy to optimize a gaming session experience or operation associated with the player individually.

Still referring to examples of optimizing reinvestment behaviors, regarding maximizing high-value player lifetime value (PLV), an AI tool can enable maximization of Player Lifetime Value (PLV) of high-value or VIP players by analyzing reinvestment behavior and adjusting their reward structures. For example, the AI tool can identify a high-value player who regularly reinvests significant amounts in play as a candidate for personalized VIP offers. The AI tool can also automatically offer exclusive experiences like helicopter rides, personalized concierge services, or invitations to private events. By tracking how these players respond to various offers, the AI tool can fine-tune a reinvestment strategy to extend a relationship and increase overall PLV. This can result in higher revenue from VIP players and stronger long-term relationships.

Still referring to examples of optimizing reinvestment behaviors, regarding optimizing promotional costs, an AI tool can optimize promotional budgets by targeting only players who are likely to respond positively to rewards, thus avoiding unnecessary spending on players with low return rates. For example, the AI tool can notice that players in certain segments (e.g., casual visitors) are less responsive to high-value free-play offers. Instead of providing these players with costly incentives, the AI tool shifts its focus toward smaller but frequent rewards, such as food vouchers or entry into prize drawings. Meanwhile, for high-reinvestment players, the AI tool can increase the size of free-play offers or extend exclusive perks, knowing that these players are more likely to respond and continue playing. This can result in reduced promotional costs and more efficient marketing spend.

Still referring to examples of optimizing reinvestment behaviors, regarding slot machine or game reinvestment strategies, an AI tool can apply reinvestment behavior insights to individual games or slot machines. By analyzing how players reinvest winnings from specific machines, the AI tool can adjust the payback percentages, volatility, or bonus features. For example, the AI tool notices that players reinvesting their winnings on certain slot machines tend to increase their bets significantly after hitting a bonus. Based on this behavior, the AI tool can automatically fine-tune the bonus frequency or jackpot amounts on these machines to encourage more frequent denomination increases and reinvestment. In another embodiment, for machines with low reinvestment rates, the AI tool can offer in-game bonuses, free spins, or jackpots to incentivize more continued play. This can result in optimized game performance and increased time-on-device (TOD).

Still referring to examples of optimizing reinvestment behaviors, regarding cross-selling non-gaming experiences, an AI tool can offer non-gaming experiences like restaurants, shows, and hotel stays. By analyzing reinvestment behavior, the AI tool can target specific players with cross-sell offers for non-gaming services based on their reinvestment patterns. For example, the AI tool can detect a player who consistently reinvests a large portion of their winnings and can automatically offer complimentary dining or show tickets as a way to extend their overall spend beyond gaming. Additionally, the AI tool can detect players who appear to disengage after winning and the AI tool can entice them with non-gaming offers to keep them on property longer, leading to higher overall spend across different revenue streams. This can result in higher non-gaming revenue and an enhanced guest experience.

Still referring to examples of optimizing reinvestment behaviors, regarding predictive analytics for VIP experience customization, an AI tool can utilize predictive models based on reinvestment behavior to customize a VIP experience, to offer personalized services and perks to high-value players to increase their reinvestment rates and time-on-property, etc. For example, the AI tool can use predictive analytics to forecast when VIP players are likely to return based on their reinvestment history. For instance, if a player typically reinvests a significant amount after attending an event, the AI tool can automatically invite them to a private concert or exclusive party. This personalized attention increases the likelihood that the player will return, reinvest heavily, and continue spending. This can result in increased loyalty and higher PLV from VIP players.

The following are examples of key factors used to identify games to be grouped based on an overall session experience according to some embodiments of the present disclosure: player segmentation, volatility and payout structures, game theme and design, session length, in-Game features, and multiplayer vs. single player. An AI tool can analyze player behaviors, preferences, and engagement patterns to create a more cohesive and enjoyable experience for players. The AI tool can group games in this way to curate sets of games that appeal to similar player segments or moods, thereby enhancing engagement and retention.

Referring to said examples of key factors used to identify games to be grouped, regarding player segmentation, an AI tool can segment players into categories such as high-rollers vs. casual players, skill-based vs. luck bases games, etc. For instance, regarding high-rollers vs. casual Players, the AI tool can group games based on betting preferences to ensure that high-denomination games are clustered together for players seeking a high-risk, high-reward experience. Conversely, the AI tool can group game with lower denominations for casual or risk-averse players. Regarding skill-based vs. luck-based games, some players enjoy skill-based games like poker, while others prefer luck-based games like slot machines. The AI tool can group games based on the skill level required to tailor the session experience to player preferences.

Still referring to examples of key factors used to identify games to be grouped, regarding volatility and payout structures, an AI tool can be used group games and/or game aspects according to various types such as, but not limited to, high volatility games, low volatility games, progressive jackpots, etc. Regarding high volatility games, the AI tool can group games with higher volatility to provide bigger but less frequent payouts. These games might be appealing to thrill-seeking players who are looking for high-risk experiences. Regarding low volatility games, the AI tool can group games that offer smaller, more frequent payouts to create a more stable experience for players who prefer consistency and longer gameplay sessions. Regarding progressive jackpots, the AI tool can group games with progressive jackpots to cater to players who are seeking the excitement of potentially huge payouts.

Still referring to examples of key factors used to identify games to be grouped, regarding game theme and design, an AI tool can group games according to, but not limited to, visual themes, game mechanics, etc. For example, regarding visual themes, the AI tool can group games by theme (e.g., adventure, fantasy, classic Vegas, etc.) to enhance immersion and session continuity, such as for a player who enjoys games with a space or fantasy theme, the AI tool can group games within those categories. Regarding game mechanics, the AI tool can group games based on similar mechanics (e.g., multi-reel slots, megaways slots, card games, etc.) to provide a seamless experience for players who enjoy a particular style of play.

Still referring to examples of key factors used to identify games to be grouped, regarding session length, an AI tool can group games according to a variation of the session length. For instance, the AI tool can group games that appeal to different session lengths, such as short vs. long sessions. For instance, games with quick outcomes and fast-paced action might appeal to players who prefer shorter gaming sessions. On the other hand, games with more complex strategies, bonus rounds, or long playtimes are better suited for players who enjoy extended gaming sessions.

Still referring to examples of key factors used to identify games to be grouped, regarding in-game features, an AI tool can group games related to certain game features for example bonus-heavy games or classic simplicity games. Regarding bonus-heavy games, the AI tool can group games with frequent bonus rounds, free spins, or interactive mini-games. Regarding classic simplicity games, the AI tool can group games that do not have complex features or bonuses, such as classic-style games (e.g., traditional slot machines or table games) to attract players who favor a straightforward experience.

Still referring to examples of key factors used to identify games to be grouped, regarding multiplayer vs. single player, an AI tool can group games according to a number of players associated with the game. For example, the AI tool can group games for social players who enjoy the social aspects of gaming (e.g., poker, multiplayer slot tournaments), groups games based on multiplayer functionality, groups games based on live dealer, etc. In other examples, the AI tool groups games according to a solo experience, such as grouping games for those who prefer to play independently and without interaction.

The following are examples of data analysis to group games based on session experience according to some embodiments of the present disclosure: session duration analysis, win/loss pattern analysis, player transition patterns, and player satisfaction metrics.

Referring to the said examples of data analysis to group games, regarding session duration analysis, an AI tool can identify games that can lead to longer sessions and groups them together for players who are looking for extended playtime. For example, the AI tool can use player data to analyze session duration across different games. The AI tool can group games that consistently have longer sessions to encourage sustained player engagement.

Still referring examples of data analysis to group games, regarding win/loss pattern analysis, an AI tool can group games based on players' win/loss patterns to cater to different risk appetites. For example, the AI tool can group higher-denomination games or high-volatility games to facilitate a game transition by players who are more likely to increase their bets or switch to high-risk games after a big win.

Still referring examples of data analysis to group games, regarding player transition patterns, an AI tool can analyze how players transition between games during a session and can group games that are frequently played together. For example, the AI tool can identify patterns in how players move from one game to another. For example, if players often start with low-volatility games and then switch to higher-volatility ones as their session progresses, the AI tool can group games in this sequence to encourage natural transitions.

Still referring examples of data analysis to group games, regarding player satisfaction metrics, an AI tool can group games that generate high player satisfaction based on feedback, engagement levels, and time spent. For example, the AI tool can leverage sentiment analysis on feedback data and player engagement metrics (e.g., net promoter score, session engagement) to group games that tend to create a positive overall experience. The AI tool can offer clusters of highly rated games to increase session satisfaction.

The following are some examples of grouping games according to some embodiments of the present disclosure: themed game clusters, volatility-based game clusters, and session progression clusters.

Referring to said examples of grouping games, regarding themed game clusters, an AI tool can group together games with similar themes (e.g., ancient Egypt, mythology, or action-adventure) to cater to players who are drawn to specific genres. For example, players who enjoy one “Egyptian Pharaoh” themed slot may also enjoy other similar-themed games. This provides continuity in player session experience. This can result in enhanced player immersion, improved game discoverability, and increased session length due to thematic continuity.

Still referring to examples of grouping games, regarding volatility-based game clusters, an AI tool can offer a cluster of games that offer similar risk-reward dynamics, such as for players who enjoy high-volatility, high-reward games. This allows thrill-seeking players to find games that match their preferred risk profile more easily. This can result in increased player satisfaction, higher average bet sizes, and more time spent on high-volatility games.

Still referring to examples of grouping games, regarding session progression clusters, an AI tool can identify whether certain players start their sessions with low-risk games and gradually move toward high-risk, high-reward games as the session progresses. Thus, the AI tool groups games in a way that mirrors the player behavior, such as by offering players a suggested sequence of games based on risk levels. This can result in a more personalized gaming experience, smoother transitions between games, and improved player retention during a single session.

The following describes some approaches to detecting suboptimal game configurations according to some embodiments of the present disclosure: performance metrics analysis, player behavior analysis, volatility and payout structure, A/B testing game configurations, player feedback and sentiment analysis, competitive benchmarking, in-game event monitoring, player segmentation and personalization, etc. For example, an AI tool can identify issues or inefficiencies in how games are set up or operate that negatively impact player experience, engagement, and profitability. By analyzing various data points and using specific strategies, the AI tool can uncover these configurations and make the necessary adjustments to optimize gameplay.

Referring to said examples of approaches to detecting suboptimal game configurations, regarding performance metrics analysis, an AI tool can identify games that are underperforming compared to others in terms of player engagement, revenue, and time on device. Some key metrics the AI tool can consider include, but are not limited to revenue per game, time on device, average bet size, session frequency, etc. Regarding revenue per game, the AI tool can analyze (e.g., compare) revenue generated by each game, such as determination of suboptimal games that may generate significantly lower revenue than similar games in the same category. Regarding time on device (TOD), the AI tool can automatically detect a configuration that fails to engage players, such as via detection of whether players spend significantly less time on certain games compared to others. Regarding average bet size, the AI tool can indicate an unattractive betting range or poorly balanced payouts in response to detection that a game consistently shows lower-than-expected bet sizes. Regarding session frequency, the AI tool can determine a suboptimal configuration in response to determination of how often players return to a game. If a game is rarely revisited, its configuration could be driving players away. For instance, the AI tool can analyze these metrics in a dashboard or reports, looking for outliers or games that consistently underperform. If specific games show low engagement and revenue while others in the same category perform well, this could be a sign of suboptimal configurations.

Still referring to examples of approaches to detecting suboptimal game configurations, regarding player behavior analysis, an AI tool can identify suboptimal configuration of games where players exhibit negative behaviors like early abandonment or erratic denomination changes, which may indicate frustration with the game setup. Some key data point considered by the AI tool include, but are not limited to abandonment Rate (e.g., the AI tool detects suboptimal configuration of games where players leave after just a few minutes or after a few rounds of play, which can signal issues like confusing rules, frustrating gameplay mechanics, or unbalanced rewards), betting patterns (e.g., the AI tool detects suboptimal configuration of games in response to detection of erratic or drastic changes in bet denominations (e.g., frequent lowering of bets), which may indicate whether players are not comfortable with the volatility or payout structures of the game), churn analysis (e.g., the AI tool detects suboptimal configuration of games that have a high rate of player churn, where players abandon the game and do not return). In some embodiments, the AI tool conducts behavioral analysis using machine learning or statistical models to identify patterns that correlate with suboptimal game performance. For instance, high abandonment rates combined with low bet size growth could indicate a poorly balanced game configuration.

Still referring to examples of approaches to detecting suboptimal game configurations, regarding volatility and payout structure, an AI tool can ensure that a game's volatility and payout structure match the target audience's preferences. Some key considerations by the AI tool include, but are not limited to, volatility mismatch, payout frequency, payout size, etc. Regarding volatility mismatch, the AI tool can detect whether a volatility of a game is too high for casual players or tool low for high-rollers. If a game's volatility is too high for casual players, it can lead to frustration and early abandonment. Conversely, if volatility is too low for high-rollers, they may find the game uninteresting. Regarding payout frequency, the AI tool can determine whether payouts are too infrequent or inconsistent. If payouts are too infrequent or inconsistent, players may feel unrewarded, resulting in lower engagement. Regarding payout size, the AI tool can determine whether games are providing large enough payouts. Games offering small payouts that do not feel significant to players could lead to dissatisfaction, especially in high-denomination games. In some embodiments, the AI tool analyzes the payout frequency and size distribution across different player segments, compares the actual payout structure to player expectations for those segments, and adjusts the volatility or payout tables to better align with target audience preferences.

Still referring to examples of approaches to detecting suboptimal game configurations, regarding A/B testing game configuration, an AI tool can test different game configurations to see which one yields the highest engagement, player retention, and profitability. Some key aspects to test by the AI tool include, but are not limited to, denomination range (e.g., testing whether expanding or narrowing the denomination range increases player engagement), bonus frequency (e.g., experimenting with increasing or decreasing the frequency of in-game bonuses and rewards, payout adjustments (e.g., testing different payout structures (e.g., more frequent smaller wins vs. less frequent large wins) to determine which configuration resonates best with your players), etc. For example, the AI tool can deploy A/B testing across various game configurations to isolate which changes have the most positive impact on player experience. The AI tool can further monitor key metrics (engagement, revenue, bet size) across both versions to make data-driven decisions.

Still referring to examples of approaches to detecting suboptimal game configurations, regarding player feedback and sentiment analysis, an AI tool can identify suboptimal game configurations based on player feedback, reviews, and sentiment analysis. Some key data points that the AI tool can analyze include player reviews (e.g., the AI tool collects player feedback from surveys, social media, or online reviews, the AI tool detects when players express frustration when games are too complex, the AI tool detects player sentiment regarding slow bonus triggers, the AI tool detects player sentiment regarding whether payout structures feel are unfair), customer support data (e.g., the AI tool analyzes types of complaints related to specific games, frequent complaints that may point to a need to reconfigure the game, etc.), sentiment analysis (e.g., the AI tool use natural language processing (NLP) to analyze player reviews and comments, the AI tool identifies negative sentiment associated with certain game mechanics or configurations, etc.). In some embodiments, the AI tool applies sentiment to player comments and feedback to highlight the most frequent complaints or dissatisfaction. The AI tool uses these insights to adjust game configurations or introduce updates that address player concerns. Some examples of detection of player biofeedback and/or player emotional states are described in U.S. Pat. No. 8,308,562 to Patton, U.S. Pat. No. 9,330,523 to Sutton et al., and U.S. Patent Publication No. US20090180937 to Bucher et al., which are incorporated by reference herein in their respective entireties.

Still referring to examples of approaches to detecting suboptimal game configurations, regarding competitive benchmarking, an AI tool can compare games configurations against similar games offered by competitors to ensure that the games meet market expectations. The AI tool can analyze various key metrics including, but not limited to bet Range (e.g., the AI tool ensures that games offer a bet range that is comparable or better than competitors' games for similar types of players), payout frequency (e.g., the AI tool compares payout frequencies and amounts against competitors to ensure a game is offering a competitive experience), bonus structures (e.g., the AI tool looks at bonus mechanics and reward frequency of competitors' games to identify areas where games may be underperforming), etc. For example, the AI tool can perform a competitive analysis to identify whether configurations are misaligned with industry standards, to identify whether competitors offer better incentives or payouts, to identify whether players find games less appealing than other competitor games, etc. The AI tool can make data-backed adjustments to stay competitive.

Still referring to examples of approaches to detecting suboptimal game configurations, regarding in-game event monitoring, an AI tool can track and analyze specific in-game events that may indicate suboptimal configurations. Some key in-game events include, but are not limited to, bonus round activation (e.g., the AI tool determines whether players frequently fail to reach bonus rounds, which may be an indication that the bonus trigger is too difficult or that players aren't engaged long enough), win Frequency vs. bet size (e.g., the AI tool tracks the correlation between how often players win and how much they bet to determine, for instance, whether players are betting high but winning infrequently, which could indicate an imbalance in game fairness or excitement), game abandonment post-bonus (e.g., the AI tool can determine whether a player abandons the game immediately after hitting a major win or completing a bonus round, which could indicate that the remaining gameplay does not offer enough value to keep a player engaged). For example, the AI tool can use real-time monitoring and data tracking to capture in-game events and perform root-cause analysis. By detecting patterns in events that lead to disengagement or reduced play, the AI tool can adjust the game configuration accordingly.

Still referring to examples of approaches to detecting suboptimal game configurations, regarding player segmentation and personalization, an AI tool can ensure that games are configured optimally for different player segments. In one embodiment, the AI tool can segment players as high-rollers vs. casual players. For instance, high-rollers may prefer higher volatility and bigger risks, while casual players often favor lower risks and consistent rewards. In another example, the AI tool can segment players into new players vs. regular players. New players might prefer simpler games with frequent rewards, while regular players might seek more complex, high-stakes games. In one example, the AI tool segments a player base using machine learning models and analyzes how each segment interacts with a provider's games. The AI tool uses these insights to create personalized games and/or game experiences.

As described above, a gaming system (e.g., or an AI tool associated with a gaming system) can product performance optimization through player behavior insights, such as by identifying games to be grouped based on overall session experience, by detecting and automatically correcting (or making suggestions for correcting) suboptimal game configurations, manage game performance with greater speed and confidence. Further, determining player behavior insight can be associated with detection and analysis, via ML models(s), of specific behaviors, such as investment and reinvestment behaviors or denomination change behaviors. For instance, the gaming system may determine, based on analysis, by an AI tool, of various RFM metrics that a change in denomination value at an early stage of a gaming session predicts a likelihood of increasing denomination values later during the gaming session. The RFM metrics include, but are not limited to, analysis of features, such as session length, reinvested percentage, reinvested amount, etc. Furthermore, determining player behavior insights can involve analysis, via ML model(s), of the impact of features on wagering behavior (e.g., denomination change rate is different between different game themes, game types, regions, casino types, etc.).

In other embodiments, the gaming system (e.g., an AI tool), monitors and analyzes other aspects of a gaming system, such as monitoring soft tilts such as touch screen errors and bill rejects to detect a negative impact on a gamer in a gaming session while games are playable in the presence of errors. In yet other embodiments, the gaming system delivers automated alerts when a rejection rate is above a certain threshold (e.g., an increase to handle pull improvement by correcting rejection rate).

In yet other embodiments, one example of improving optimization of a casino device, operation, process, etc. comprises optimizing a configuration associated with a gaming table, such as automatically optimizing transactions associated with accounting of the gaming table (e.g., auto filling a chip tray, auto crediting, auto balance adjustments, etc.). For instance, an AI tool can proactively detect that a chip tray is getting low on chips and can generate a request to fill the chip tray.

All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and with all other features in all other documents incorporated by reference, without limitation. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

1. A method comprising:
aggregating, by an electronic processor, gaming data generated by casino devices communicatively coupled to a casino network;
accessing, by the electronic processor, a machine learning model trained, via exploratory data analysis of the aggregated gaming data, to map input features of the aggregated gaming data to model parameters used to predict a target output value;
predicting, by the electronic processor using the machine learning model to analyze at least some portion of the aggregated gaming data associated with a specific user account logged onto one of the casino devices, a user-specific output value that identifies a player behavior; and
automatically modifying, based on the identified player behavior, a configuration associated with the one of the casino devices to optimize, for the specific user account, an operation associated with the one of the casino devices.

2. The method of claim 1, wherein the predicting the user-specific output value associated with the player behavior comprises analyzing the at least some portion of the aggregated gaming data for recency, frequency, and monetary engagement metrics associated with the specific user account, and wherein the automatically modifying the configuration associated with the one of the casino devices is based on the analysis of the at least some portion of the aggregated gaming data for the recency, frequency, and monetary engagement metrics.

3. The method of claim 1, further comprising identifying, based on analysis of the at least some portion of the aggregated gaming data, a suboptimal game configuration at the one of the casino devices, and wherein the automatically modifying the configuration includes optimizing the suboptimal game configuration for the specific user account.

4. The method of claim 3, wherein detecting the suboptimal game configuration comprises identifying an underperforming game available at the one of the casino devices, and wherein the modifying the configuration comprises automatically adjusting one or more of a volatility, a payout structure, a bonus frequency, a game theme, or a denomination range of the underperforming game.

5. The method of claim 1, wherein the modifying the configuration comprises automatically grouping, by the electronic processor, one or more games provided by the one of the casino devices based on at least one of a game theme, a game volatility, or an in-game feature.

6. The method of claim 1, further comprising determining, by the electronic processor using the predicted user-specific output value, a risk level associated with the player behavior, wherein the automatically modifying the configuration comprises modifying the configuration to a specific level based on the determined risk level.

7. The method of claim 1, wherein predicting the user-specific output value that identifies the player behavior comprises measuring at least one of a reinvestment player behavior or a denomination change player behavior, and said method further comprising:
monitoring, by the electronic processor in response to modifying the configuration, a degree of change to the at least one of the reinvestment player behavior or the denomination change player behavior; and
balancing, by the electronic processor, a cost associated with causing the degree of change to the at least one of the reinvestment player behavior or the denomination change player behavior with an anticipated return of investment for the cost.

8. The method of claim 7, wherein measuring the at least one of the reinvestment player behavior or the denomination change player behavior is based on at least one of a measured player retention rate, a measured average spend per visit to a casino, or a measured player lifetime value.

9. The method of claim 1, wherein the automatically modifying the configuration causes optimization of the operation to perform at least one of fine-tuning a loyalty program, generating a promotion, modifying a game mechanic, targeting a specific player segment, optimizing marketing spending, or selecting an intervention strategy associated with a responsible gaming restriction.

10. The method of claim 1, wherein the predicting the user-specific output value associated with the player behavior comprises analyzing real-time gaming data associated with a current gaming session associated with the specific user account, and wherein the automatically modifying the configuration associated with the one of the casino devices comprises dynamically offering, via the one of the casino devices, a promotion specifically based, at least in part, on the real-time gaming data.

11. A gaming system comprising:
a network communication device configured to communicate with a casino network; and
one or more processors configured to execute instructions, wherein execution of the instructions cause the gaming system to perform operations to:
aggregate gaming data generated by casino devices communicatively coupled to the casino network;
access a machine learning model trained, via exploratory data analysis of at least a portion of the aggregated gaming data, to map input features of the at least a portion of the aggregated gaming data to model parameters used to predict a target output value;
predict, using the machine learning model to analyze at least some portion of the aggregated gaming data associated with a specific user account logged onto one of the casino devices, a user-specific output value that identifies a player behavior; and
automatically modify, based on the identified player behavior, a configuration associated with the one of the casino devices to optimize, for the specific user account an operation associated with the one of the casino devices.

12. The gaming system of claim 11, wherein the one or more processors being configured to execute instructions to cause the gaming system to perform operations to predict the user-specific output value associated with the player behavior is configured to execute instructions to cause the gaming system to perform operations to analyze the at least some portion of the aggregated gaming data for recency, frequency, and monetary engagement metrics associated with the specific user account, and wherein the operation of automatically modifying the configuration associated with the one of the casino devices is based on the analysis of the at least some portion of the aggregated gaming data for the recency, frequency, and monetary engagement metrics.

13. The gaming system of claim 11, wherein the one or more processors are configured to execute instructions to cause the gaming system to perform operations to identify, based on analysis of the at least some portion of the aggregated gaming data, a suboptimal game configuration at the one of the casino devices, wherein the operation of automatically modifying the configuration includes operations to optimize the suboptimal game configuration for the specific user account, wherein the one or more processors configured to execute instructions to cause the gaming system to perform operations to identify the suboptimal game configuration are further configured to execute instructions to cause the gaming system to perform operations to identify an underperforming game available at the one of the casino devices, and wherein the one or more processors configured to execute instructions to cause the gaming system to perform operations to automatically modify the configuration is configured to execute instructions to cause the gaming system to perform operations to automatically adjust one or more of a volatility, a payout structure, a bonus frequency, a game theme, or a denomination range of the underperforming game.

14. The gaming system of claim 11, wherein the one or more processors configured to execute instructions to cause the gaming system to perform operations to modify the configuration are further configured to execute instructions to cause the gaming system to perform operations to automatically group one or more games provided by the one of the casino devices based on at least one of a game theme, a game volatility, or an in-game feature.

15. The gaming system of claim 11, wherein the one or more processors are further configured to execute instructions to cause the gaming system to perform operations to determine, using the predicted user-specific output value, a risk level associated with the player behavior, and wherein the automatically modifying the configuration comprises modifying the configuration to a specific level based on the determined risk level.

16. The gaming system of claim 11, wherein the one or more processors configured to execute instructions to cause the gaming system to perform operations to predict the user-specific output value that identifies the player behavior are further configured to execute instructions to cause the gaming system to perform operations to:
measure at least one of a reinvestment player behavior or a denomination change player behavior, wherein measurement of the at least one of the reinvestment player behavior or the denomination change player behavior is based on at least one of a measured player retention rate, a measured average spend per visit to a casino, or a measured player lifetime value;
monitor, in response to modification of the configuration, a degree of change to the at least one of the reinvestment player behavior or the denomination change player behavior; and
balance a cost associated with causing the degree of change to the at least one of the reinvestment player behavior or the denomination change player behavior with an anticipated return of investment for the cost.

17. The gaming system of claim 11, wherein the one or more processors configured to execute instructions to cause the gaming system to perform operations to automatically modify the configuration causes optimization of the operation to perform at least one of fine-tuning a loyalty program, generating a promotion, modifying a game mechanic, targeting a specific player segment, optimizing marketing spending, or selecting an intervention strategy associated with a responsible gaming restriction.

18. The gaming system of claim 11, wherein the one or more processors configured to execute instructions to cause the gaming system to perform operations to predict the user-specific output value associated with the player behavior is further configured to execute instructions, which when executed, cause the gaming system to perform operations to analyze real-time gaming data associated with a current gaming session associated with the specific user account, and dynamically offer, via the one of the casino devices, a promotion specifically based, at least in part, on the real-time gaming data.

19. One or more non-transitory, machine-readable mediums having instructions stored thereon, which when executed by one or more electronic processors of a gaming system cause the gaming system to perform operations comprising:
aggregating gaming data generated by casino devices communicatively coupled to a casino network;
accessing a machine learning model trained, via exploratory data analysis of the aggregated gaming data, to map input features of the aggregated gaming data to model parameters used to predict a target output value;
predicting, using the machine learning model to analyze at least some portion of the aggregated gaming data associated with a specific user account logged onto one of the casino devices, a user-specific output value that identifies a player behavior; and
automatically modifying, based on the identified player behavior, a configuration associated with the one of the casino devices to optimize, for the specific user account, an operation associated with the one of the casino devices.
